(19) United States
(12) Patent Application Publication
(10) Pub. No.: US 2008/0017558 A1
(43) Pub. Date: Jan. 24, 2008

(54) Methods and Devices for Improved Aeration From Vertically-Orientated Submerged Membranes

(76) Inventors: David C. Pollock, Calgary (CA); Gregory B. Brodd, Kirkland, WA (US)

Correspondence Address: BLACK LOWE & GRAHAM PLLC, Suite 4800, 701 Fifth Avenue, Seattle, WA, 98104, US

(21) Appl. No.: 11/679,789

(22) Filed: Feb. 27, 2007

Related U.S. Application Data
(63) Continuation-in-part of application No. PCT/US2005/010976, filed on Mar. 31, 2005.
(60) Provisional application No. 60/778,164, filed on Mar. 1, 2006.

(51) Int. Cl. B03D 1/14; B01D 21/30; C02F 3/12; B01D 35/00

(52) U.S. Cl. 210/90; 210/136; 210/221.1; 210/221.2

(57) ABSTRACT

Submerged gas diffuser assemblies configured to aerate liquid suspensions in reservoirs or deep shafts with enhanced aeration contact patterns and adjustable aeration rates. Aeration contact patterns and rates are varied by the adjusting the spatial configuration of gas permeable membranes, altering the fluid flow patterns around the membranes, manipulating trans-membrane pressures across membranes, varying the sequence of aeration of liquid within the fluid flow patterns, expanding the membrane surface area, and/or by selectively occluding certain portions of membrane surface area of the membrane assemblies. The membrane assemblies are designed to prevent, control, or mitigate membrane fouling and hydro lockup.

### RELATED APPLICATIONS

This application claims priority to U.S. Provisional Patent Application No. 60/778,164 filed Mar. 1, 2006. This application also claims priority as a continuation in part of International application No. PCT/US2005/010976 filed Mar. 31, 2005 (corresponding to WIPO publication No. WO/2005/100264, published Oct. 27, 2005), which in turn relates priority of this application back to, and is a continuation in part of, U.S. patent application Ser. No. 10/895,432 filed Apr. 6, 2004 (corresponding to U.S. Publication No. 2005/0218074 A1, published Oct. 6, 2005), and also claims priority from U.S. Provisional Patent Application No. 60/572,387, filed May 18, 2004. The complete priority lineage set forth above is claimed in this application, and each of the foregoing priority applications and corresponding publications are incorporated herein by reference in its entirety for all purposes.

### FIELD OF THE INVENTION

The present invention relates to methods and devices for processing, refining, and/or treating liquid compositions. More specifically, the invention relates to membrane separation methods and devices employing a selective, semi-permeable, microporous, or other partitioning membrane for processing, refining, and/or treating liquid compositions, for example membrane waste-water purification processes and apparatus.

### BACKGROUND OF THE INVENTION

Background Pertaining to Vertical Bioreactors: High efficiency wastewater treatment has become increasingly important as the world's population continues to grow. The quantity of water needed for human consumption and other uses has increased at a rapid pace, while the amount of naturally available water remains unchanged. The ever-increasing demand for usable, clean water has made reclamation of wastewater an essential component of growth and development of human populations.

In the United States and other developed nations, as existing metropolitan areas become overcrowded, developers are encouraged or required to construct new housing in previously undeveloped areas. Many of these undeveloped areas lack sufficient water for consumption, irrigation and similar purposes, necessitating reclamation and reuse of available water resources. For development in these areas to be successful, sewage from the residential use of water, commonly referred to as wastewater, is therefore a primary target for reclamation.

Residential wastewater has a high water content, but requires substantial processing before it can be reused because of the human waste and other contaminants mixed with it. To achieve reclamation of residential wastewater in many new development areas, isolated from existing sewage treatment facilities, on-site wastewater treatment and reclamation is highly advantageous or essential.

A wide variety of different wastewater treatment systems have been proposed for reclaiming residential sewage and other categories of wastewater. One such system disclosed in U.S. Pat. No. 2,528,649, incorporates a simple sedimentation tank for separating solid waste, or “sludge”, from wastewater. After sedimentation, the sludge is passed to a digestion system where it is allowed to settle so that clear aqueous liquid separates from the sludge. The clarified liquid is redirected back to the sedimentation tank. Unfortunately, this system suffers from a number of shortcomings that make it inefficient. In particular, the system incorporates a relatively crude sedimentation system that merely allows the influent sewage to separate and does not aerate or facilitate processing of the sewage in any other way.

A number of wastewater treatment processes comprise “biological” systems utilizing microorganisms contained in an activated biomass, or sludge for the removal of COD, phosphorous and/or nitrogen from wastewater. These treatment processes typically incorporate multiple treatment phases or “zones”, namely: (1) a preliminary treatment area; (2) a primary treatment area; and (3) a secondary treatment area. Preliminary treatment is primarily concerned with the removal of solid inorganics from untreated wastewater. Typically, this preliminary treatment encompasses a two-stage treatment process in which the debris is removed by screens and/or settling. Organic matter is carried out in the fluid stream for subsequent treatment. Primary treatment entails a physical process wherein a portion of the organics, including suspended solids such as feces, food particles, etc. is removed by flotation or sedimentation. Secondary treatment typically encompasses a biological treatment process where microorganisms are utilized to remove remaining organics, nitrogen and phosphorous from the wastewater fluid stream. Microorganism growth and metabolic activity are exploited and controlled through the use of controlled growth conditions.

In large scale municipal or industrial applications, biological treatment processes typically utilize a basin or other reservoir in which the wastewater is mixed with a suspension of biomass/sludge. Subsequent growth and metabolism of the microorganisms, and the resultant treatment of the wastewater, is carried out under aerobic and/or anaerobic/anoxic conditions. In most large scale municipal or industrial treatment systems, the various components of the treatment process are performed in discrete basins or reactors. As such, there is a continuous flow of the wastewater from one process step to the next. Biomass containing the active microorganisms may be recycled from one process step to another. The conditioning of such biomass to enhance growth of particularized subgroups of microorganisms possessing a proclivity for performing a specific type of metabolic process, e.g. phosphate removal, nitrogen removal has been the subject matter of numerous patents, including: U.S. Pat. No. 4,056,465; U.S. Pat. No. 4,487,697; U.S. Pat. No. 4,568,462; U.S. Pat. No. 5,344,562, each incorporated herein by reference. Other components and aspects of biological wastewater treatment have been described in various patent documents, including: U.S. Pat. No. 2,788,127; U.S. Pat. No. 2,875,151; U.S. Pat. No. 3,440,669; U.S. Pat. No. 3,543,294; U.S. Pat. No. 4,522,722; U.S. Pat. No. 4,824,572; U.S. Pat. No. 5,290,435; U.S. Pat. No. 5,354,471; U.S. Pat. No. 5,395,527; U.S. Pat. No. 5,480,548; U.S. Pat. No. 4,259,182; U.S. Pat. No. 4,780,208; U.S. Pat. No. 5,252,214; U.S. Pat. No. 5,022,993; U.S. Pat. No. 5,342,522; U.S. Pat. No. 3,957,632; U.S. Pat. No. 5,098,572; U.S. Pat. No. 5,290,451; Canadian Patent # 1,064,169; Canadian Patent # 1,096,976; Canadian Patent # 1,198,837; Canadian Patent # 1,304,839; Canadian Patent # 1,307,059; Canadian Patent # 2,041,329, each herein incorporated by reference in their entirety.

Biological removal of organic carbon, nitrogen and phosphorus compounds from waste water requires attention to special environmental conditions within the processing equipment. For instance, for bacteria and other microbes to convert organic carbon compounds (measured as BOD) to carbon dioxide and water, a well mixed aerobic environment is required. Approximately one pound of oxygen is required for each pound of BOD removed. To convert nitrogen compounds to nitrogen gas and carbon dioxide, nitrosomas and nitrobacter operate in an aerobic environment consuming inorganic carbon. Approximately 4.6 pounds of oxygen is required for each pound of ammonia-N converted to nitrate-N (assuming alkalinity is sufficient). Subsequently, facultative bacteria operate in an anoxic environment consuming organic carbon and liberating nitrogen gas. Approximately 2.6 pounds of oxygen is recovered for each pound of nitrate-N converted to nitrogen gas. To biologically tie up phosphate in the cell mass, an anaerobic step to produce volatile fatty acids is required. This is followed by Poly P microbes consuming large amounts of phosphorus required to metabolize the volatile fatty acids in an aerobic environment thus concentrating the phosphate in the biomass (see, e.g., Abstract by Dr. W. Wilson Western Canada Water and Wastewater Conference, Calgary AB. January 2002).

The combination of these many biological processes ideally results in a Biological Nutrient Removal (BNR) process, sometimes called tertiary treatment. However, a well-designed tertiary treatment operation requires coordination and sequencing of a complex assemblage of components, processes and conditions. Each of the constituent biological processing steps proceeds at its own rate, with specific environmental parameters required. Efficient tertiary processing also requires the correct amounts of specialty microbes to sustain the microbial populations and perform specific processing functions.

Current wastewater treatment systems which attempt to provide tertiary treatment include Upflow Sludge Bed Filter (USBF), Sequencing Batch Reactor (SBR) and Membrane Separation Activated Sludge (MSAS) systems. The Sequencing Batch Reactor (SBR) process is a modification of the conventional activated sludge process. U.S. Pat. No. 5,503,748 discloses a long vertical shaft aerator applied to the SBR technology. The SBR process employs a number of discrete steps, typically comprising sequential fill, reaction, settlement and decantation of wastewater with biomass in an enclosed reactor. In the initial step of this process, wastewater is transferred into a reactor containing biomass, and combined to form a mixed liquor. In the reaction step of the treatment process the microorganisms of the biomass utilize and metabolize and/or take up the nitrogen, phosphorous and/or organic sources in the wastewater. These latter reactions may be performed under anaerobic conditions, anoxic conditions, aerobic conditions, or a combination thereof to manipulate organism growth, population dynamics and contaminant processing. The length of this stage will be dependent on the waste's characteristic, concentration of the biomass, and other factors. Following the reaction cycle, the biomass in the mixed liquor is allowed to settle out. A sludge blanket settles on the bottom of the reactor leaving a treated effluent supernatant. The treated and clarified wastewater (i.e. effluent) is subsequently decanted and discharged. The reactor vessel is then refilled and the treatment process cycle reinitiated. Thus, the sequencing batch reactor's process is based on discrete operation in time, whereas other wastewater treatment processes are based on distinct operations in space, e.g., by performance of different reactions in separate vessels.

A number of additional wastewater treatment designs feature an air-lift reactor, which is a mechanically simple, combined gas-liquid flow device characterized by fluid circulation in a defined cyclic pattern through a set of specifically designed channels. Fluid motion is due to the mean density difference in an upflow (riser) and downflow (down corner) sections of the reactor. The air-lift reactor is ordinarily comprised of distinct zones with different flow patterns. The riser is typically the zone where the gas is injected creating a fluid density difference, resulting in upward flow of both liquid and gas phases. At the top of the reactor, there is a gas-liquid separator section, which is typically a region of horizontal fluid flow and flow reversal where gas bubbles disengage from the liquid phase. The down corner is the zone where the gas-liquid dispersion or degassed liquid ordinarily recirculates to the riser. The down corner zone exhibits either single-phase, two-phase cocurrent, or two-phase mixed cocurrent-countercurrent downward flow, depending on whether the liquid velocity is greater than the free-rise velocity of the bubbles. The base section at the lower end of the vessel communicates the exit of the down corner to the entrance of the riser.

The air-lift reactor has predominantly been used for microorganism fermentation processes such as the ICI single cell protein production. Nonetheless, a number of systems are known which utilize air-lift reactors for wastewater treatment. Among these examples is the Betz reactor (Gasner, Biotech. Bioeng. 16:1179-1195, 1974), and “deep shaft” bioreactors for effluent treatment (see, e.g., Hines et al., Chem. Eng. Sym. Ser. U.K. 41:D1-D10, 1975).

Following the original development of deep shaft bioreactor technology, recent efforts have led to improvements in long vertical shaft bioreactor systems for wastewater treatment. Among these improvements, U.S. Pat. Nos. 4,279,754, 5,645,726, and 5,650,070 issued to Pollock (incorporated herein by referenced in their entirety) disclose a modified vertical shaft bioreactor systems for the treatment of biodegradable wastewater and/or sludge. Generally, these vertical shaft bioreactor systems comprise a bioreactor, a solid/liquid separator and intervening apparatus in communication with the bioreactor and separator. The bioreactor comprises a circulatory system that includes two or more vertical, side-by-side or coaxial chambers, a downflow chamber (or down corner) and an upflow chamber (or riser). These chambers are connected at their upper ends through a surface basin and communicate at their lower ends via a common “mix zone” adjacent the lower end of the down corner.

In addition to the mix zone, these reactors feature a “plug flow zone” located below the mix zone and communicating therewith. As previously described, the term “plug flow” has referred to a net downward migration of solid particles from the mix zone toward an effluent outlet located at the lower end of the reactor. In one application to sludge digestion the net downward migration has been reported by Guild et al. (Proceedings WEF conf., Atlanta Ga., October 2001), to include local back mixing only, but over extended periods of operation (e.g., about 16 hours), inter-zonal mixing occurs.

The waste-containing liquor (“mixed liquor”) is driven through the circulating system (i.e., between the downflow and upflow chambers, the surface basin and the mix zone) by injection of an oxygen-containing gas, usually air, near the bottom of the reactor (e.g., at the mix zone and plug flow zone). A portion of the circulating flow is directed to the plug flow zone and is removed at the lower end thereof as effluent. In wastewater treatment reactors, the air is typically injected 5-10 feet above the bottom of the reactor and, optionally, immediately below the lower end of the down corner. The deepest air injection point divides the plug flow zone into a quasi plug flow zone with localized back mixing above the deepest point of air injection, and a strict plug flow zone with reportedly no mixing below the deepest point of air injection.

At start-up of the bioreactor, air is injected into the riser in the nature of an air lift pump, causing liquor circulation between and through the upflow and downflow chambers. Fluid in the down corner has a higher density than the liquid-bubble mixture of the riser and thereby provides a sufficient lifting force to maintain circulation.

Once the bioreactor circulation is thus initiated, all of the air injection is diverted to the mix zone and/or plug flow zone. The air bubbles that rise out of these zones are trained into the upflow chamber and are excluded from the downflow chamber where the downward flow of liquor exceeds the rise rate of the bubbles. Dissolved oxygen in the circulating mixed liquor is the principal reactant in the biochemical degradation of the waste. As the liquor ascends in the riser to regions of lower hydrostatic pressure, this and other dissolved gases separate and form bubbles. When the liquid/bubble mixture from the riser enters the basin, gas disengagement occurs. To facilitate this purpose, the surface basin is ordinarily fitted with a horizontal baffle at the top of the upflow chamber to force the mixed liquor to traverse a major part of the basin and release spent gas before re-entering the downflow chamber for further treatment.

U.S. Pat. No. 5,650,070 discloses a process where influent waste water is introduced at depth into the riser chamber through an upwardly directed outlet arm of an influent conduit. A zone of turbulence is created at the lower end of the downflow chamber by the turn-around velocity head as the circulating flow reverses from downward to upward flow. This mix zone is not well defined but typically is between 15-25 feet deep. A portion of the mixed liquor in the mix zone flows downwardly into the top of the plug flow zone in response to an equal amount of treated effluent being removed from the lower end of the plug flow zone into an effluent line, as discussed above. During operation of the bioreactor the flow of influent liquor to and effluent liquor from the bioreactor are controlled in response to changes in level of liquid in the connecting upper basin.

Reaction between waste, dissolved oxygen, nutrients and biomass (including an active microbial population), substantially takes place in an upper circulating zone of the bioreactor defined by the surface basin, the upflow and downflow chambers and the mix zone. The majority of the contents of the mix zone circulate upwardly into the upflow chamber. In this upflow chamber undissolved gas, mostly nitrogen, expands to help provide the gas lift necessary to drive circulation of the liquor in the upper part of the reactor. The spent gas is released from the liquor as it traverses the horizontal baffle in the surface basin. The plug flow zone located below the upper circulating zone provides a final treatment or “polish” to the mixed liquor flowing downward from the mix zone to effluent extraction at the lower end of the reactor.

The injected oxygen-containing gas dissolves readily under pressure in the liquor in the plug flow zone where there is localized back mixing resulting in a slow net downward movement of liquor. Undissolved gas (bubbles) migrate upward to the very turbulent mix zone under pressure. The gas to liquid transfer in this zone is very high, reaching overall reactor oxygen transfer efficiencies in excess of 65%. The products of the reaction are carbon dioxide and additional biomass which, in combination with unreacted solid material present in the influent wastewater, forms a sludge (or biosolids).

In addition to aerobic digestion of BOD, it is becoming more and more important to couple biological nutrient removal (BNR) of nitrogen and phosphorous compounds with conventional wastewater treatment. As the demand for higher quality liquid effluent discharges increase, the need for technologies as provided by the present invention has become increasingly more compelling. The old Secondary Biological treatment standard of 30 mg/L BOD and 30 mg/L TSS is no longer adequate in many jurisdictions and limits are now often placed on nitrogen and phosphorus as well. Effective removal of these nutrients is essential in view of existing and developing environmental laws aimed at preventing eutrophication of natural waters and the attendant ecosystem damages that result therefrom.

In basic terms, nitrogen removal is accomplished by converting ammonia contained in a mixed liquor stream to nitrites and nitrates, in the presence of oxygen, which is known as an aerobic nitrifying stage. Ammonia conversion to nitrite is carried out by microbes known as Nitrosomonas, while the conversion of nitrite to nitrate is accomplished by Nitrobacters. Nitrate conversion to nitrogen gas occurs in an anoxic denitrifying stage that takes place in a suspended growth environment devoid of dissolved oxygen. Nitrogen, carbon dioxide and water is produced, with the gas being vented from the system. Nitrification rates can be optimized by regulating interdependent waste stream parameters such as temperature, dissolved oxygen levels (D.O.), pH, solids retention time (SRT), ammonia concentration and BOD/TKN ratio (Total Kjeldahl Nitrogen, or TKN, is organic nitrogen plus the nitrogen from ammonia and ammonium). Higher temperatures and higher dissolved oxygen levels tend to promote increased nitrification rates, as does pH levels in 7.0 to 8.0 ranges. Sludge retention times of from 3.5 to 5, and preferably 5-8, days dramatically increase nitrification efficiency, after which time efficiencies tend to remain constant. Increases in ammonia concentration increases the nitrification rate but only to a maximum level attainable after which further ammonia concentration increases do less to increase the rate of nitrification. Rates have also been shown to be maximized at BOD/TKN ratios of less than 1.0 (see, e.g., Abstract by Dr. W. Wilson, Western Canada Water and Wastewater BNR conference Calgary AB Canada January 2002).

Physical/Bio-Chemical phosphorous removal typically requires an anaerobic suspended growth zone at the start of the system, and a sludge fermentation tank to supply volatile fatty acids (VFA's) for the energy needs of the phosphorous ingesting organisms (Acinetobacters). Recently it has been reported that anaerobic force mains can generate sufficient volatile acids to permit substantial biological phosphorus removal.

Refractory treatment and polishing stages may be added to the process, downstream of the final clarification stage. In many waste streams, the majority of organic compounds (80%-90%) are easily biodegraded. The remaining fraction biodegrade more slowly and are termed “refractory” compounds. Prior art biological nutrient removal designs incorporate a single sludge and a single clarifier, for example, U.S. Pat. No. 3,964,998 to Barnard, but in that case the overall oxidation rate of the system has to be reduced to satisfy the slowest compound to oxidize.

Biological nutrient removal (BNR) systems can take various process configurations. One such embodiment is the five stage Modified Bardenpho™ process, which is based upon U.S. Pat. No. 3,964,998 to Barnard. It provides anaerobic, anoxic and aerobic stages for removal of phosphorous, nitrogen and organic carbon. More than 24 Bardenpho™ treatment plants are operational, with most using the five stage process as opposed to the previously designed four stage process. Most of these facilities require supplemental chemical addition to meet effluent phosphorous limits of less than 1.0 mg/L. Plants using this process employ various aeration methods, tank configurations, pumping equipment and sludge handling methods. WEF Manual of Practice No. 8, “Design of Municipal Wastewater Treatment Plants”, Vol. 2, 1991.

In the context of vertical bioreactor technology, Pollock (U.S. Pat. No. 5,651,892, issued Jul. 29, 1997, incorporated herein by reference) discloses an innovative process utilizing a vertical bioreactor linked to a flooded filter via a flotation separator. According to this design, improved reaction rates are achieved by separating the biomass into a high rate aerobic organic carbon removal step, followed by an aerobic nitrification step using a separate nitrifying biomass. These steps are then followed by a high rate denitrification step in an anoxic environment created by feeding influent and return mixed liquor or effluent into that zone to provide a source of organic carbon and consume the oxygen.

Incorporation of an anaerobic processing step for phosphate removal is typically done in a separate reactor—due to the long fermentation time required for volatile fatty acid production. Furthermore, phosphorus removal in single mixed liquor systems is difficult to implement because the phosphate rich biomass produced in the aerobic portion of the process should not contact the anaerobic fermentation reactor product due to the risk of re-solubilizing the entrapped phosphate. In other instances, biological phosphorus removal is augmented by addition of metal salts such as ferric chloride or alum. These can be added directly into the aerobic zone of the reactor to chemically bind the phosphate.

Thus, a variety of treatment systems, including coupled vertical shaft reactors and SBR's, have been successfully used to provide tertiary wastewater treatment. However, these tertiary treatment systems involve a single mixed liquor process wherein all of the specialty microbes involved in the process are mixed together. These include autotrophic organisms that utilize energy from inorganic material (e.g., the nitrifiers Nitrosomonas and Nitrobacters), and heterotrophs which utilize organic energy sources and include the aerobic BOD removers and the Acinetobacter biological phosphorous removers (Bio-P organisms). Therefore, in all of these types of systems, the rate of treatment is controlled by the slowest performing microbe, usually nitrosomas which converts ammonium to nitrite. Due to the slow overall rate of treatment, these single mixed liquor systems are called extended aeration systems and are quite energy intensive.

Despite the foregoing developments and advancements in wastewater treatment technologies, there remains an urgent need in the art for improved wastewater treatment systems that can satisfy a broadened range of uses and perform expanded and enhanced functions not satisfied by existing wastewater treatment systems. For example, there is a long unmet need in the art for a simplified wastewater treatment process and apparatus that provides enhanced biological nutrient removal (BNR) and which, in certain embodiments, can produce class A bio-solids required for unrestricted land applications. In addition, there remains an unfulfilled need for wastewater treatment systems and methods that satisfy these expanded functions while minimizing the costs and environmental impacts that attend conventional wastewater treatment plant installation and operation.

Background Pertaining to Membrane Separation Technologies And Use of Membranes in Bioreactors for Waste Water Treatment: Membrane separation, which employs a selective, semi-permeable, or partitioning membrane is a rapidly evolving aspect of industrial separation technology for processing, refining, and/or treating liquid compositions, for example as employed in modern membrane waste-water purification processes and apparatus. In general, membrane separation devices and processes are applied to a first liquid composition, for example an influent liquid wastewater stream or flow, for subsequent purification. The first liquid compositions contacts one surface of the membrane where some constituents of the first liquid composition typically passes through the membrane under the effects of an applied driving force, and other constituents are retained in the influent liquid. The transmigrated constituents form a second liquid composition that is in a purer state than the initial wastewater stream.

Membrane separation technologies that can be employed within the methods and devices of the invention for processing, refining or treating liquid compositions include microfiltration, ultrafiltration, nanofiltration, reverse osmosis, electrodialysis, electrodeionization, pervaporation, membrane extraction, membrane distillation, membrane stripping, membrane aeration, and other membrane-based processes. Various driving forces may be used principally, or in combination with other driving forces disclosed herein, to make or enhance membrane function, depending on the type of the membrane separation employed. Pressure-driven membrane filtration, also known as membrane filtration, includes microfiltration, ultrafiltration, nanofiltration and reverse osmosis, and uses pressure as a driving force, whereas electrical driving force is used in electrodialysis and electrodeionization.

Historically, membrane separation processes or systems have not been considered cost effective for water treatment due to the adverse impacts that membrane scaling, membrane fouling, membrane degradation and the like impose on the efficiency of removing solutes from aqueous water streams. More recently, however, advancements in technology have made membrane separation a more commercially viable technology for treating aqueous compositions suitable for use in industrial and residential water treatment processes.

The technology of solids-liquid separation using membranes has been rapidly developing within the wastewater treatment industry and in other membrane separation fields of use. For early membrane wastewater treatment plants, the predicted useful lifespan of membranes was between about 5-7 years. Currently, useful membrane lifespan in waste water treatment applications is often as long as 8 years or greater.

In North America and other areas of the world, water rationing has become increasingly common, even in cities that normally having good water resources, such as Vancouver, Seattle, and Calgary. Water rationing has become critical in many parts of the prairie and desert states. The moisture content in the soil in some areas is already less than in the “dirty thirties.” The primary factor in progressive water rationing restrictions has been attributed to the inability of existing potable water treatment plants to produce enough potable water to satisfy increasing domestic and commercial demands. Associated with this problem, there is a need for improved wastewater treatment capacity to increase production of mid-quality water for irrigation that is currently produced more expensively by potable water plants.

Presently, there are a number of membrane bioreactor plants operating at over eight million gallons per day (8 MGD), and a 12 MGD plant is reportedly under construction in Europe. Newer hotels have been engineered to have two sets of plumbing, one for potable water and one for recycle water for such uses as toilet flushing.

Most cities in North America that are growing have segregated surface drainage lines and sewer lines. Wherever there is an existing surface water drain line, it is feasible to run a small diameter recycle water return line inside the much larger drain line, without the high costs associated with excavation and new line placement. In this development model, cross contamination is not a significant concern, because when it is raining the recycle water is not required. Furthermore, the recycle line is pressurized with a higher quality water than the runoff water. The less expensive recycle water can be delivered to most locations in the city for use in irrigation and/or maintenance of streets, golf courses, parks, sod farms, nurseries, lawns, etc.

Alternatively, small treatment plants, such as those using improved long vertical shaft bioreactors that provide tertiary treatment, could be strategically placed throughout the urban areas and could be privately owned and operated without municipal involvement. In low demand periods, they could discharge directly into the surface water drains, thereby substantially reducing loads on municipal plants.

The improved long vertical shaft bioreactors accomplish BNR treatment in a single integrated bioreactor that uses sequential zones, each dedicated to a specific part of the total treatment. Therefore each zone may be optimized individually.

Technological advances in membrane separation, processing, and treatment technologies have been occurring at a rapid pace. The flux rate of membranes (flow rate per sq. feet of membrane surface) has been increasing while the cost per sq. feet has steadily decreased. In addition, membrane prices used in modern treatment and processing plants have been decreasing, and will decrease even more significantly over the next decade. These factors, taken together, encourage the use of membranes in the treatment of recycle wastewater, among other processes. For example, recent membrane bioreactor (MBR) pilot plant trials at San Diego indicate that recycle water will cost $3.05/1000 gal and $1.92/1000 gal when produced in plants of 1 and 5 MGD size respectively. This cost includes amortization of capital, operating and maintenance costs based on year-round operations. At least one golf course in Seattle pays $3.96/100 cu. feet of potable water ($5.29/1000 gal) on a seasonal demand basis.

Membrane bioreactors require periodic cleaning to maintain their performance. The cleaning frequency depends on the type of membranes and their operating environment, and is typically as frequent as every few months. Existing reactors typically are not operational during membrane cleaning, causing a temporary and reoccurring loss of wastewater treatment capacity. Further, cleaning often involves use of expensive, specialized chemicals requiring compliance with environmental regulations in use and disposal.

The improved long vertical shaft bioreactors offer distinct process advantages over other bioreactors, and there is a need for new methods and apparatus incorporating membranes in such improved bioreactors. There is a further need to configure gas permeable membranes in these reactors in a matter that avoids asymmetric aeration patterns and inefficient gas transfer.

### SUMMARY OF THE INVENTION

The present invention satisfies these needs and fulfills additional objects and advantages that will become apparent from the following description and appended drawings. Embodiments of the invention provide improved systems, devices, and methods for in situ aeration of liquids and liquid suspensions using vertically deployed gas permeable membranes. Vertical gas permeable membranes are configured to have substantially uniform fine bubble emergence rates across a vertical height of the membrane.

The devices may include at least one fluid submerged, vertically oriented membrane, porous tubing, porous plate, screen, or combinations thereof, hydraulically connected to a gas source, such as compressed air or oxygen. The membrane, tubing, plate, or screen may be part a separate deep shaft waste treatment system, or incorporated within a deep shaft system retrofitted to augment conventional waste treatment facilities.

Submerged gas diffuser assemblies of the invention are configured to aerate liquids and liquid suspensions with substantially the same fine bubble aeration rate per unit area along the vertical height of the membrane. This substantially uniform fine bubble aeration rate enhances aeration by providing symmetric gas contact patterns from the vertically deployed gas permeable membranes into exposed liquids. Fine bubble streams are generated by an improved shearing effect of vertically flowing liquids across the vertically orientated membranes. The fine bubbles are smaller from the vertical membranes because the improved shearing from the vertically flowing fluids cleaves off smaller bubbles as they emerge from the membrane in contrast to the bubble nucleation or growth that occurs in horizontal membrane devices.

Adjusting the spatial configuration of gas permeable membranes varies aeration contact patterns and rates. Altering the liquid flow patterns around the vertically deployed membranes, and manipulating trans-membrane pressures across the membrane's vertical height, helps establish the formation of substantially uniform fine bubbles. Efficiency of gas exchange across membranes depends upon the liquid flow rates presented to the membrane assemblies, the contents within the liquids, the membrane surface area, and the rate of draining fluids from internal regions of the diffuser. Under some circumstances, the diffuser may under hydro-locking in which a selective occlusion of certain portions of membrane surface area generate gas impermeable regions. The membrane assemblies are designed to prevent, control, or mitigate membrane fouling and hydro lockup by effectively draining fluids from internal regions of the diffuser to mitigate hydro-locking that might develop.

As described below, the membranes may be spatially configured in plates, conical arrays, or cylindrical assemblies. The fine bubble gas flow across the membrane is substantially uniform across the vertical depth of the membrane by diffuser designs that establish a uniform trans-membrane pressure differential along the length of the vertically deployed gas permeable membrane.

The gas is delivered to internal regions of the membrane resulting in the distribution of fine gas bubbles substantially evenly throughout the membrane's vertically orientated surface. Depending on membrane design, the gas bubbles are distributed evenly by the membrane without a “wetting out” or hydro blocking effect, and in other cases when wetting out occurs, the diffuser designs advantageously allows the countering of wetting out events. That is, when hydro blocking or locking occurs, diffuser designs provide for the mitigation, reduction, and elimination of wetting out events.

The configuration of the devices, the system employed, and the methods for operating the aeration membrane creates a liquid composition or liquid suspension having a high oxygen content referred to as hyper oxygenated or hyper 0₂. Alternate designs include membranes having a pore geometry that prevents the fouling by suspended solids and other apparatus designs having membrane assemblies amenable for rapid removal for servicing and re-installation into shafts, containers, or ponds. Yet other designs are amendable to in-situ cleaning through back flushing in gas pipes during servicing cycles.

Other embodiments described below further include vertically orientated gas diffusers that present differing gas emerging patterns having discernable migration fronts and those membranes not having discernable migration fronts. Diffusers having migration fronts may show a progressive bubble pattern movement from one region of the vertical orientated membrane surface to another region, for example bottom-to-top. Other embodiments have a near simultaneous gas emerging pattern from the surface of gas bubbles emerging from substantially all regions of the vertical orientated membrane surface without an apparent gas bubble migration front.

Yet other embodiments of the invention also provides methods and devices having improved through-put and operating life of submerged membranes used in biological treatment of waste waters, and increased time between cleaning and maintenance of the membranes. More specifically, the invention relates to membrane separation methods and devices employing a selective, semi-permeable, microporous, or other partitioning membrane for processing, refining, and/or treating liquid compositions, for example membrane waste-water purification processes and apparatus. Other aspects of the invention improve diffusion of a gas in a liquid by creating a substantially uniform pressure differential between opposite sides of a membrane.

Within one aspect of the invention a submerged membrane assembly and associated methods and apparatus are provided. The submerged assembly typically includes a membrane having at least a first surface and a second surface, which most often comprise opposing faces of a planar membrane. In certain embodiments the opposing surfaces of the membrane are square or rectangular, and the membrane has a vertical axis (e.g., a vertical defined by one side of a square-configured membrane or an elongated side of a rectangular membrane). The membrane is permeable between the first and second surfaces by molecules of less than a predetermined size.

Within other aspects of the invention, the submerged membrane assembly includes a first fluid compartment that contains a first fluid having a first specific gravity in fluid communication with the first membrane surface. The assembly also includes a second fluid compartment that contains a second fluid having a second specific gravity in fluid communication with the second membrane surface.

Additionally, the membrane assembly typically includes means for imposing a differential hydraulic head between the first fluid contained in the first compartment and the second fluid contained in the second compartment, and means for changing the second specific gravity. The differential hydraulic head imposing means may include the first fluid compartment, wherein the first fluid compartment defines a first column height, and the second fluid compartment, wherein the second fluid compartment defines a second column height. The second column height may be selected relative to the first column height to produce a selected pressure differential across the membrane along the vertical axis of the membrane at the first specific gravity and a changed second specific gravity (i.e., the second specific gravity altered from an initial second specific gravity value to the changed second specific gravity value by operation of said means for changing the second specific gravity). The first column height and the second column height may each be established solely by gravity and construction and design of the first and second fluid compartments (typically by having an outflow or overflow port or opening in the second fluid compartment that is lower in correspondence to the membrane vertical axis than a fluid column height in the first fluid compartment). The differential hydraulic head imposing means may alternatively include a means for applying a pressure differential between the first and second fluid compartments. For example, a negative pressure generating means or vacuum may be applied to the second compartment or fluid to generate a reduced pressure in the second fluid compared to fluid pressure of the first fluid in the first compartment. Alternatively, a positive pressure generating means or pressurizing device may be applied to the first compartment or fluid to generate an elevated pressure in the first fluid compared to fluid pressure of the second fluid in the second compartment.

Within various embodiments of the invention, the second specific gravity changing means may include a means for directly or indirectly introducing gas into the second fluid in the second compartment. For example, gas can be directly dissolved in the second fluid or directly introduced into the second fluid in the form of bubbles, thereby reducing the second specific gravity to the desired, changed second specific gravity value. Typically, the first fluid contains a dissolved gas, and gas is introduced from the first fluid to the second fluid by passing through the membrane from the first side to the second side, either in solution or in the form of microbubbles or larger gas bubbles. In certain embodiments, dissolved gas (e.g., air or oxygen) in the first fluid passes between the first and second surfaces of the membrane and, at or near the second surface, nucleates to form gas bubbles that are incorporated in the second fluid. When the gas introducing means thus involves transfer of dissolved gas from the first fluid into the second fluid, the gas can nucleate at or near the second membrane surface, which may include nucleation between the first and second membrane surfaces, at the second membrane surface, within the second fluid compartment, and/or dissolution of the gas within the second fluid. The gas introducing means can alternately achieve dissolved gas introduction from the first to the second fluid without dissolution of the gas and formation of bubbles, which can alternatively take place after the gas introduction or not at all. In yet additional embodiments, the dissolved gas of the first fluid may nucleate in response to a mechanical action imparted by passing through the membrane, in response to a pressure differential across the membrane, or in the second fluid in response to a difference in dissolved gas levels between the first fluid and the second fluid. In certain other embodiments, the means for changing the second specific gravity may include a gas introduction port coupled to the second fluid compartment for introduction of gas into the second fluid. Gas can be introduced into the second fluid via this gas introduction port in the form of pressurized gas or in other forms, for example by introducing a gas-saturated fluid that mixes with the second fluid.

Another aspect of the invention provides a submerged membrane assembly. The submerged membrane assembly includes a membrane having a first surface, a second surface, and a vertical axis, and which is permeable between the surfaces by molecules of less than a predetermined size. The assembly further includes a first fluid compartment in fluid communication with the first membrane surface that contains a first fluid having a first specific gravity at a first column height, a second fluid compartment in fluid communication with the second membrane surface that contains a second fluid having a second specific gravity at a second column height, and means for changing the second specific gravity. The second column height selected relative to the first column height to produce a selected pressure differential across the membrane along the vertical axis at the first specific gravity and the changed second specific gravity. The second specific gravity changing means may include a gas added to the second fluid, and the gas may be added by direct or indirect introduction of gas into the second fluid (typically in bubble form, but optionally in an initially dissolved form). In exemplary embodiments, the second specific gravity changing means includes a gas added to the second fluid by a dissolved gas of the first fluid permeating through the membrane and nucleating proximate to, or within, the second fluid. The gas may nucleate at or near at least a portion of the second surface of the membrane and optionally impart a desired scouring action on the membrane by nucleation (either between the first and second membrane surfaces in the event nucleation occurs within the membrane, or more typically at or near the second membrane surface) and/or by the mechanical effects of bubbles rising in the second fluid.

The membrane assembly may optionally include a gas inlet port coupled to the second fluid compartment for direct introduction of gas (e.g., dissolved in a fluid, or in pressurized gas form) into the second fluid.

The assembly may further include a fluid collector that collects fluid from the second compartment, for example through an overflow port at or near the second fluid column height. In certain embodiments, the first fluid compartment may be a head tank or a saddle tank of a vertical bioreactor or other wastewater treatment apparatus.

For use in wastewater treatment applications, the membrane assembly of the invention typically includes a semi-permeable membrane that excludes particle exchange between the first and second surfaces (permeation) by particles of a size greater than a selected size indicated for the processed (effluent) water. For most treated wastewater, the selected membrane pore size will be less than or equal to about 2 microns, more typically less than or equal to 0.5 microns, and often less than or equal to 0.1 micron. The membrane may include any of a variety of commercially available membranes for use in wastewater treatment applications, for example a flat plate membrane, or a hollow fiber membrane.

In related aspects of the invention, the submerged membrane assembly includes a membrane having a first surface, a second surface, and a vertical axis, and is permeable between the first and second surfaces by molecules of less than a predetermined size. The assembly includes a first fluid compartment in fluid communication with the first membrane surface which contains a first fluid having a first specific gravity at a first column height. The assembly also includes a second fluid compartment in fluid communication with the second membrane surface which contains a second fluid having a second specific gravity at a second column height. The second fluid contains, or is altered to contain, a gas in an amount sufficient to adjust the second specific gravity to more closely approximate the first specific gravity. In exemplary embodiments, the gas contained in the second fluid is in the form of gas bubbles. A fluid collector is fluidly connected to the second compartment at the second fluid column height to collect fluid from the second compartment. The second column height is selected relative to the first column height to produce a selected pressure differential across the membrane along the vertical axis. The first fluid compartment further may include a first fluid outflow at the first column height. The first fluid may include dissolved gas. The gas in the second fluid may include bubbles formed by a dissolved gas of the first fluid that has permeated the membrane and nucleated (within or proximate to the second fluid, for example by nucleating at or near the second membrane surface). A gas bubble rising in the second fluid may impart a cleaning action on the second membrane surface. The second fluid compartment may include a gas inlet port to introduce gas directly into the second fluid (as an alternate, or complementary gas introduction means to gas that permeates between the first and second membrane surfaces from the first fluid. The first column height and the second column height may be established without a mechanical device, e.g., solely as determined by gravity, or by application of negative pressure to the second fluid or positive pressure to the first fluid.

The methods and devices of the invention are broadly applicable within fluid treatment methods and devices. In various treatment processes and devices where membranes are employed, where fluids containing solids tend to foul the membranes or where clean fluids have a slow permeate rate, the invention provides substantial advantages. In the case of drinking water, membrane run time can be extended by adding CO2 to the first and/or second fluids, which is also desirable for pH adjustment of the water. Industrial filters, for example filters to remove sediment and precipitated protein from chilled beer, this will also be advantageous for recarbonation prior to bottling. Inert gas filtration, such as gasoline purification using nitrogen gas, is also amenable to optimization using the methods and devices of the invention. In this case, a gas recovery system is provided downstream of the membrane, and a repressurization system may also be employed. Nitrous oxide may also be employed as an added gas (e.g., as a gas introduced into the second fluid) to yield desired fuels/additives.

In the case of viscous fluids, such as lubricants, processing of such fluids will also be facilitated by the methods and devices of the invention, particularly by using an inert gas within said methods and devices. Inert gases, such as nitrogen, argon, helium, carbon dioxide, are all candidates for such applications. Active gasses, such as methane, are only sparingly soluble in water, and therefore will have more limited uses within the invention. Some gasses are sensitive to pH changes. For instance, bicarbonate of soda dissolves in water without pressure but a shift in pH will release CO2 in the same fashion that pressure changes do.

Other fluid processing technologies to which the methods and devices of the invention can be applied include, for example, desalinization plants, biotechnical and biomedical separation procedures (e.g., dialysis of blood and other body fluids), and environmental decontamination processes (e.g., oil and other petroleum contaminant removal from marine and fresh water sites).

In more detailed aspect of the invention, methods for treating fluids by membrane separation are provided that employ a selective, semi-permeable, microporous, or other partitioning membrane for processing, refining, and/or treating liquid compositions, for example membrane waste-water purification processes and apparatus. These methods include containing a first fluid having a first specific gravity, containing a second fluid having a second specific gravity, separating the first fluid from the second fluid with a permeable membrane having a first surface in fluid communication with the first fluid, a second surface in fluid communication with the second fluid, the membrane further having a vertical axis and being permeable between the surfaces by molecules of less than a predetermined size. The method further includes imposing a differential hydraulic head (e.g., passively by gravity and differential chamber overflow levels, or actively by application of positive or negative pressure as described herein) between the first fluid and the second fluid, adjusting the second specific gravity (typically by introduction of gas), and collecting the second fluid. Imposing the differential hydraulic head may further include containing the first fluid at a first column height, and containing the second fluid at a second column height, wherein the second column height is selected relative to the first column height to produce a selected pressure differential across the membrane along the membrane vertical axis at the first specific gravity and the adjusted second specific gravity.

Another aspect of the invention provides a method of treating a fluid by membrane separation employing a selective, semi-permeable, microporous, or other partitioning membrane for processing, refining, and/or treating liquid compositions, for example membrane waste-water purification processes and apparatus. The method includes containing a first fluid having a first specific gravity at a first column height, and containing second fluid having a second specific gravity at a second column height. The method includes separating the first fluid from the second fluid with a permeable membrane having a first surface in fluid communication with the first fluid, and a second surface in fluid communication with the second fluid. The membrane has a vertical axis and is permeable between the surfaces by molecules of less than a predetermined size. The method further includes adjusting the second specific gravity to more closely approximate the first specific gravity in value. Alternate normalization of specific gravities between the first and second fluids can be achieved in other ways, for example by introduction of non-gaseous solutes into the first fluid. In certain embodiments, the second specific gravity is adjusted to within approximately +/−5 percent of the first specific gravity (i.e., to a value that is 95% of the value of the first specific gravity). In another embodiment, the second specific gravity is adjusted to within approximately +/−2.5 percent of the first specific gravity. The method also includes production of a selected pressure differential across the membrane along its vertical axis at the adjusted second specific gravity, for example by providing or selecting a second column height that differs from the first column height. In more detailed embodiments, the method further includes collecting the second fluid, for example by overflowing or off-draining the second fluid as a processed effluent.

Another aspect of the invention provides an improved vertical shaft bioreactor and associated methods for treatment of wastewater. The vertical bioreactor and associated methods are as described herein, above. The bioreactor receives an influent of wastewater containing biodegradable matter for treatment and produces an effluent flow which is directed to a submerged membrane assembly of the invention. The improvement in the bioreactor includes a membrane-adapted head tank that functions as a normal vertical shaft bioreactor head tank but is modified to receive and contain the effluent flow and removably receive the submerged membrane. The submerged membrane includes a permeable membrane having a first surface, a second surface, and a vertical axis, and which is permeable between the surfaces by molecules of less than a predetermined size. The first membrane surface is in fluid communication with the effluent flow in the head tank, and the second membrane surface is in fluid communication with a second fluid having a second specific gravity and contained in a second fluid compartment. The improvement includes a means for imposing a differential hydraulic head between the effluent flow contained in the tank and the second fluid contained in the second fluid compartment, and a means for adjusting the second specific gravity. In more detailed embodiments, the improvement also includes a fluid collector that collects the second fluid.

In other detailed aspects the invention provides an improved bioreactor for treatment of wastewater, the bioreactor receiving an influent of wastewater containing biodegradable matter for treatment and producing effluent flow having a first specific gravity. The improvement includes a tank that receives and contains the effluent flow at a first column height, and that removably mounts a submerged membrane assembly, and a fluid collector that collects the second fluid. The submerged membrane assembly includes a permeable membrane having a first surface, a second surface, and a vertical axis, and which is permeable between the surfaces by molecules of less than a predetermined size. The first membrane surface is in fluid communication with the effluent flow. A second fluid compartment (separated by the membrane from the head tank) contains a second fluid having a second specific gravity at a second column height, and the second membrane surface is in fluid communication with the second fluid. The improvement further includes a means for adjusting the second specific gravity. The second column height is selected relative to the first column height to produce a selected pressure differential across the membrane along the vertical axis at the changed second specific gravity. A portion of the contained effluent flow may be exposed to a normal atmospheric pressure.

In yet additional detailed aspects the invention provides a submerged membrane gas diffusion apparatus. The apparatus includes a membrane having a first surface and a second surface, and a vertical axis, and which is permeable between the surfaces by molecules of less than a predetermined size. The apparatus includes a first containment member, typically a tubular containment member, having a bubble capture aperture, a first membrane mounting portion in fluid communication with the first surface of the membrane, and a first chamber in fluid communication with the first membrane mounting portion and the bubble capture aperture, the chamber including a rising gas bubble capture portion proximate to the bubble capture aperture and having a first vertical length. The apparatus further includes a second containment member, typically a tubular containment member, having a gas release aperture, a second membrane mounting portion in fluid communication with the first surface of the membrane, and a second chamber in fluid communication with the second membrane mounting portion and the gas release aperture, the chamber including a gas reservoir portion proximate to the gas release aperture and having a second vertical length that is less than the first vertical length. Notably, the first and second containment members can be constructed and dimensioned according to a variety of designs to function in the manner disclosed herein below, whereas the tubular design described herein is provided for exemplary purposes only.

Another aspect of the invention provides a submerged membrane gas diffusion assembly. The assembly includes a membrane having a first surface and a second surface, and a vertical axis, and which is permeable between the surfaces by molecules of less than a predetermined size. The assembly includes an aeration compartment that contains a first fluid and rising bubbles of a gas, a static fluid compartment that contains a second fluid, and a fluid treatment compartment that contains a fluid to be treated in fluid communication with the second membrane surface. The assembly also includes a first tubular member having a bubble capture aperture located in the aeration compartment, a first membrane mounting portion in fluid communication with the first surface of the membrane, and a first chamber in fluid communication with the first membrane mounting portion and the bubble capture aperture, the chamber including a rising gas bubble capture portion proximate to the bubble capture aperture and having a first vertical length. The assembly further includes a second tubular member having a gas release aperture located in the static fluid compartment, a second membrane mounting portion in fluid communication with the first surface of the membrane; and a second chamber in fluid communication with the second membrane mounting portion and the gas release aperture, the chamber including a gas reservoir portion proximate to the gas release aperture and having a second vertical length that is less than the first vertical length.

A further aspect of the invention provides a method for diffusing a gas into a target fluid. The method includes permeably separating the target fluid from the gas with a membrane, the membrane having a first surface in contact with the gas, a second surface in contact with the target fluid, and which is permeable between the surfaces by molecules of less than a predetermined size. The method also includes capturing the gas by receiving a first fluid that includes rising bubbles of the gas into a bubble capture aperture of a first chamber, the first chamber including a rising gas bubble capture portion proximate to the bubble capture aperture and having a first vertical length. The method further comprises imposing a hydraulic head on the gas in the first chamber using a buoyancy of the gas in the first fluid to displace the first fluid from the bubble capture portion. Imposition of the hydraulic head forces the gas to flow between the gas bubble capture portion of the first chamber and a first membrane mounting portion of the first chamber, which is in fluid communication with the first surface of the membrane. The method further includes permeation of at least a portion of the gas through the membrane and into the target liquid in response to imposition of the hydraulic head. In addition, the gas flows between a second membrane mounting portion, which is in fluid communication with the first surface of the membrane, and a second chamber. The second chamber has a gas reservoir portion proximate to a gas release aperture and a second vertical length that is less than the first vertical length. The method automatically releases the gas through the gas release aperture when the hydraulic head displaces a second fluid from the gas reservoir portion.

Additional aspects of the invention are set forth in detail in the following description and appended drawings.

### BRIEF DESCRIPTION OF THE DRAWINGS

Illustrative and alternative embodiments of the present invention are described in detail below with reference to the following drawings.

FIG. 1 is a diagrammatic vertical section through one embodiment of a bioreactor according to the invention for use in waste water treatment.

FIG. 2 is a diagrammatic vertical section through one embodiment of a bioreactor according to the invention for use in waste water treatment. This embodiment features a conventional sedimentation clarifier followed by an aerated polishing biofilter followed by an ultra violet light disinfection chamber and back wash tank.

FIG. 3 is a diagrammatic vertical section through one embodiment of a bioreactor according to the invention for use in waste water treatment. This embodiment features an integrated circular sedimentation clarifier surrounding the circular zone 2 head tank which surrounds the circular zone 1 head tank. All three tanks being concentric with the vertical reactor. A provision is made to return settled activated sludge by gravity to either zone 1 or zone 2.

FIG. 4 is a diagrammatic vertical section through one embodiment of a bioreactor according to the invention for use in waste water treatment. This embodiment features moving bed media circulating in zone 2 or alternately fixed media suspended in the head tank of zone 2.

FIG. 5 is a diagrammatic vertical section through one embodiment of a bioreactor according to the invention for use in waste water treatment. This embodiment features a pressurized head tank, an off-gas collector means, said off-gas driving an air lift influent pump required to overcome said head tank pressure, a membrane filtration cartridge operating under pressure to separate biomass from liquid and a clean water ultraviolet (UV) disinfecting chamber also serving as back wash storage for membrane backwashing.

FIG. 6 is a diagrammatic vertical section through one embodiment of a bioreactor according to the invention for use in waste water treatment. This embodiment features an integrated clarifier followed by an aerated polishing biofilter followed by an ultra violet light disinfection chamber and filter back wash tank.

FIG. 7 is a diagrammatic vertical section through one embodiment of a bioreactor according to the invention for use in treatment of biosolids. This embodiment features an inter zonal self batching air lock at the bottom of the bioreactor. In this case, zone 2 head tank is concentric and internal to zone 1 head tank.

FIG. 8 is an isometric vertical section through one embodiment of the bioreactor according to the invention for use in waste water treatment. This section shows typical arrangement of various channels and the position of the aeration distribution header, zone 1 head tank, zone 2 head tank and an integral sedimentation clarifier.

FIG. 9 is an isometric vertical section of a portion of reactor internal channels and down corner flanged and bolted. This figure shows a down corner expansion tool which is used during insertion of the assembly into the reactor casing.

FIG. 10 is a diagrammatic end view of the reactor internal section showing the down corner and radial baffles. The element in the center represents the expansion tool in its relaxed position. The down corner is also in its relaxed position. The removable expansion tool which is operated by actuation means from the ground level is inserted in its relaxed position during fabrication.

FIG. 11 is a diagrammatic end view of the reactor internal section showing the down corner forced out of round by the expansion tool. The radial baffles connected to the down corner are shown relaxed from the casing wall, allowing easy insertion.

FIG. 12 provides a graphical representation of the EPA time and temperature requirements for class A bio-solids.

FIG. 13 provides an exemplary block flow diagram of the present invention adapted to produce recycle quality water, Class A bio-solids, and clean odorless off-gas, the flow diagram having the following key described in items A-Z:

Preliminary treatment

| | |
|---|---|
| A | Fine screens |
| B | Solids hopper-Screenings and washed grit |
| C | Hyrdaclone degritter |

Waste water BNR treatment as described herein

| | |
|---|---|
| D | Deoxygenation unit (channel 32 + 40) |
| E | Denitrification (head tank 16) |
| F | Anoxic/anaerobic unit (channel 12) |
| G | Aerobic unit (zone 1 channel 80) |
| H | Nitrification (zone 2 head tank, 110 and 82) |
| I | Sedimentation clarifier (120) |
| J | Waste activated sludge float thickener |
| K | Alum or ferric chloride feeder |
| L | Process air compressor |

Recycle quality water (units required by law)

| | |
|---|---|
| M | Flocculating tank |
| N | Cloth disk filter |
| 0 | Chlorination |
| P | Ultraviolet disinfection |
| Q | Backwash pump |

Thermophilic aerobic digestion as described herein
class A biosolids

| | |
|---|---|
| R | Zone 1 thermophilic aerobic digester |
| S | Zone 2 |
| T | Acid feeder |
| U | Polymer feeder |
| V | Centrifuge de-watering |
| W | Flotation cell |
| X | Air compressor |
| Y | Off gas collection system |
| Z | Class A bio-solids collection |

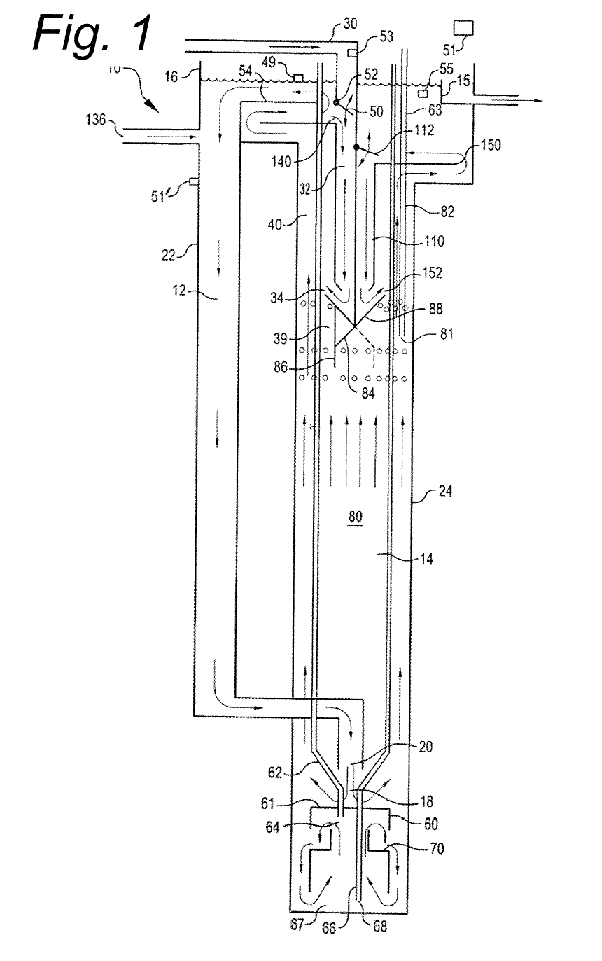

FIGS. 14-1 through 14-7 illustrate a presence of nucleated dissolved air or applied dispersed air on the clean water (or permeate) side of a permeable membrane, creation of an equalized pressure differential along a vertical axis of a submerged permeable membrane assembly, and scouring the clean water side of the membrane with rising bubbles, according to an embodiment of the invention.

FIG. 15 is a top perspective view of a bioreactor head tank, and a membrane bioreactor head having plurality of saddle tanks mounting membrane bioreactor assemblies, according to an embodiment of the invention.

FIG. 16A is a top view of the saddle tank of the membrane bioreactor head of FIG. 15 illustrating a top membrane bioreactor assembly that includes a plurality of flat plate permeable membranes, according to an embodiment of the invention.

FIG. 16B is a cross-sectional side view of the bioreactor head tank of FIG. 15, and of the saddle tank having a stack of four membrane bioreactor assemblies positioned vertically above each other, according to an embodiment of the invention.

FIG. 17 illustrates a folded saddle tank system that includes a first folded saddle tank and a second folded saddle tank that collectively carry the membrane assemblies, according to an embodiment of the invention.

FIG. 18 illustrate results of a series of membrane throughput tests conducted on bench test apparatus of under varying condition and levels of diffused gas in water, according to an embodiment of the invention.

FIG. 19 illustrates results of a series of temperature vs. viscosity tests conducted on the bench test apparatus.

FIG. 20 illustrates a cross-sectional view of a gas diffusion apparatus that maintains equal pressure differentials across a plurality membrane in a gas-liquid system, according to an embodiment of the invention.

FIG. 21 illustrates several aspects of the gas diffusion apparatus of FIG. 20, according to an embodiment of the invention.

FIG. 22 illustrates a cross-sectional view of a cone-shaped diffuser.

FIG. 23A illustrates in cross-section a cone-shaped diffuser fitted with a non-gas permeable flexible diaphragm.

FIG. 23B is a close-up isometric illustration of the gas diffuser of FIG. 23A.

FIG. 24 illustrates a cylinder embodiment of FIG. 22.

FIG. 25 illustrates a cylinder embodiment of FIG. 24.

FIG. 26 illustrates a cylindrical gas diffuser using a bellows activator and non-flexible gas impermeable diaphragm.

FIG. 27A illustrates a gas ribbed diffuser embodiment having a flexible diaphragm.

FIG. 27B illustrates a portion of an alternate embodiment of the diffuser of FIG. 27A.

FIG. 28 illustrates a porous tube gas diffuser equipped with a flexible diaphragm.

FIGS. 29A and 29B illustrates top and side cross-sectional and isometric views of a flat plate diffuser equipped with a flexible gas impermeable diaphragm.

FIGS. 30A-C illustrates in partial cross-sectional and isometric views a plate diffuser extension in connection with cylinder diffusers.

FIG. 31 illustrates a combination ribbed cylinder and plate extension diffuser.

FIG. 32 illustrates a combination needle valve cylinder and plate extension diffuser.

FIG. 33 illustrates an isometric view of the plate extension embodiment of FIG. 30 with a receiver shell to fit cylindrical diffusers.

FIG. 34A illustrates a plan view of a combination diffuser having multiple parallel plate extensions.

FIG. 34B illustrates a plan view of an array of combination diffusers with interleaved plate extensions.

FIG. 34C illustrates a plan view of a combination diffuser having a radial assembly of plate extensions.

FIG. 35 illustrates a plot of closing pressures, trans-membrane pressures, and trans-diaphragm pressures of the diffuser of FIG. 27.

FIG. 36 is a data graphic of the oxygen transfer efficiency of the diffuser illustrated in FIG. 27.

FIG. 37A illustrates isometric and cutaway views of a vertical shaft having a submerged diffuser adjacent to a horizontal distributor.

FIGS. 37B-E illustrates expansions of cross sectional views along lines A-A and B-B of FIG. 37A.

FIG. 38 is a plot of terminal velocity of air bubbles as a function of bubble size.

FIG. 39 illustrates a cross-section of an alternate diffuser embodiment having a non-gas permeable flexible diaphragm configured to stabilize hydraulic flow.

FIG. 40A illustrates an expansion of the structural detail of an inverted U-tube located in the wall region of the down corner near the air injection locus of FIG. 39.

FIG. 40B illustrates an expansion of the structural detail of the cone-shaped diffuser of FIG. 39.

### DETAILED DESCRIPTION OF EXEMPLARY EMBODIMENTS OF THE INVENTION

As further discussed below, FIGS. 22-37E concern the design of hyper oxygenated or hyper O₂ devices and systems.

As further illustrated in FIGS. 1-21, other embodiments of the invention that provide a long vertical shaft bioreactor 10 for wastewater treatment. The bioreactor of the exemplary embodiments shares a number of structural and functional characteristics with previously described vertical shaft bioreactor systems (see, e.g., U.S. Pat. Nos. 4,279,754, 5,645,726, and 5,650,070 issued to Pollock, each incorporated herein by reference), but departs in several important and novel aspects therefrom.

In one embodiment of the invention depicted in FIG. 1, a vertical shaft bioreactor 10 of the invention features a wastewater circulation system which includes two or more substantially vertical channels, including at least one downflow channel, or down corner channel 12, fluidly interconnected in a circuitous, open or closed, path with at least one upflow channel, or riser channel 14. The down corner and riser channels may be interconnected at their upper ends via a surface basin or head tank 16, which may be open or closed, and at a lower junction corresponding to a mix zone 18 situated below a lower port or aperture 20 of the down corner.

The down corner 12 and riser 14 channels may be defined by separate conduits, for example by separate, cylindrical-walled pipes. Alternatively, they may be defined as interconnected compartments or channels sharing one or more walls, for example as parallel channels separated by partitioning structures (e.g., radial partitions or septa) within an elongate, compartmentalized reactor vessel or frame. The down corner 12 and riser 14 channels are preferably oriented substantially parallel to one another, for example in a side-by-side or coaxial relative configuration.

Typically, the down corner 12 and riser 14 channels may be defined as separate conduits over at least a portion of their lengths. In one example, the down corner channel is defined by a separate, cylindrical-walled down corner conduit (e.g., a steel pipe) 22 nested coaxially within a larger diameter, cylindrical walled riser conduit 24 (which will often correspond to an outer wall or casing of the entire bioreactor assembly). As such, the attached Figures are generally to be interpreted as schematic illustrations, wherein for ease of illustration the drawings which show the down corner conduit laterally displaced relative to the riser conduit are intended also to schematically illustrate an alternative, parallel or coaxially nested configuration of the down corner conduit within the larger riser conduit.

In one embodiment of the invention adapted for residential use, the wastewater treatment bioreactor 10 of the invention is constructed to service a small residential community of about 5,000 populations. Typically, two parallel bioreactors are installed in accordance with EPA redundancy requirements, in vertical in-ground shafts bored using conventional drilling technology. In various embodiments, the bioreactor of the invention can be constructed, configured with secondary features, or adjusted to provide the secondary and/or tertiary levels of treatment, listed below.

a) Secondary treatment (BOD and TSS removal) only.

b) Secondary treatment with nitrification of ammonia (conversion of ammonia to nitrate).

c) Secondary treatment with nitrification and denitrification (removal of ammonia and nitrate).

d) Secondary treatment with nitrification, denitrification, and chemical phosphorus removed (tertiary treatment). Some biological phosphorus removal will occur at low loads.

e) Thermophilic aerobic digestion and pasteurization of sewage sludges to produce class A biosolids.

In brief reference to the following description, the secondary treatment of a) above may be completely aerobic both in the zone 1 head tank 16 and down corner channel 12 of zone 1, and in the zone 2 upflow channel(s) 82 and head tank 15. This configuration requires a shaft of about 30 inches diameter and 250 feet deep, a zone 1 head tank of about 6 feet diameter×10 feet deep and a concentric zone 2 head tank of about 12 feet diameter×10 feet deep. The concentric clarifier is about 28 feet diameter×10 feet deep and is fitted with a rake mechanism to assist in sludge removal. In more detailed embodiments, this reactor will treat residential sewage from at least a 2,500 member human population and produce <30 mg/L TBOD and <30 mg/L TSS.

The secondary treatment process of b) is also completely aerobic and of the same general dimensions as a) except the zone 2 head tank is about 16 feet in diameter. A larger portion of the air originating at the bottom of zone 1 is diverted into zone 2 using a diverter mechanism 84. The treatment system of c) above is designed for anoxic conditions in the head tank and down corner of zone 1. In certain embodiments, this reactor will treat residential sewage from at least a 2,500 member human population and produce <1 mg/L ammonia-N, <15 mg/L TBOD, and <15 mg/L TSS.

Only a small fraction of air from the lower portion of zone 1 is diverted into the zone 1 upflow channel(s) 40. In addition to raw influent feed in the upper end of zone 1, recycled nitrified effluent or return activated sludge from the clarifier or, alternatively from zone 2 head tank, is added to the raw influent to create the anoxic conditions.

In this treatment process the reactor is enlarged to approximately 36 inches in diameter, zone 1 head tank is increased to about 8 feet diameter, zone 2 head tank is increased to about 16 feet in diameter. The concentric clarifier has an outside diameter of about 30′ and is fitted with a rake mechanism. In more detailed embodiments, this process will treat residential sewage from a human population of 2,500 or greater to <5 mg/L TKN, <10 mg/L TBOD, and <10 mg/L TSS.

The treatment system of d) above is the same general dimension of c). Within the treatment process of d), alum of ferric chloride may be added into zone 2 for chemical precipitation of phosphorus. It is usually uneconomic to use only a biological phosphorus removal process alone to achieve a high degree of phosphorus removal (e.g., 2-3 mg/L residual) on small plants, since a pre-fermentation step to produce volatile fatty acids (VFA) may be required. Typical characteristics of effluent from this plant are: TBOD<10 mg/L; TSS<10 mg/L; TN<5 mg/L; PO4<1 mg/L.

In the case of sludge treatment e), the reactor is reconfigured such that zone 1 surrounds zone 2, or may be adjacent to zone 2 throughout the major portion of the reactor length and zone 2 head tank 15′ surrounds the zone 1 head tank 16′. Zone 1 and zone 2 are hydraulically connected at the bottom of zone 2 through a self batching air lock device which precludes zone 1 contents from entering zone 2 while processing each batch. The thermophilic aerobic digester volume of configuration e) is about one half the volume of the wastewater treatment reactor producing the biomass. Because sludge storage provision is more economic to build than redundancy in reactors, only one digester is required for two treatment reactors. Accordingly the small town of about 5000 people requires 2 treatment reactors and 1 sludge digester all of the same size. The foregoing example is a typical design for small communities of about 5000 people.

Since about 80% of the voidage (air lift) occurs in the top 80-100 feet of any air lift reactor, the superior channels can be effective between 150 and 50 feet deep, preferably 80-88 feet which is the standard length of two joints of double random length pipe. Off the shelf air compressors are readily available in 100, 125 and 150 psi models correspond to shaft depth of 200, 250 and 300 feet. Although airlift bioreactors have been built between 60 feet and 500 feet depths, a more common range is 150 to 350 feet depth and a range of 200 feet to 300 feet is now most common.

Conventional water well rigs can drill holes up to about 48 inches and deep foundation equipment for pilings can drill up to about ten feet in diameter. Augers (where geology permits) can drill up to about 20-feet diameter but are limited to about 200-feet depth. Mined shafts can be up to 30 feet diameter and of virtually any depth.

Small municipal plant reactors (5000 population) will typically be placed with conventional water well rigs and preferably be about 24 to 48 inches in diameter.

Larger communities (10,000-50,000 population) may require shafts of 5 to 10 feet diameter×200 feet depth placed by deep foundation piling machines and augers, whereas very large industrial plants (e.g. pulp mills) may require shafts placed by mining techniques.

The long vertical shaft bioreactor 10 of the invention receives influent, typically wastewater or sludge, through an influent conduit 30 which introduces the influent into an influent channel 32. The influent flows downward to the bottom of the influent channel, where it exits through a shielded influent port 34 and combines with upflow in a zone 1 upflow channel 40 delineated at its lower end by the influent port. The influent port is upturned or otherwise shielded to prevent admission of bubbles from below the zone 1 upflow channel from entering the influent channel.

In alternate embodiments of the invention, the influent channel 32 can optionally accept recycle flow of liquor from the head tank 16 portion of zone 1 of the bioreactor 10. This flow is regulated by a zone 1 recycle flow regulator 50, for example a manual or motor-actuated baffle, valve or other flow-regulating apparatus. In this context, the influent flow through the zone 1 recycle regulator 50 is ordinarily throttled via an influent flow throttling control mechanism. This can include, for example, a system control unit 51 (e.g., a system control microprocessor) operatively linked to a valve or baffle actuator 52 and an optional flow sensor 53 or 53′ for determining influent and/or zone 1 recycle flow or alternatively dissolved oxygen DO probe 49 to monitor oxygen levels. Control of influent flow through the regulator functions in part to adjust the air lift in zone 1 upflow channel 40 and facilitate gravity influent flow. The combined flow in the zone 1 upflow channel contains some anoxic air bubbles (see below) and is therefore lighter than the fluid in influent channel 32, and rises. By anoxic air bubbles is meant bubbles predominately containing gasses other than useable oxygen. Flow in the zone 1 upflow channel 40 traverses a horizontal degas plate 54 and descends substantially free of entrained bubbles in the down corner channel 12 under gravity and enters the main riser channel 14 in the vicinity of the mix zone 18, where it is intensively aerated.

The compressed air or other oxygen-containing gas or liquid serving as the oxygenation source for the bioreactor 10 is typically delivered through one or more dedicated oxygenating lines, typically compressed air lines 62. A dedicated compressed air line is connected to a compressed air supply at the surface and runs downward parallel to the riser channel (e.g., nested within the riser conduit 24) extending to an oxygenation port, typically an air delivery port 64, that opens in fluid connection with the riser channel 14. The air delivery port 64 is generally positioned beneath the air distribution header 60 to release the compressed air for dispersal by the header, as described above. Within certain embodiments of the invention, compressed air (or other oxygen-containing gas or liquid) is optionally, or additionally, delivered within the bioreactor by a dual-service aeration/solids extraction line 66. Functioning of this line can be controlled, e.g., by a system control unit 51 as described above, to optionally deliver compressed air or other oxygen-containing gas or liquid and, in a second operation mode, serve as a waste solids extraction line 66 to purge waste solids from a sump 67 portion of the reactor located at the bottom of the riser channel. The waste solids extraction line extends from the surface (e.g., from a surface-located, waste-solids extraction/flotation reservoir) to an aeration/waste solids extraction port 68 opening in fluid connection with the sump. Solid particles that settle into the sump will accumulate over a period of hours of operation. For the majority of the bioreactor's operation time, the aeration/solids extraction line is continuously purged by flow of compressed air, and therefore the sump 67 is substantially mixed and aerated and forms a functional part of the mix zone 18. Periodically, the aeration/extraction line can be depressurized, whereby settled solids within the sump will rush to the top of the reactor to be purged therefrom. These solids are highly aerated, well stabilized (odor free) and because of the high gas content will spontaneously float to a thickened sludge.

In related embodiments of the invention, the improved vertical shaft bioreactor 10 features two simultaneously-operating aeration lines or ports to enhance the formation of small, dispersed bubbles to generate upflow currents and supply process air within the bioreactor. The use of two aeration lines is exemplified by the dedicated compressed air line 62 and dual-function aeration/solids extraction line 66, which each operate at least for a majority of the bioreactor process time in a compressed air delivery mode. In this mode, the two lines in concert provide a cooperative, multiple source compressed air injection mechanism of the invention, which serves to enhance the turbulence and small bubble-forming capacity within the mixing zone 18 of the reactor, which is in turn expanded by the cooperation of multiple compressed aeration lines or ports. In one aspect of this enhanced mixing/bubble forming mechanism, a first aeration line opening, exemplified by the air delivery port 64 of dedicated air line 62, is positioned below the air distribution header 60 and above a second aeration line opening, exemplified by aeration/extraction port 68 of the dual-function aeration/solids extraction line. Compressed air released from this lower aeration port stimulates fluid mixing and bubble formation near the bottom of the riser channel 14 to set up a first circulation path or vector. The resultant circulating fluid-bubble mixture impinges upwardly and/or transversely against mixed fluid and bubbles generated by the introduction of compressed air from the first, upper air line 62. This results in increased shear forces and the production of smaller air bubbles in an enlarged mixing zone, compared to the results achieved by operation of a single aeration line (see, FIG. 1).

In conjunction with the above-described use of a cooperative, multiple source compressed air circulation regime, certain embodiments of the invention incorporate a modified (typically stepped, chambered, or baffled) header, or a multi-component header complex, to augment the enhanced mixing/bubble forming mechanism provided by multiple, interactive aeration sources. In one aspect, a second, cooperating shear header 70 is mounted within the riser chamber 14 below the main bubble distribution header 60 and works in conjunction with two, vertically tiered aeration sources generally as described above. The shear header can be any flow diverting or channeling device that enhances an upward and/or transverse or radial flow component within the mixing zone generated by a second, lower-positioned aeration source (exemplified by the aeration/solids extraction port 68). In one exemplary embodiment, the shear header comprises an internally stepped draught tube (FIG. 1) attached by vertical struts to the underside of the distribution header. Compressed air fed into the aeration/solids extraction line 66 causes an air lift effect in the stepped draught tube, thus establishing a separate circulation pattern or vector in the lower portion of the mix zone as shown in FIG. 1. This upward and/or transverse or radial circulating flow impinges against mixed fluid and bubbles generated by the introduction of compressed air from the first, upper air line 62 near the perimeter of the distribution header, which interaction is regulated in part by air delivered though the aeration/solids extraction port, while the balance of process air is delivered though the dedicated air delivery port 64. This creates very high flow rates inside the serrated skirt in increased shear at the perimeter of the distribution header which aids substantially in shearing bubbles to a smaller size. Whereas previous bioreactors typically generate bubbles at the site of distribution in the range of about a half inch to three quarters of an inch in diameter, the novel interactive flow mechanism and cooperative header design of the invention generates substantially smaller bubbles, typically about one quarter to one half inch, often less than one quarter inch, down to as small as one-fifth to one-eighth inch or less in diameter. For example, studies published in the water Environment Research Journal May/June 1999 pgs. 307-315 (incorporated herein by reference) determined that bubbles about 2 mm are the optimum diameter for mixing and oxygen transfer. However bubbles of this size do not form naturally at an orifice without some mechanism for shearing the bubble. The bubble size is determined when the buoyancy force equals the attraction forces at the orifice and bubble size is not necessarily a function of orifice size. Since bubbles of this size range have a rise rate of about 0.8-1.0 feet/sec. in water, a downward circulation velocity of greater than 1 feet/sec. in the vicinity of the serrated skirt 60 will cause the bubble to be sheared from the orifice. The circulation velocity is regulated by the amount of air injected in line 68 and can be adjusted independently of the air being applied at orifice 64. Samples extracted periodically in line 66 can be measured for dissolved oxygen. The circulation velocity between aerator elements 60 and 70 can be adjusted to maximize the oxygen transfer. This novel design provides enhanced mixing and bubble distribution without unacceptable risk of clogging. When the aeration/solids extraction line is being used for biomass wasting, air-flow in the dedicated air line maintains reactor circulation. At this point, when the aerator barrel of the shear header is depressurized a new batch of waste biomass transfers from the mix zone 18 to the sump and aeration of biomass within the aeration barrel of the shear header begins again.

Yet additional embodiments of the invention are distinguished by virtue of their novel features for channeling, circulating, and segregating fluid, air and/or biomass within the reactor 10. These features are in turn variable, combinable in alternative reactor configurations, and/or adjustable within additional aspects of the invention allowing use or modification of the reactor for different wastewater treatment applications and results. In general aspects, the bioreactor 10 of the invention features a first treatment or processing “zone” designated zone 1, wherein the majority (e.g., greater than 80%, up to 90-95% or greater) of the primary reaction between waste, dissolved oxygen, nutrients and biomass (including an active microbial population), takes place. Within certain embodiments, this zone is defined to include an upper circulating zone of the bioreactor 10 comprising the surface basin or head tank 16, a primary reaction chamber 80 comprising a central volume of the riser channel 14, the down corner channel 12, and the mix zone 18.

The majority of the contents of the mix zone 18 represent a fluid-bubble mixture that is less dense than the fluid in the down corner channel 12 and therefore circulates upwardly from the mix zone into the primary reaction chamber 80. Undissolved gas, mostly nitrogen, expands to help provide the gas lift necessary to drive circulation of the liquor in the upper part of the reactor 10 in the patterns as shown by the arrows throughout the Figures. The products of this primary reaction are carbon dioxide and additional biomass which, in combination with unreacted solid material present in the influent wastewater, forms a sludge (or biosolids).

In certain embodiments of the invention, as illustrated in FIG. 1, upflow of fluid in the primary reactor channel 80 is segregated into multiple, smaller upflow channels in an upper section of the bioreactor 10. In one exemplary embodiment, upflow from the primary reactor channel is diverted into at least two discrete superior upflow channels, as exemplified by the zone 1 upflow channel 40 and a zone 2 (typically operated as a polishing zone) upflow channel 82 depicted in FIG. 1. In one exemplary construction design, flow diversion from the primary reactor channel into multiple, superior channels is achieved by employing a fixed or adjustable diverter plate 84 or comparable flow diverting device that is anchored near the top of the primary reactor channel.

The diverter plate 84 is configured and dimensioned to segregate the primary reactor channel 80 upflow into multiple superior channels. Typically, the diverter plate is configured and dimensioned to intercept and divert a larger fraction of total upflow volume of the fluid-bubble mixture from the primary reactor channel into a selected “aerobic” upflow channel, depending on the desired mode of operation of the bioreactor 10, as further explained below. In the exemplary embodiment shown in FIG. 1, the diverter plate features a vertical baffle 86 that facilitates segregation and channeling of the fluid-bubble mixture flowing upward in the primary reactor channel toward an upwardly angled, laterally or radially extending flow diverting extension 88 of the diverter plate that diverts a larger fraction of the total upflow volume of fluid and bubbles from the primary reactor channel into one or the other of the first zone upflow channel 40, or second zone upflow channel 82. Accordingly, a smaller fraction of the total upflow volume of fluid and bubbles is allowed to pass into the remaining superior upflow channel 40, thereby limiting as a primary process determinant the flow of aerated fluid into this remaining channel so as to contribute to generation of anoxic conditions in this channel, if desired.

Selection, positioning and adjustment of the flow diverter mechanism depends on the selected mode of operation of the bioreactor 10. In alternative embodiments, the diverter plate 84 can be positioned, shaped, dimensioned and/or adjusted to channel upflow of the fluid-bubble mixture from the primary reactor channel 80 into one or more superior channels to achieve higher aerobic environmental conditions in the selected channel(s), while limiting the upflow (particularly of high oxygen-containing fluid) into one or more superior channels selected for lower aerobic, even anoxic, environmental conditions. By way of example, the following steady state functionality of adjustable baffles 86 and 84 is described. In FIG. 1, 10 bubbles are depicted as rising uniformly at the top of zone 1 immediately below baffle 86. The baffle is adjusted so that 3 bubbles are segregated into area 39 and 7 are segregated into area 81. However the flow into area 81 is approximately equal to Q, influent/effluent flow+1.75 Q nitrated recycle flow=2.75 Q. In this exemplary design, the flow into area 39 is controlled to 5 Q. Therefore the flow per bubble in area 39 is 5/3=1.7 Q/bubble and in area 81 it is 2.75/7=0.4 Q/bubble. Similarly the oxygen demand and supply in the superior channels and head tanks can be calculated. Typically the average BOD in the area 39 and 81 is about 10 mg/L and the average ammonia-N concentration to be removed is 15 mg/L (after ammonia used in cell synthesis) and the denitrified recycle flow is 1.75 Q. Therefore the average ammonia concentration would be 15/1.75=8.57 mg/L. This level of ammonia-N is equal to 8.75 mg/L-Nx 4.6 # oxygen/# N=39 mg/L of BOD equivalent. The total load into zone 2 is therefore=2.75 Q (10+39)=134 Q oxygen units. Since there are 7 bubble oxygen units the load per bubble is 134/7=19 oxygen units required/bubble. Similarly the load into area 39 is 5 Q×10 mg/L BOD=50 Q oxygen units required. However in channel 40 above port 34 the load increases to 50 Qunits+Q×200 units (assuming the influent BOD is 200 mg/L) for a total load of 250 Q units of oxygen required. Since there are only 3 bubble oxygen units available, the oxygen required per bubble is 250/3=83 oxygen units. Therefore the oxygen demand per bubble oxygen unit is higher in head tank 16 than in head tank 15 by 83/19=4.3 times. Consequently, if there is measurable dissolved oxygen in head tank 16 there will be surplus DO in head tank 15, and if there is surplus DO in head tank 16 there will substantially more DO at any level below baffle 86 down to the mix zone 18. Thus baffle 86 can be adjusted to accommodate a wide range of load and flow criteria.

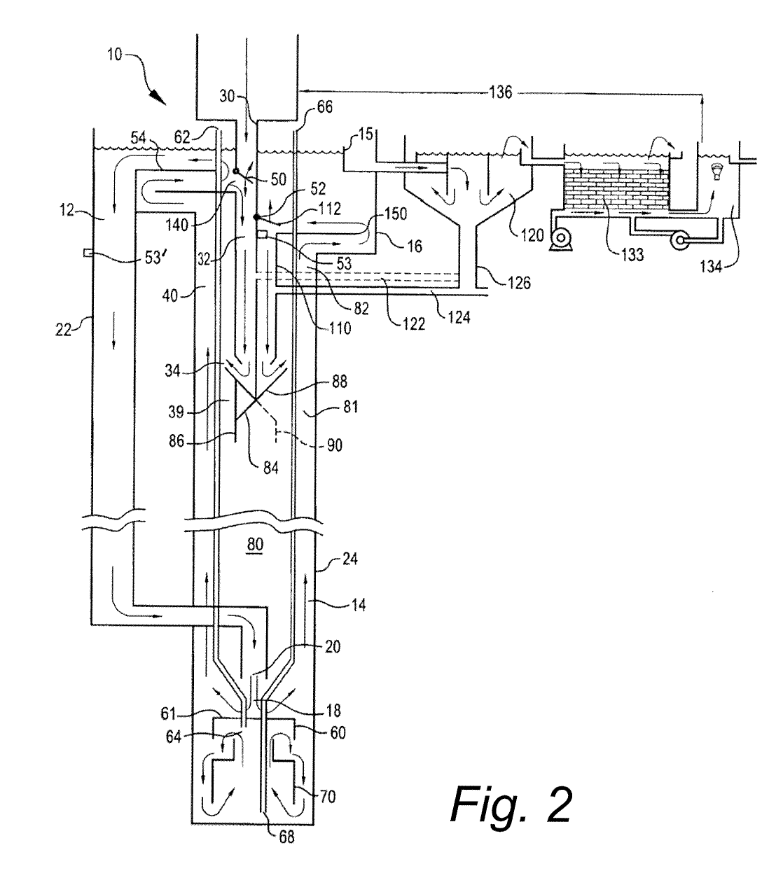

Thus, in one aspect of the invention, the improved long vertical shaft bioreactor 10 functions for multi-purpose waste treatment by providing aerobic digestion of BOD as well as single mixed liquor processing BNR treatment. Referring to FIG. 2, the flow diverter 84 is constructed and configured as shown (compare alternate diverter configuration/setting shown by phantom line 90) to divert a majority fraction of total upflow volume of the fluid-bubble mixture from the primary reactor channel into the zone 2 upflow channel 82, while limiting the upflow volume of fluid and bubbles from the primary reactor channel 80 into the zone 1 upflow channel 40. Volume ratio in influent channel 32 and flow down and into the zone 1 upflow channel (which intercepts only a small fraction of the bubbles from the primary reactor channel) can be finely controlled. Thus, a relatively small amount of air lift and a slow circulation rate can be provided the zone 1 upflow channel compared to the lift and circulation in the zone 2 upflow channel in this diverter configuration. The residence time of the fluid mixture in the zone 1 upflow channel is therefore increased, and the oxygen transfer capability in zone 1 upflow channel 40 is reduced due to the reduced bubble upflow. Notably, the bubbles in the zone 1 upflow channel are mostly nitrogen, because the oxygen is largely consumed in the lower and middle part of zone 1 (particularly including the mix zone 18 and the primary reactor channel 80 below the diverter).

Within this embodiment and adjustment/operation mode of the bioreactor 10, the superior channel referred to as the zone 1 upflow channel 40, can be selected to provide an anoxic environment, achieved in part by the low relative influx of oxygen and the high oxygen demand of the raw influent stream. This anoxic zone continues throughout the circulation path between the zone 1 upflow channel and the down corner channel 12, as approximately indicated by the arrows in FIG. 2. Within this anoxic zone, a final step of BNR processing, denitrification of nitrate initially contained in the mixture of fluid in the zone 1 upflow channel occurs. When this mixture, following the path indicated, reaches the mix zone 18, re-aeration of the anoxic flow exiting the lower down corner port 20 occurs, and residual BOD that was not removed in the anoxic zone is oxidized in the lower part of zone 1 (including the mix zone and primary reactor channel 80). Thereafter, a portion of the uprising flow in the primary reactor channel flows upward into the zone 1 upflow channel 40, because this top portion of zone 1 is designed to be anoxic, the number of bubbles required for bio-oxidation is reduced. The airlift effect is also greatly reduced to slow the upflow in this part of the reactor. In addition, the ability to control influent flow via the zone 1 recycle flow regulator 50 also allows adjustment of air lift and flow in the zone 1 upflow channel.

Within the foregoing operation mode of the bioreactor 10, a major portion of the uprising air flow in the primary reactor channel 80 flows upward into the other superior upflow channel(s), exemplified by the zone 2 upflow channel 82. The relative lower liquid upflow fraction thus segregated includes the majority of bubbles originating at the lower end of zone 1 (e.g., bubbles generated by the dedicated air line 62 and optional multi-purpose aeration/waste solid extraction line 66, functioning in concert with the bubble distribution header 60 and optional shearing enhancer mechanism exemplified by the shear header 70). This active, fluid-bubble mixture segregated into zone 2 by operation of the diverter 84 enters the zone 2 upflow channel, then mixes with vigorous re-circulating flow entering zone 2 through a zone 2 recirculation channel 110 (which recycles liquor from the zone 2 head tank 15). This recirculation flow is optionally regulated by a zone 2 recirculation flow regulator 112, for example a manual or motor-actuated baffle, valve or other flow-regulating apparatus. This recycle flow regulator is also optionally controlled by the system control unit 51 (e.g., system control microprocessor) operatively linked to a valve or baffle actuator 52 and optional flow sensor 53 for determining zone 2 recycle flow).

When the bioreactor 10 is thus configured and/or adjusted for BNR removal, nitrification of mixed liquor can be efficiently conducted and controlled within zone 2 of the bioreactor 10, in accordance with the above-described construction and operation details. Some of the mixed liquor from zone 2 may be discharged to a detached 120 or integrated 120′ solids-liquid separator (clarifier) (see, e.g., FIGS. 2-4, and 6). Some of the mixed liquor from zone 2 may be returned to the influent channel 32, where it undergoes de-nitrification, as described above, and the cycle repeats. Optionally, some clarified effluent may be returned to channel 32 during low flow periods, thereby removing more nitrogen compounds overall.

In more detailed embodiments of the invention, influent, return clarified effluent (e.g., recycled from a separate clarifier 120 or integrated clarifier 120′), and return activated sludge are combined in a preselected ratio to facilitate operation of the bioreactor 10. This can be achieve using various flow control features of the invention, and is facilitated in part by incorporation and controlled operation of a zone 1 activated sludge return channel 122 and a zone 2 activated sludge return channel 124 which receive activated sludge (e.g., via a sludge extractor line 126 connected to the clarifier) and direct the sludge into the zone 1 influent channel 32 or zone 2 recycle channel 110, respectively (see, e.g., FIGS. 2-4, and 8). Flow control within and between each of the illustrated feed, flow and drain lines and ports throughout the appended Figures is readily achieved using flow regulators 50 operatively interconnected with valve or baffle actuators 52 and/or flow sensors, all of which are operatively integrated and controlled by one or more system control unit(s) 52.

The selected mix ratio per volume of influent of typical municipal waste may be as high as 3 volumes of clarified effluent and 1 volume of return activated sludge to as low as 1 volume of clarified effluent and 1 volume of return activated sludge. Approximately 85% of total nitrogen will be converted to N₂ with 1.75 volumes of either clarified effluent or mixed liquor per volume of influent (see, e.g., Naohiro Taniguchi et al. report on air lift recirculation for nitrification and denitrification, R&D Division, Japan sewage works agency 1987, incorporated herein by reference.) It should be noted, however, that some industrial wastes may require 100 or more recycled volumes per volume of influent.

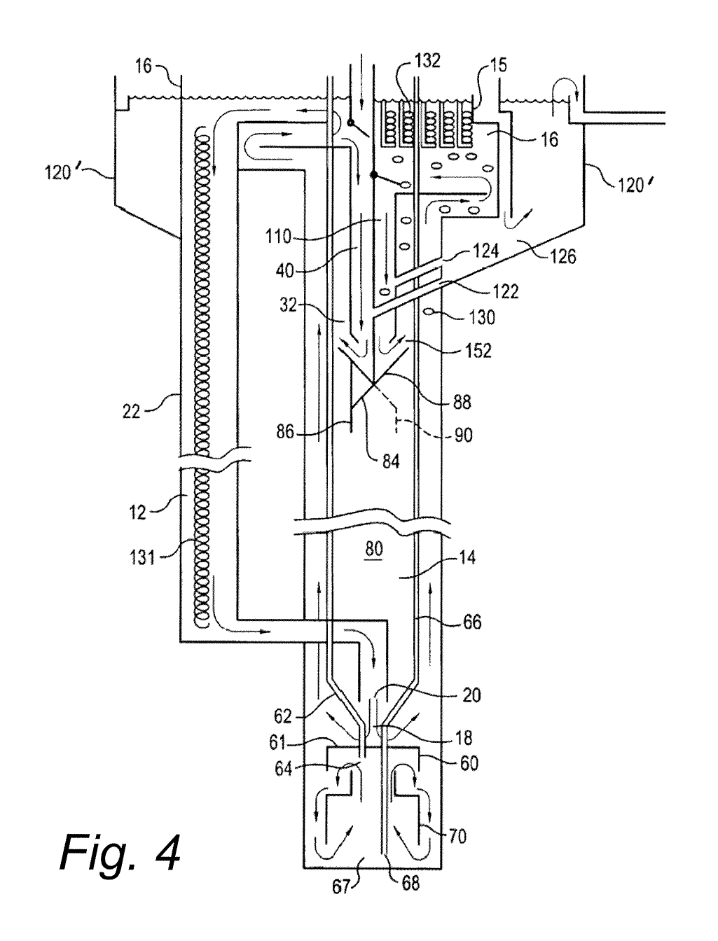

With respect to the nitrification process functions of the bioreactor 10, this can be further modified or enhanced by selection or adjustment of the various reactor features and operation parameters described above. In addition, the system can readily incorporate, or be coupled with, additional system features or components to enhance BNR process functions. Because the BOD is low in zone 2, growth of BOD-removing organisms is generally minimized, which allows nitrifying bacteria to dominate the biomass. In addition to this advantage, a substantial improvement in the rate of conversion of ammonium to nitrite and nitrate can also be realized by increasing the concentration of nitrifying bacteria. Since nitrifiers are attachment organisms, the provision of attachment sites in a mixed liquor in the form of sponge balls, suspended media, bits of small diameter plastic or rubber (elastomeric) polyethylene tubing, hanging strings of porous fabric in the liquor, etc., can be used quite effectively within the devices and methods of the invention (see, e.g., Keith Ganze “Moving Bed Aerobic Treatment” Industrial Waste Water November/December 1998, incorporated herein by reference.) For example, referring to FIG. 4, the BNR processes of the bioreactor 10 can be substantially improved by including suspended media 130 that encapsulate or provide substrate for nitrifying bacteria within the recycling circulation path of zone 2 (see, also, T Lessel et al “Erfahrungen mit getauchten Festbettreaktorn fur die Nitrifikation” 38. Jahrgang, Heft 12/1991, Seite 1652 bis 1665, incorporated herein by reference), which modification is facilitated by the novel relative positioning and interzonal separation between zone 1 and zone 2. The moving bed media can be prevented from escaping in the effluent, for example by simple screens. Alternatively, fixed media 132 can be secured within in the head tank to increase the biomass of microorganisms adapted for BNR processing. These modifications yield a superior BNR performance. For example, the combination of a zone 2 regime that minimizes BOD-removing bacteria along with the increased attached growth biomass of nitrifying bacteria (e.g. 15-20 g/L equivalent nitrifiers) provides for highly effective BNR processing within the bioreactor 10 of the invention. A single sludge extended aeration process typically contains 15-20% of nitrifying bacteria (by weight or population percentage of sludge mass). However, when attachment media are used within the present invention, the biomass of nitrifiers can be expanded up to greater than 30%, often up to 60-70%, as much as 75-85% or more of nitrifiers in the system population. This relates to the relative exhaustion of BOD in this process stage and zone of the system, as well as to the effective use of fixed or circulating attachment media within zone 2. These novel features and characteristics distinguish the modified single sludge system of the present invention from other single sludge processes.

Within additional aspects of the invention, a novel nitrification process is provided which relies substantially or entirely upon residual dissolved oxygen originating near the bottom of zone 1 as the source of oxygen to drive the process. Yet another important benefit and distinction that arises by using the unspent gases from zone 1 in this fashion is the high level of CO₂ available, which is also required by nitrifying bacteria as a source of inorganic carbon. In other nitrification systems, the primary inorganic carbon source depends on alkalinity of the wastewater and is typically determined by the presence of CaCO₃. The bioreactor process systems of the invention are therefore more compact and require less energy than current, extended aeration systems. Bioreactors constructed and operated according to the invention also produce a better quality biomass (including class A biosolids if desired) that is easier to separate from the mother liquor.

To further enhance the functions and operation of the bioreactor 10 of the invention, various coupled or integrated features can be incorporated with the bioreactor for enhanced processing of waste water. As illustrated in FIG. 2, the bioreactor according to the invention for use in waste water treatment may incorporate a conventional, stand-alone sedimentation clarifier 120. The bioreactor is further optionally fluidly connected with an aerated polishing biofilter 133 and/or an ultra violet light disinfection chamber 134 and/or back wash tank. In certain embodiments, line 136 returns backwash to the influent.

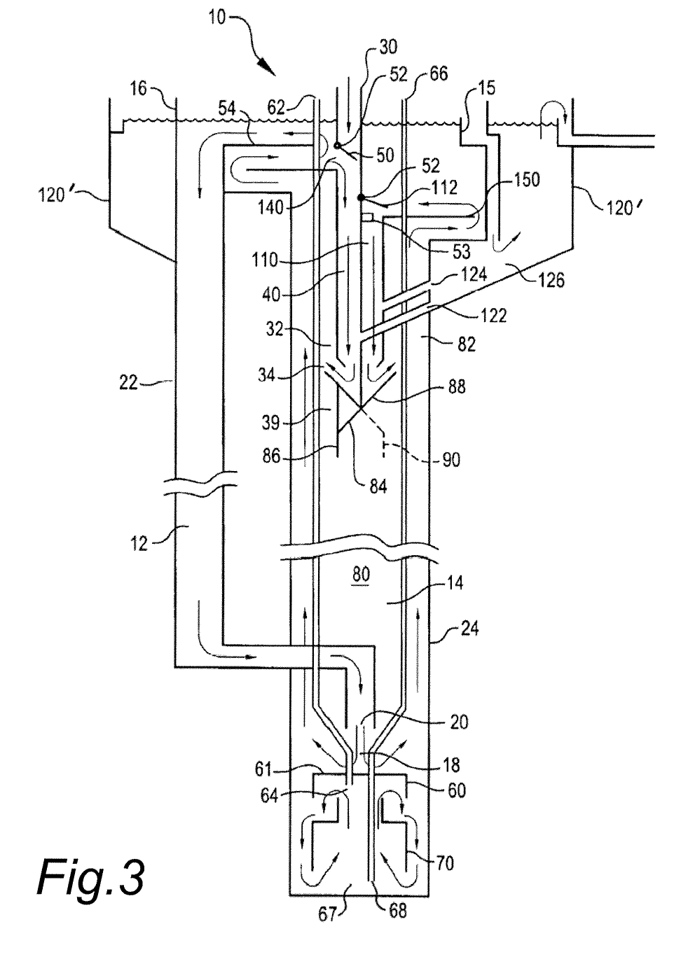

Alternatively, FIGS. 3 and 8 (schematically and by partial sectional perspective views, respectively) illustrate an additional embodiment of the bioreactor 10 according to the invention—featuring an integrated circular sedimentation clarifier 120′ surrounding a circular zone 2 head tank 15 which in turn surrounds a circular zone 1 head tank 16 (all three tanks being concentric in this vertical reactor). In these embodiments, settled activated sludge is returned by gravity to either zone 1 or zone 2.

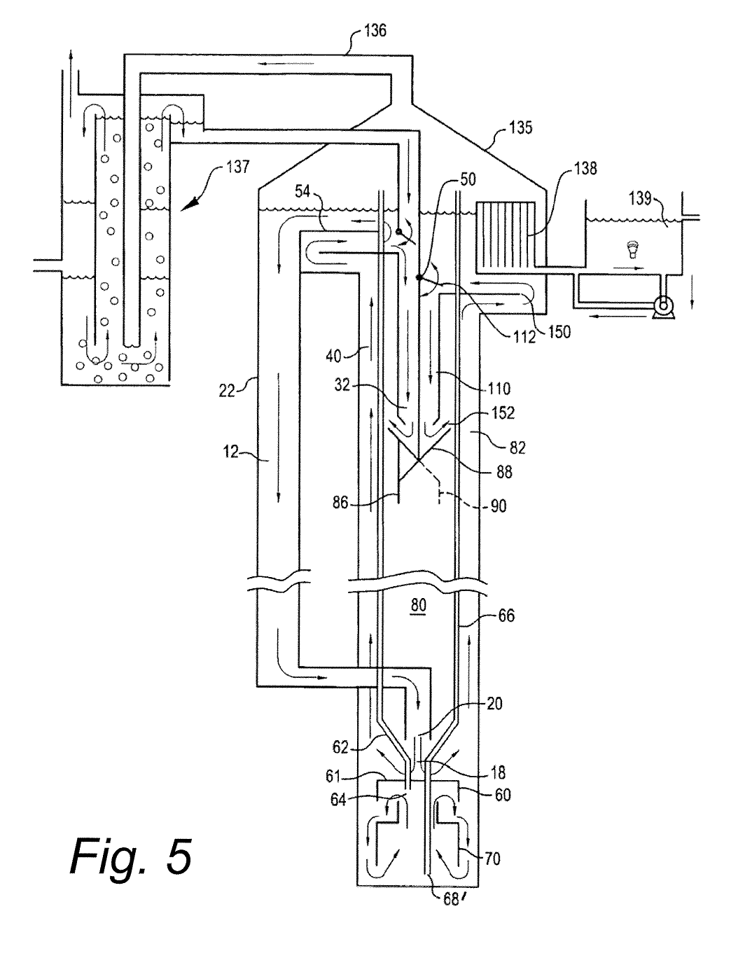

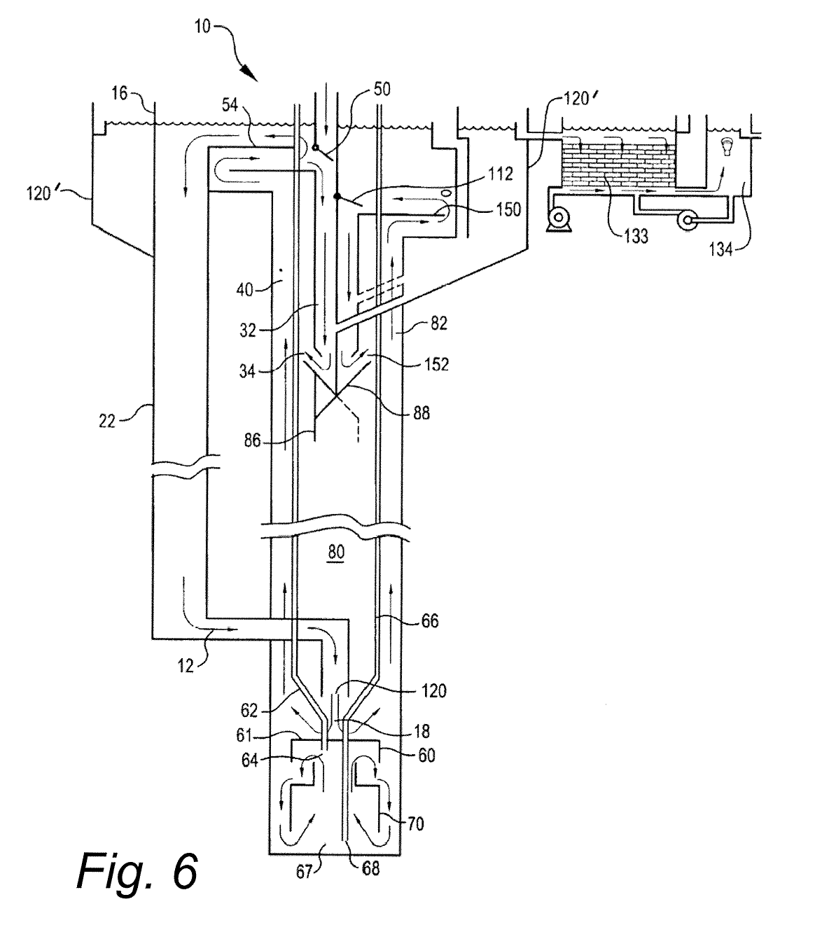

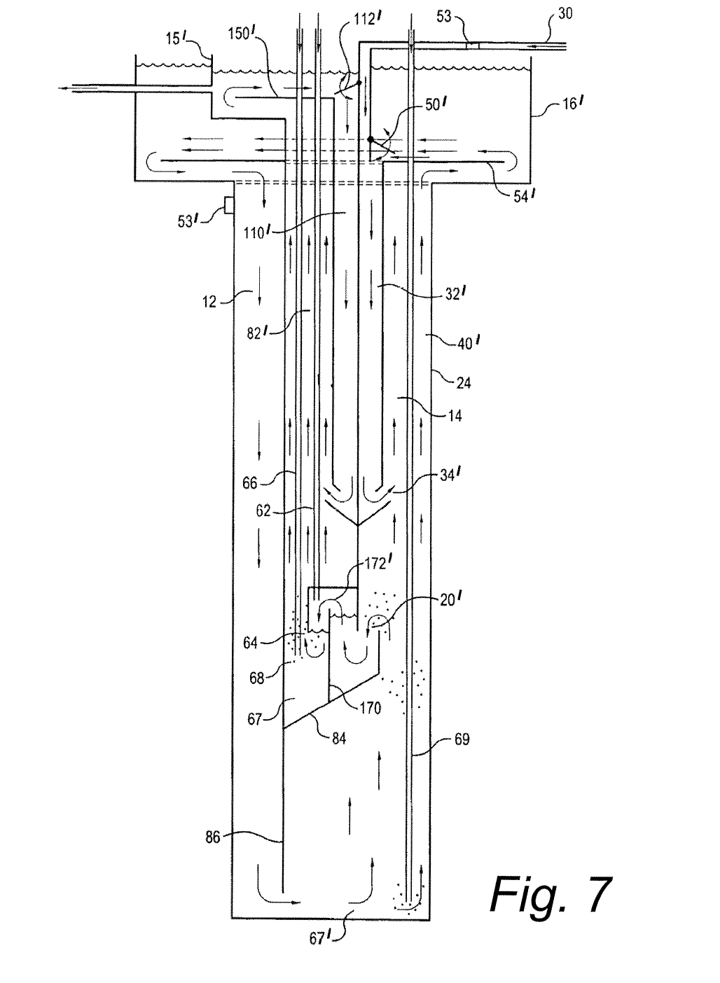

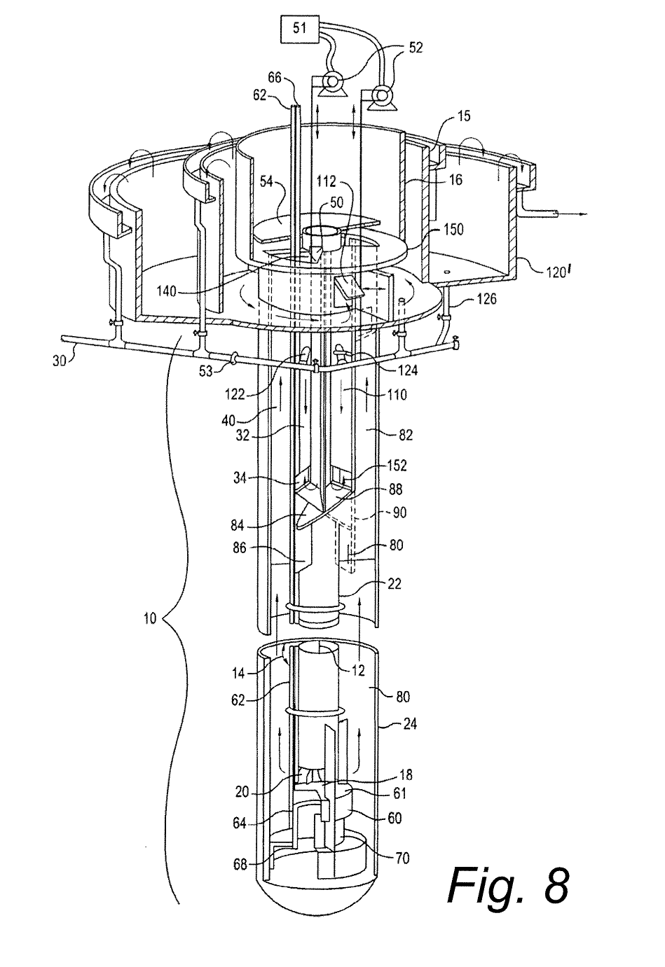

Alternate embodiments of the bioreactor 10 illustrated in FIG. 4 feature moving bed media 130 circulating in zone 2 and, additionally or alternatively, fixed media 132 suspended in the head tank 15 of zone 2. Another embodiment, as illustrated in FIG. 5, incorporates a pressurized head tank 135, and an optional off-gas collector 136 (see, e.g., U.S. Pat. No. 4,272,379 to Pollock, incorporated herein by reference), for example with off-gas driving an air lift influent pump 137 required to overcome the head tank pressure, as well as an optional membrane filtration cartridge 138 (see, e.g., George Heiner et al, “Membrane Bioreactors” Pollution Engineering December 1999, incorporated herein by reference) operating under pressure to separate biomass from liquid and a clean water, ultraviolet (UV) disinfecting chamber 139 also serving as back wash storage for membrane backwashing. Still other embodiments, as shown in FIG. 6, feature an integrated clarifier 120′ fluidly connected to an aerated polishing biofilter 133 and an ultra violet light disinfection chamber 134 and filter back wash tank.

Typically, for long vertical shaft bioreactors, the optimum biological air supply rate required for bio-oxidation process creates excessive “voidage” at the top of the reactor, comparable in the present case to the superior upflow channels exemplified by the zone 1 upflow channel 40 and zone 2 upflow channel 82. Excessive voidage produces undesirable slugging (water hammer), which can cause reactor damage attributed to vibration. The occurrence of slugging air voidage also signifies poor oxygen transfer characteristics within the circulating fluids. The invention addresses these problems in a number of ways, including by providing novel means for regulating circulation velocities and modulating gas content in selected parts or channels of the reactor.

Since oxygen transfer rate and oxygen utilization rates are relatively slower than upward hydraulic velocities in the reactor 10, increasing velocity only reduces the operating efficiency of the reactor. Increased flow decreases bubble contact time and slows oxygen transfer, thus more aeration is required to optimize the process. Similarly, reducing aeration reduces reactor capacity. One proposed method for resolving air voidage and related problems is presented in U.S. patent application Ser. No. 09/570,162, filed May 11, 2000 (incorporated herein by reference) describing the “VerTreat II” bioreactor. In this disclosure, flow velocity is beneficially reduced by incorporation of an orifice plate in the lower section of the riser channel. However, this solution does not substantially resolve the problem of slugging, and the orifice plate creates additional problems including risk of fouling and flow aberrations particularly in small municipal plants.

The bioreactor 10 of the present invention resolves these problems in part by incorporating a novel relative configuration of zone 1 and zone 2. Unlike the previously described “VerTreat I” bioreactor (see, e.g., U.S. Pat. No. 5,650,070, issued Jul. 22, 1997, incorporated herein by reference), where zone 2 is below zone 1 and therefore no voidage control in zone 2 is possible, the present invention can control flow and gas content in each zone, independently. Conventional prior art “Deep Shaft” reactors start slugging at an upflow velocity of about 2 feet per second. The above-noted VerTreat II reactors with orifice plates can operate down to about one and a quarter feet per second. Within the present bioreactor, this value can be dampened to as little as one quarter to one half feet per second in the lower part of the riser channel. At lower riser velocities, some heavier solid particles will settle into the sump 67. These solids are conveniently extracted, along with surplus biomass (e.g., circulating within the shear header 70 and surrounding mix zone 18) when desired, by purging of the dual-purpose aeration/solids extraction line 66.

The invention provides substantially more efficient new features and methods for slowing velocity over prior art methods, which includes the ability to dilute the air lift stream in one or more superior upflow channel(s) of the reactor with bubble free fluid, as described above. The advantage of these features and methods over the VerTreat II technology includes the elimination of potential plugging of the orifice plate in the lower and inaccessible section of the riser channel, which is particularly problematic in smaller diameter reactors.

In long vertical air lift reactors such as the bioreactor 10 of the invention, where fluid/gas mixtures are caused to circulate in vertical channels, the volume of gas in a defined volume of liquid changes with the pressure (gas laws). Consequently at the bottom of the reactor, the volume of gas in liquid (voidage) is small, whereas at the top of the reactor the same expanded gas volume to liquid volume ratio is many times larger. Since 34 feet of water is equivalent to about one atmosphere of pressure, it can be readily calculated that 1 cubic foot of air on the surface (1 scf) becomes 0.5 cubic feet at 34 feet depth and 0.33 cubic feet at 68 feet and 0.25 cu. feet at 102 feet. Therefore integrating the area under the volume vs. depth curve shows 78% of the gas volume voidage occurs in the top 102 feet of the reactor.

Many studies on air-lift pumps and other bubble/water columns show that slugging in water occurs at 11-14% voidage. Slugging is undesirable because the bubbles coalesce into large air pockets which set up vibrations in the reactor, and most importantly, large bubbles have very poor oxygen transfer characteristics. Proposed controls of voidage to ameliorate these effects have been attempted in at least two different ways. One proposed control is to increase the reactor cross section sufficiently to allow disengaging the gas from the gas/liquid mixture. Alternatively, efforts have been undertaken to maintain residual pressure on the gas/liquid mixture at the top of the reactor. Each of these proposed controls have attendant drawbacks making them undesirable for use within the bioreactor of the present invention. For example, head tank designs of some air-lift reactors are provided where liquid depths of ½ atmosphere (17 feet) are used. This reduces the maximum voidage by 17%, but head tank depths much deeper than 17 feet are difficult to construct. In addition, tall head tanks above ground require pumping influent against a significant hydraulic head, wasting substantial energy.

The invention provides novel structural features and methods for controlling voidage and ameliorating adverse effects of slugging. Briefly, these features and methods reduce the quantity of bubbles per unit of fluid in one or more selected channels or chambers of the reactor 10, either by adding more fluid or reducing the gas. In more detailed aspects, liquid flow in one or more superior upflow channels of the reactor is increased by recycling liquor from an upper segment (e.g., 60-90′) of the reactor, through a degas step, and back down to a lower, recycling influx point near the bottom of the upper segment (e.g., 60-90 feet below the surface). It is generally considered that total gas flow (air flow) is determined by biological optimization requirements, however this total gas flow can also be proportioned into selected, superior upflow channels in the upper part of the reactor using novel flow control mechanisms described herein.

Because approximately 75-80% of the voidage occurs in the top 60-90 feet of the reactor, the recycle channels (exemplified by the influent channel 32 which optionally nested receives zone 1 recycle input from zone 1 recycle port 140, and the zone 2 recycle channel 110), are only about 25-35% of the total depth of a typical bioreactor and occupy only a small fraction of the reactor cross section area and volume. In practice, zone 1 and zone 2 of the reactor comprise approximately equal fluid volume, but in the case of BNR removal zone 2 is expanded in volume for nitrification by increasing the diameter of the zone 2 head tank 15. The voidage in the zone 2 recycle channel can be readily controlled under a wide range of operating conditions by designing for sufficient, adjustable recycle flow of degassed liquor from the zone 2 head tank 15 as regulated by the zone 2 recycle regulator 112. The bubble volume in the zone 1 upflow channel 40 can therefore be diluted by degassed liquor to the extent limited by the acceptable range of minimum and maximum values for influent flow, which is somewhat limited. To resolve this limitation, a regulated amount of liquor may be diverted through the zone 1 recycle port by adjustment of the zone 1 recycle flow regulator 50 (effectuated by operation of the system control unit 51). Controlling flow from the head tank in this coordinated manner is necessary to maintain gravity feed of the effluent.

The instant invention therefore provides a number of separate and optionally cooperative mechanisms and methods to alleviate the problems of slugging at low bioreactor 10 flow velocities. In another aspect, this problem is alleviated by providing a choice of adjustable diverter or baffle devices, exemplified by the fixed or adjustable diverter mechanism 84. The configuration (including size, shape, location and orientation) of this exemplary diverter plate can be fixed at the time of construction and installation of the reactor. Alternatively, these and other flow diverter parameters can be selectably altered, for example by employing a manual or motorized diverter plate adjustment mechanism optionally integrated for functional control (e.g., to control positional and orientation parameters) by the system controller 51. Operation of the flow diverter serves to direct a greater or lesser fraction of air bubbles entrained in the upflow from the primary reactor channel 80 into one or more selected superior channels, for example to divert a greater fraction of the fluid-bubble mixture toward the zone 2 upflow channel 82, allowing a lesser to pass upward into the zone 1 upflow channel 40.

Once the desired fraction of bubbles have been thus diverted into the zone 2 upflow channel 82, the voidage in this channel can be easily corrected by changing the amount of zone 2 recycle flow through adjustment of the zone 2 recycle flow regulator 112. The circulatory loop (following arrows between zone 2 upflow channel 82, across zone 2 degas plate 150, through zone 2 recycle regulator 112, down zone 2 recycle channel 110, and through zone 2 shielded recirculation port 152), together with a surface basin or zone 2 head tank 15 at the top, comprise zone 2 and represent the polishing process and optional nitrification features of the bioreactor which are driven by waste gas from zone 1. The configuration of the diverter which segregates flow into the superior upflow channels prevents liquor transfer from zone 2 into zone 1, since both liquid and air flow in the zone 2 upflow channel 82 is unidirectionally upward. In this regard, as noted above, zone 2 circulation characteristics are ideal for the application of fixed media 132 (FIG. 4) and, alternatively or cooperatively, membrane separation components (FIG. 5). Moving bed media 130 (FIG. 4) can also be used, since zone 2 circulates completely separately from zone 1, to enhance nitrification within alternative process modes of the reactor.

Hydraulically, any influent flow into zone 1 of the bioreactor 10 (and any required external recycle streams from the clarifier 120 or zone 2 head tank 15) that enter zone 1 must leave zone 1 by entering the bottom of zone 2. Since zone 1 is a closed loop, namely zone 1 upflow channel 40, zone 1 head tank 16, down corner 12 and primary reactor channel 80, the number of recycles in this loop and the liquid velocity depends directly on the volume of air bubbles diverted by diverter plate 84 into zone 1 upflow channel 40. For example, in a typical municipal effluent of 200 mg/L of BOD, the number of internal recycles is approximately the BOD in mg/L divided by the O₂ potential in the reactor, divided by the oxygen transfer efficiency. In a 250 feet deep reactor, oxygen is injected at about 7.3 atmospheres of pressure. Solubility of O₂ in water at 1 atmosphere and 20° C. is about 8 mg/L. This means the dissolved oxygen potential at 7.3 atmospheres is 7.3×8=59 mg/L or about 40 mg/L at an oxygen transfer efficiency of 70%. Therefore, the minimum number of recycles is 200 divided by 59×0.70=about 5. In practice 6 or 7 recycles might be used as a safety factor. A hydraulic loss calculation will determine the fraction of air required for 6 or 7 internal recycles; e.g., 30% of the air that is applied at the bottom of zone 1. As the organic load to the plant increases or decreases, the air rate is adjusted accordingly, causing the number of internal recycles to increase or decrease to satisfy the BOD requirement. However, 30% of the air applied remains consistent, constant as determined by diverter plate 84 placement. Field trimming is achieved, for example, by adjusting regulator valve 50, which changes recycle flow within the air lift section at zone 1 upflow channel 40, thus reducing or increasing its air lift capability.

Similarly, any flow from zone 1 that enters zone 2 must leave as effluent from zone 2. Since the lower portion of zone 2 comprising upflow channel 82 and adjacent downflow channel 110 typically has no internal recycle connection with zone 1, any air diverted from zone 1 into zone 2 will simply cause circulation in the superior channel(s) of zone 2 with no change in the circulation rate of zone 1 (change in air rate in zone 1 does, however, affect the circulation rate in zone 2, but not vice versa).

Therefore, within certain aspects of the invention, diverting for example 70% of the air originating at the bottom of zone 1 into zone 2 only affects the circulation in zone 2 which can be easily controlled by the zone 2 recycle regulator 112. Hydraulically, influent flow into zone 1 upflow into zone 2 and effluent from zone 2 within the reactor 10 are equal in quantity, i.e., influent flow entering the reactor in zone 1 exits through zone 2. With reference to prior art vertical bioreactors treating municipal waste, the internal recycle flow is about ten to twelve times the influent flow, or effluent flow. The present process, which features novel air lift controls as described above, can reduce this flow by about a 2-3 fold reduction, often a 5-6 fold or even greater reduction.

By adjusting the configuration of the diverter (generally referring to any diverter device for segregating flow from the primary reactor channel 80 into a plurality of superior upflow channels), the selected bubble fraction only (not typically the same as the liquid flow fraction) in the primary reactor channel can be segregated among any desired number of channels (typically 2, 4 or 6, depending on reactor size and purpose) in any ratio selected to achieve optimum operation of zone 1 and zone 2 (note that each superior channel shown in FIG. 8 has a companion channel opposite it, which is a typical layout for larger reactors using two or more clarifiers. Smaller reactors have only 4 channels and a center down corner, as illustrated in FIG. 7). For example, typical flow values in the zone 1 upflow channel 40 may be selected to be 6-8 times (alternatively, 2-3 times with BNR) the flow entering zone 2 at the top of zone 1 at the level of the diverter plate 84 (immediately below the zone 2 upflow channel 82), but only require 20-30% the amount of air to produce a non slugging air lift effect. Alternatively, when not using BNR, the flow into the zone 2 upflow channel may be selected to be about one sixth the flow in the zone 1 upflow channel, but conversely receive about 75-85% of the air. Air flow settings into the zone 2 upflow channel can thus be set over a broad range of flow settings, for example 10-15%, 20-30%, 30-50%, 50-75%, 75-90% or greater.

After diluting the zone 2 upflow, for example using 8 to 10 times the recycle flow from the zone 2 head tank 15 via the zone 2 recycle regulator 112, the air lift effect in the zone 2 upflow channel can be readily controlled. This control depends on the novel mechanisms and methods set forth above for segregating flow in an aerated and flowing vertical column, providing for selectable channeling of flow in different proportions into two or more other superior vertical columns, while the air bubbles may be split in a completely different ratio among these vertical columns. This novel ability to control air lift allows a better biological match between oxygen supply (dependent on the time available at pressure to dissolve oxygen, which is in turn a function of flow velocity) and oxygen utilization which is a function of respiration rate, (dependent on dissolved oxygen—not primarily upon the amount of bubbles present).

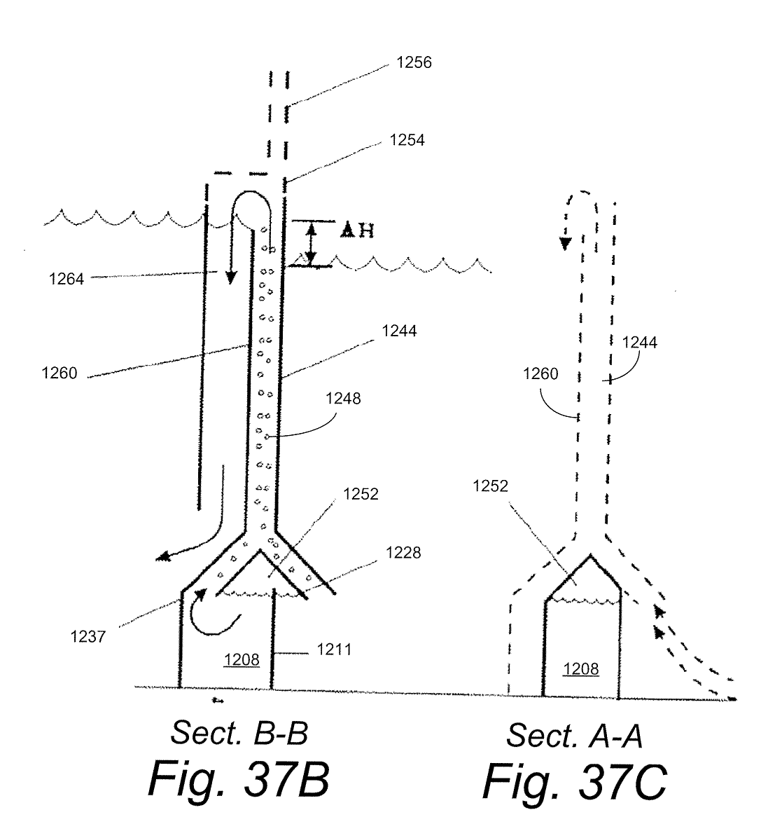

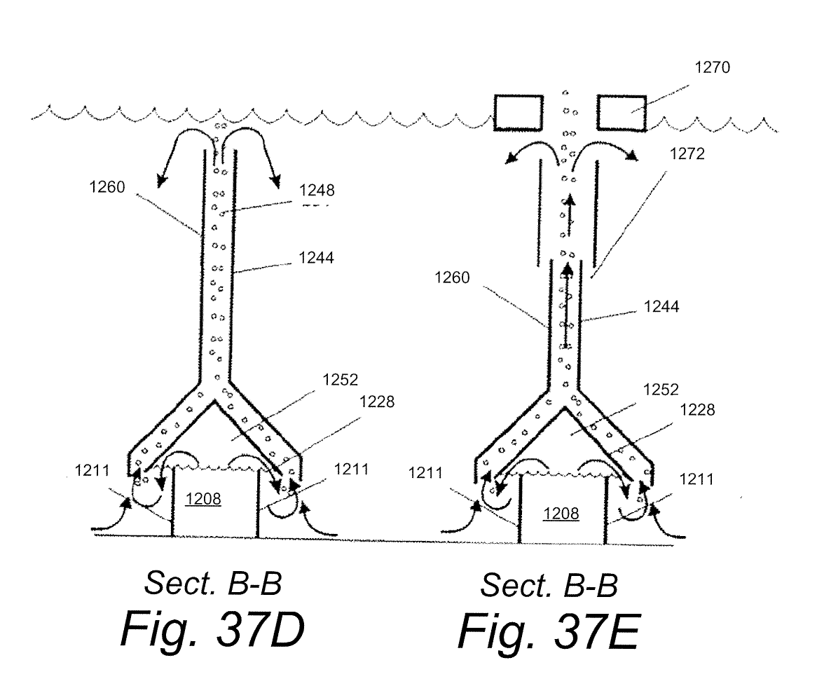

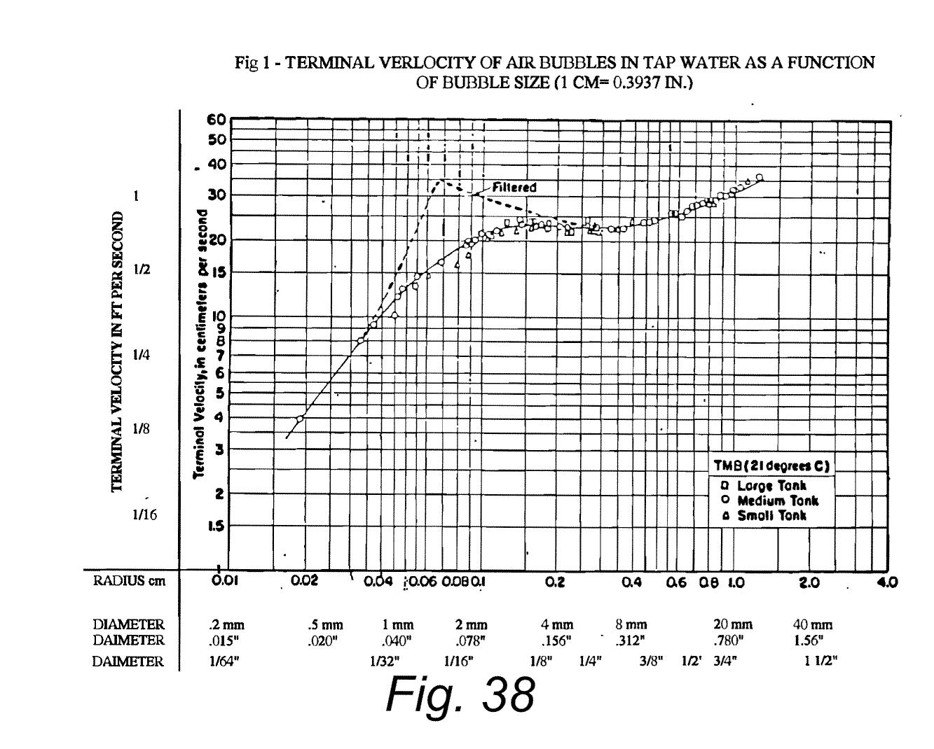

Within yet another aspect of the invention, novel features and methods are provided for addressing the challenges involved in the disposal of by-product sludge and/or surplus bio-solids from the bioreactor 10 treatment processes. Recognizing the nutrient value of these biosolids, the EPA in the US adopted 40 CFR 503 in 1993, which proscribes various process criteria to achieve class A bio-solids for unrestricted use as a soil supplement. Whenever possible, beneficial reuse of bio-solids is encouraged. One set of criteria for Class A bio-solids requires a minimum volatile solids reduction, as well as a Time-Temperature relationship, for example a 38% volatile Solids reduction and a 60° C. temperature for 5 hours qualifies as a Class A product. FIG. 12.

Within a modified embodiment of the invention, referring to FIG. 7, the bioreactor 10 is designed to function alternatively as a waste sludge digester and to meet the minimum volatile solids reduction and Time-Temperature relationship criteria for Class A biosolids production. In this regard, the reactor is specially designed and operated with a unique flow and zonal separation regime that provides for production of Class A biosolids in as little as 5-6 days, often in 3-4 days or less, using thermophilic bacteria operating at 58-65° C. but typically 58°-62° C. and often 60° C. The 38% volatile solids reduction is a measure of stability of the biomass or vector attraction reduction (VAR), while the elevated temperatures pasteurize the product to control E-coli and virtually eliminate salmonellae. Consuming 38% of the volatile matter minimizes odor potential and provides enough food energy for Thermophilic bacteria to raise the temperature of the reactor to over 60° C., without applying exogenous heat.

Published data demonstrate two areas of concern for existing vertical shaft bioreactors that seek to produce class A biosolids (see, e.g., Report on VerTad operations King County Wash., project 30900 May 20001, incorporated herein by reference.) First, small vertical bioreactors (e.g., “VerTad reactors”, as described for example in U.S. patent application Ser. No. 09/570,162, filed May 11, 2000 (incorporated herein by reference), feature a relative disposition of zone 2 (polishing zone) below zone 1. These reactors have a comparatively large surface area to volume ratio, and excessive heat is lost to the surrounding geology. Small reactors therefore require supplemental heat to support class A biosolids production, which is available at additional cost by recapturing the waste heat from the compressor or from the hot effluent stream.

A second area of concern for previous vertical bioreactors directed to high quality biosolids production is that there is insufficient liquid to liquid separation between zones 1 and 2. Published data of tracer studies in VerTad reactors show that the zone 2 (polishing zone) behaves as a plug flow reactor, with a critical feature of localized back-mixing. Over a period of about 8 hours, zone 2 begins to mix with zone 1 and the whole system (zone 1 and zone 2) is mixed in 16-20 hrs. Accordingly, some solid particles, potentially containing salmonellae or other prohibited contaminants, can settle from zone 1 into zone 2 without being exposed to the required retention time at pasteurizing temperature to meet class A biosolids requirements.

The improved bioreactor/digester 10′ of the present invention is configured in a distinct manner with zone 1 surrounding zone 2 (FIG. 7), such that for any given volume of reactor the surface to volume ratio is smaller than in previously described reactors directed to quality biosolids production, whereby the heat lost to the surrounding geology is much less. The improved bioreactor/digester provides enhanced liquid to liquid separation at a transfer point between zone 1 and zone 2. The transfer point is delineated by an air lock mechanism 172 (e.g., a diaphragm-less air operated valve) typically including an air lock baffle 170 as depicted in FIG. 7. The baffle extends upward into an air pocket formed by the introduction of clean, pressurized air from a dedicated air line 62 with air delivery port 64 or aeration/solids extraction line with corresponding port 68 located near sump 67. Zone 1 is aerated through port 69.

Within this aspect of the invention, it is considered critical that when the apparatus is being used as an aerobic thermophilic sludge digester, bubbles from zone 1 must not enter zone 2 because of the risk of re-inoculating the pasteurized product in zone 2. To prevent this from occurring, pressure in the air lock is maintained by fresh clean compressed air, and there is no liquid flow or contact between zone 1 and zone 2 or transmission of contaminated air from zone 1 to zone 2. The air lock is designed to prevent inter-zonal mixing of liquid between batches, ensuring that zone 1 does not re-inoculate the pasteurized biomass in zone 2 with pathogenic bacteria during batch processing. As an example, one batch of sludge may be processed every 5-8 hours, thus ensuring that the critical time temperature of 60° C. for five hours is always met within each batch.

In operation of this embodiment of the invention, waste biomass is fed continuously or intermittently into the reactor/digester 10′, e.g., into the zone 1 head tank 16′. As the head tank level in zone 1 rises above that of the zone 2 head tank 15′ level, a pressure differential develops across the center baffle 170 in the air lock. Eventually the zone 1 liquid level in the air lock exceeds the baffle height and fluid transfers from zone 1 to zone 2. Line 64 air supply is placed slightly below the liquid level of zone 2 within the airlock, whereby at the first onset of flow between zone 1 and zone 2, the bubbles are swept away into zone 2 and the air lock collapses. Flow stops when the head tank levels are again equal and the airlock re-establishes itself. A batch can also be initiated by draining the zone 2 head tank 15′. FIG. 7 shows zone 2 head tank being drained and the air lock approaching batch transfer. The size of the batch is the change in head tank level multiplied by the surface area of the tank. Therefore the baffle 170 need only penetrate into the air lock 172 by a foot or two because 1-2 feet of liquid level change in the head tank would typically represent a full batch. The additional hydraulic considerations in this aspect of the invention are similar to those set forth for the preceding embodiments.

When the bioreactor 10′ functions as a waste sludge digester (see, e.g., FIG. 7), thickened waste sludge, generally 4-5% solids by weight, is fed into the reactor, for example through influent conduit 30. The feed can be continuous, or batch wise, depending on the operation of the waste water treatment system generating the sludge. The raw sludge typically descends into the reactor through influent channel 32, and is met with a zone 1 upflow stream 40′ containing an elevated percentage of air bubbles (e.g., 10-15%). The combined streams are less dense than the influent stream 32′ or flow in the down corner channel 12′ and as a result, downward circulation is induced in the down corner channel and in the influent channel. In this way influent is drawn into the reactor and circulation and aeration occur in zone 1. In FIG. 7, it is important to realize that the head tank circulation from zone 1 upflow channel 40′ to channel down corner channel 12 is behind the zone 2 head tank 15′ as indicated by the broken arrows.

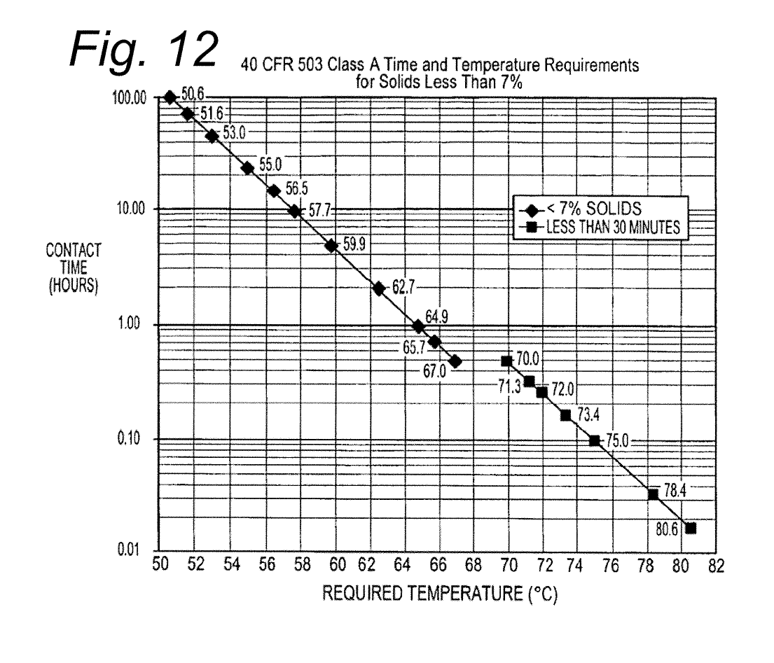

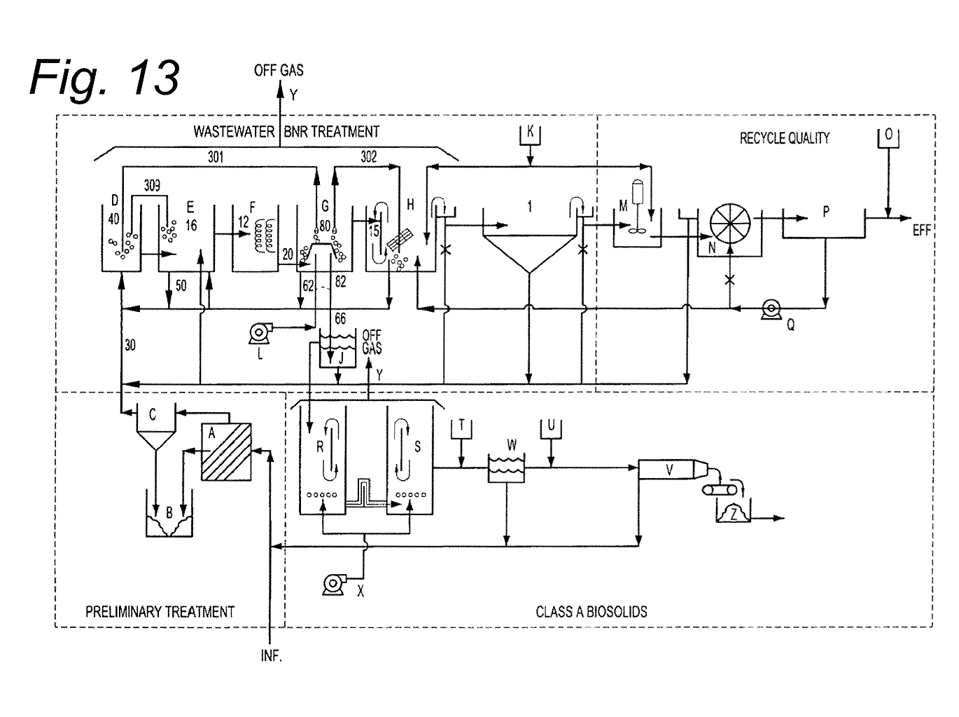

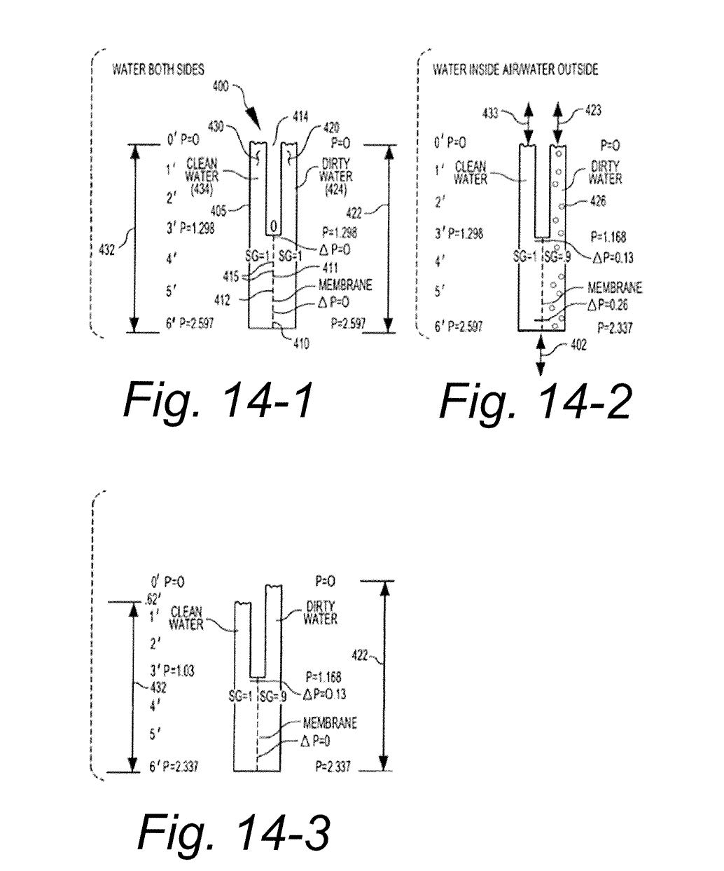

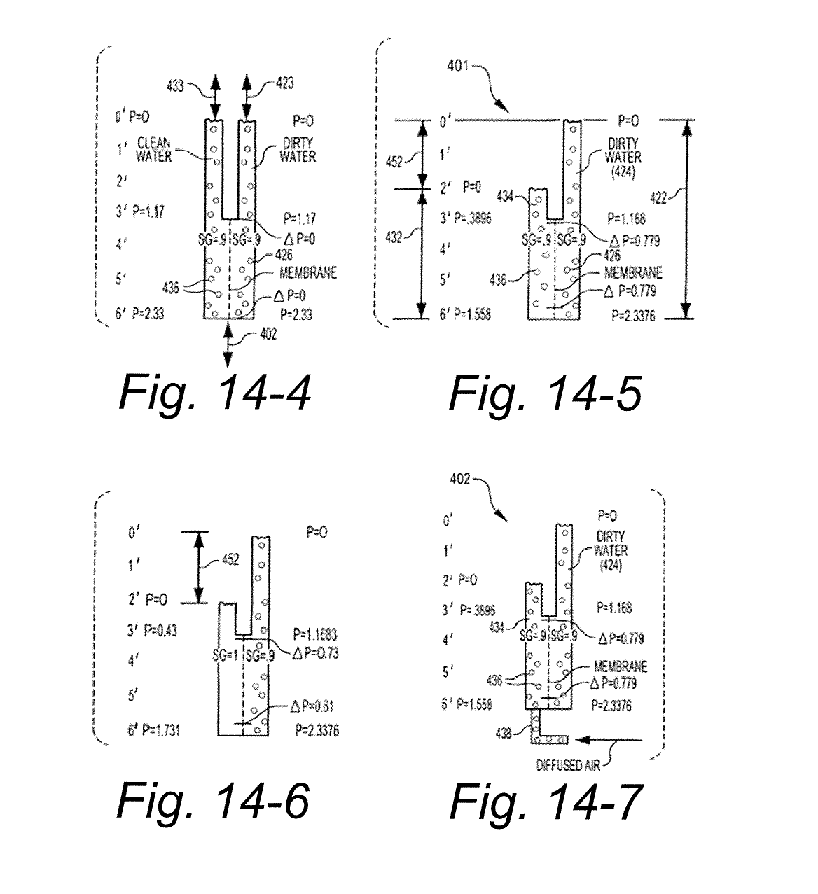

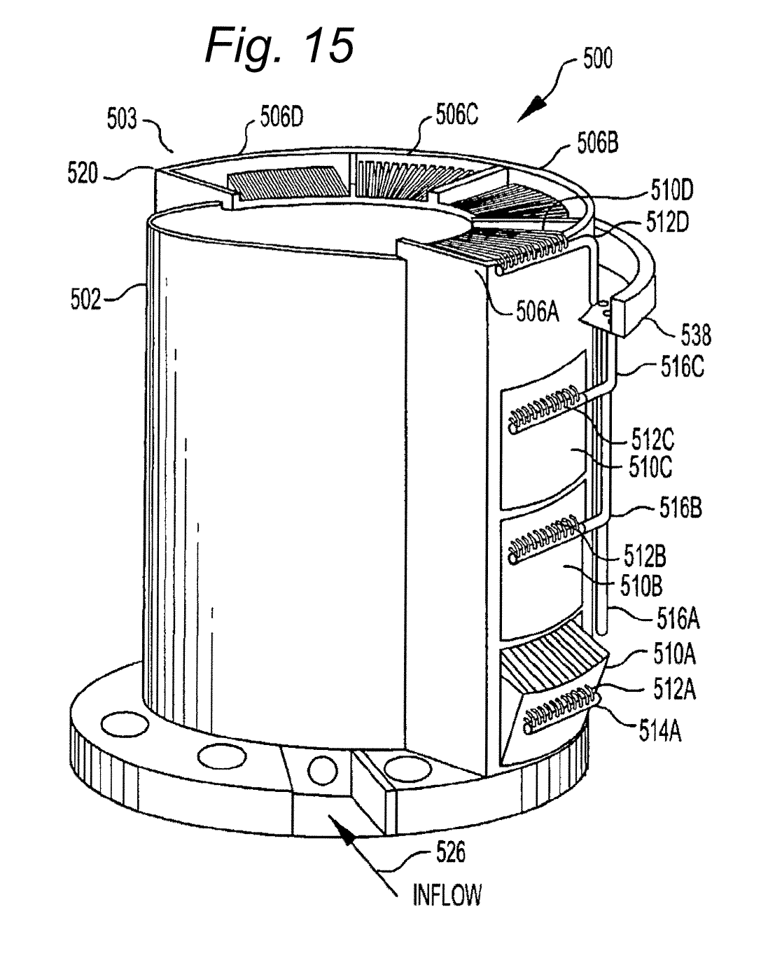

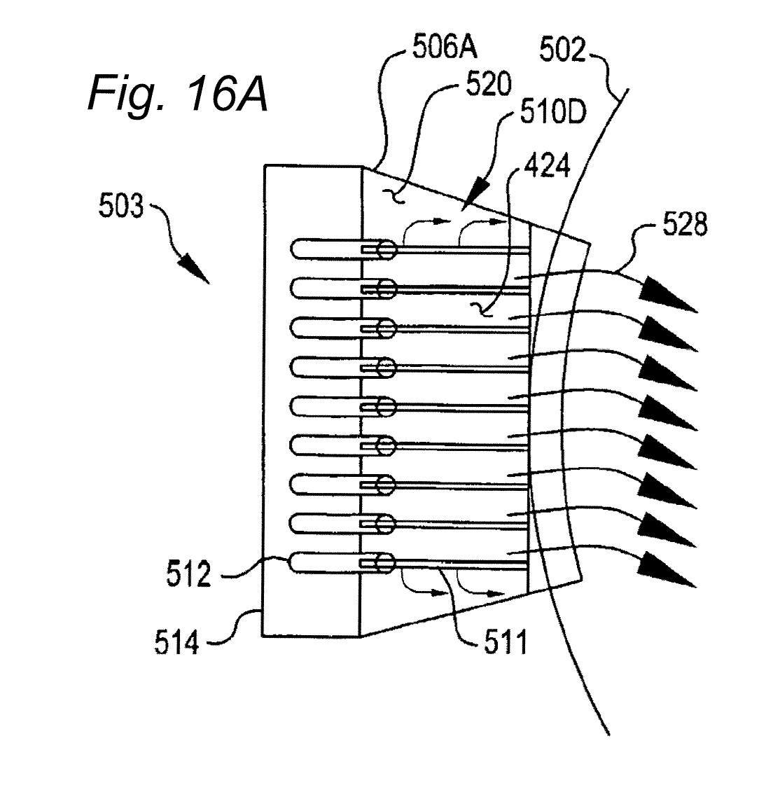

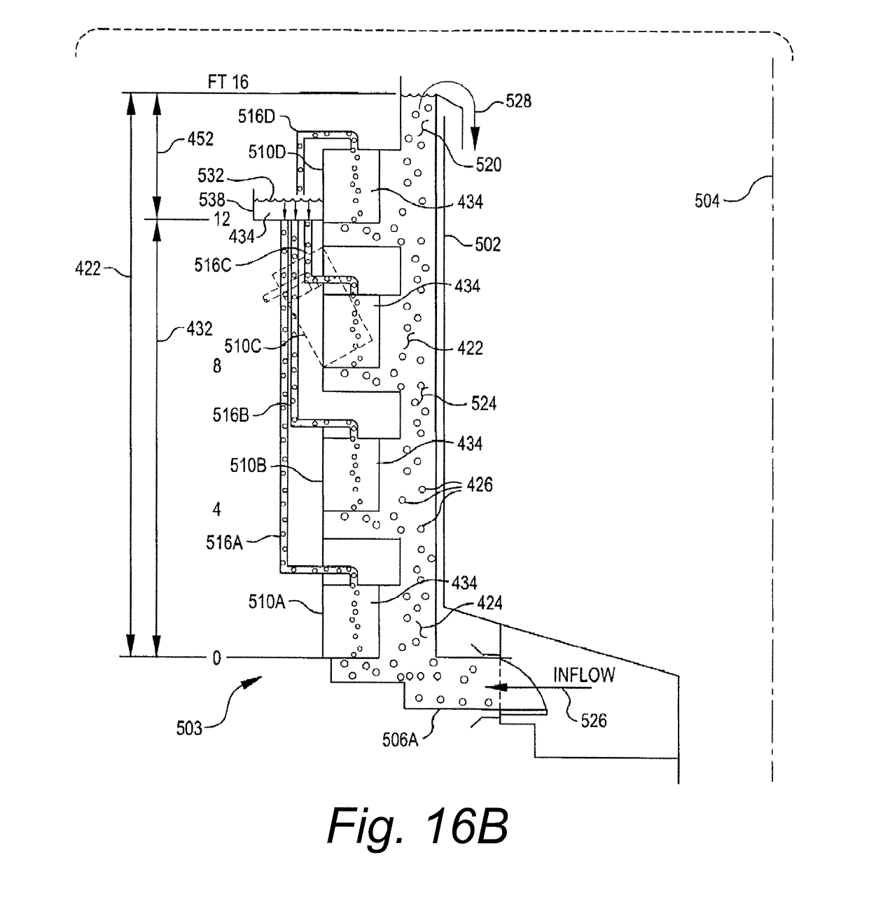

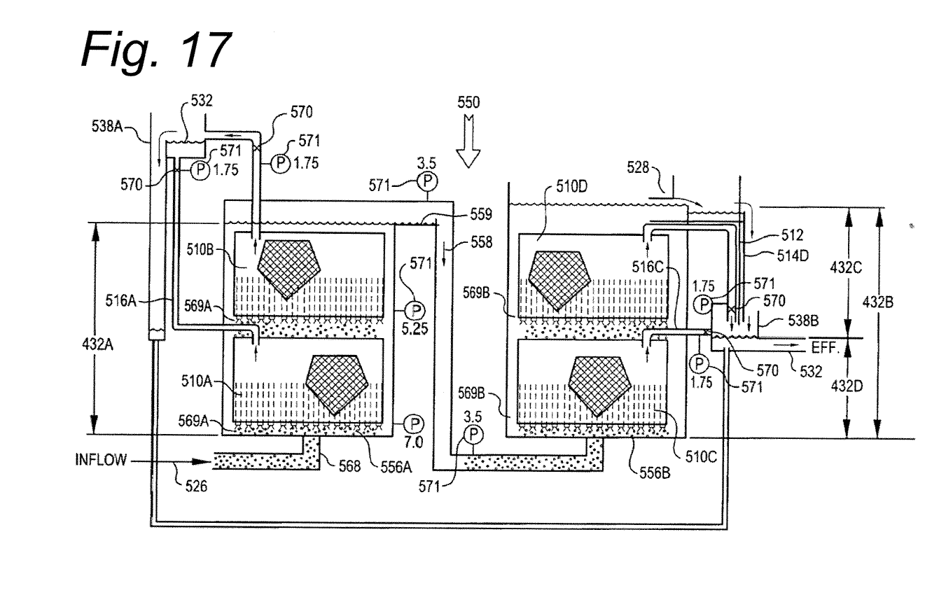

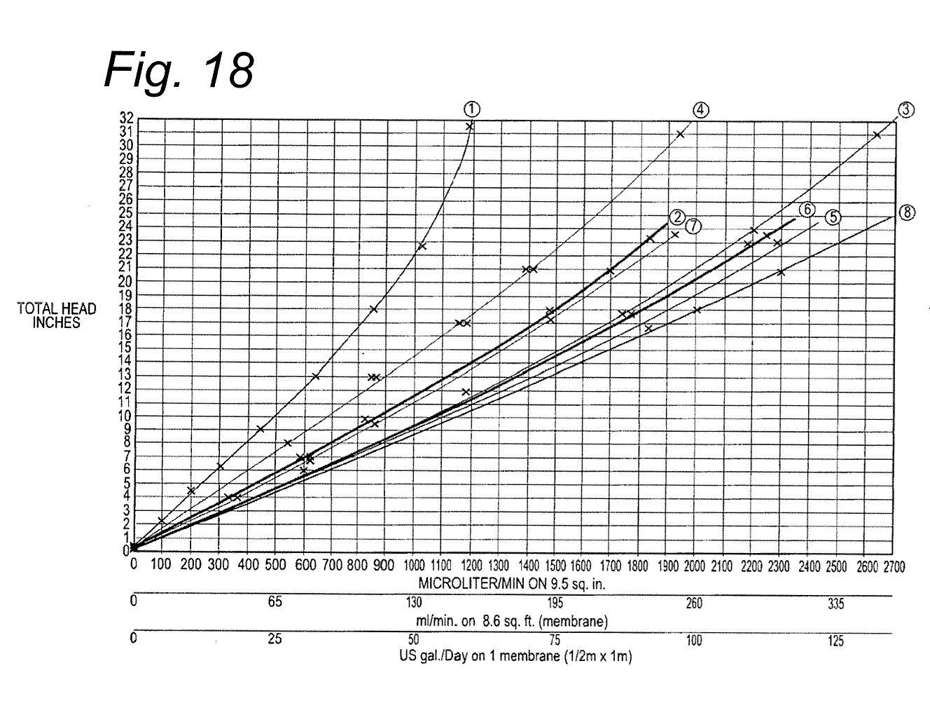

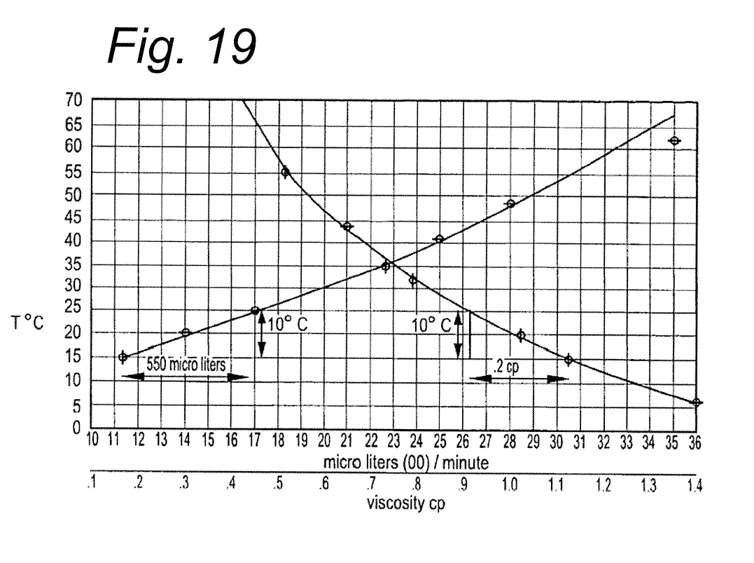

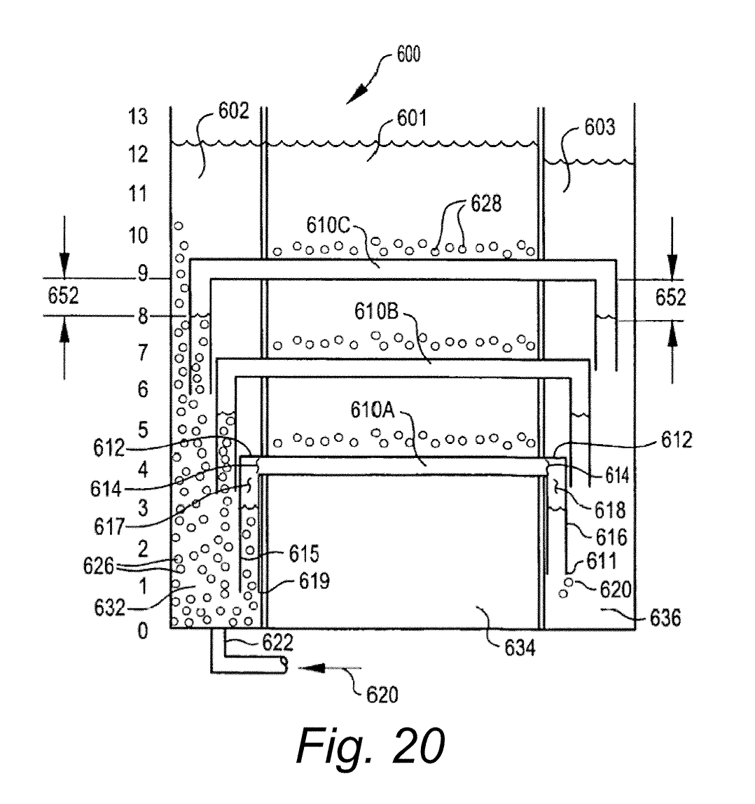

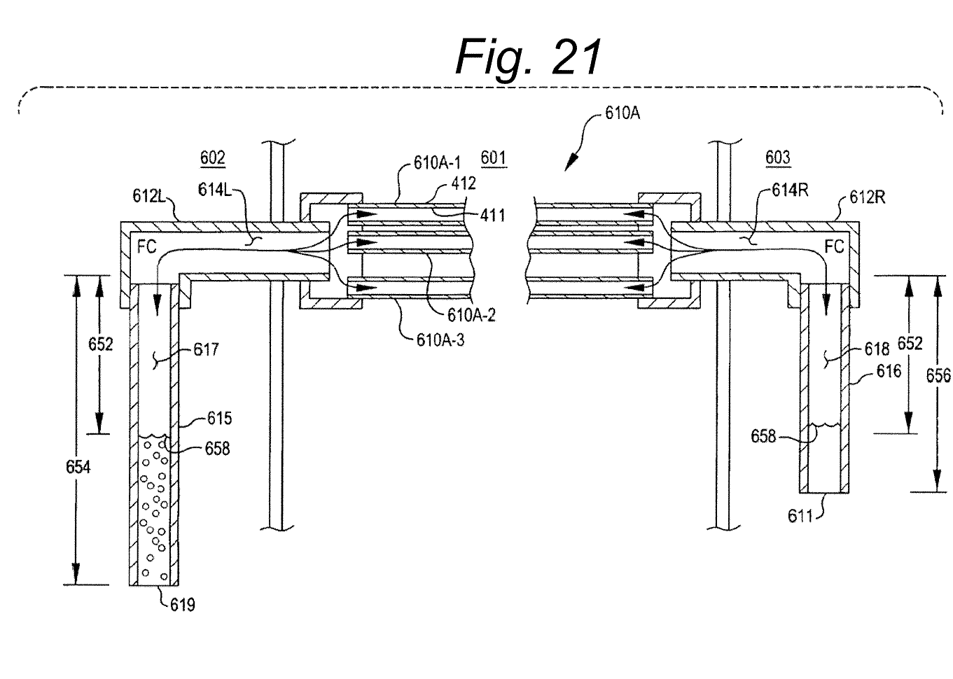

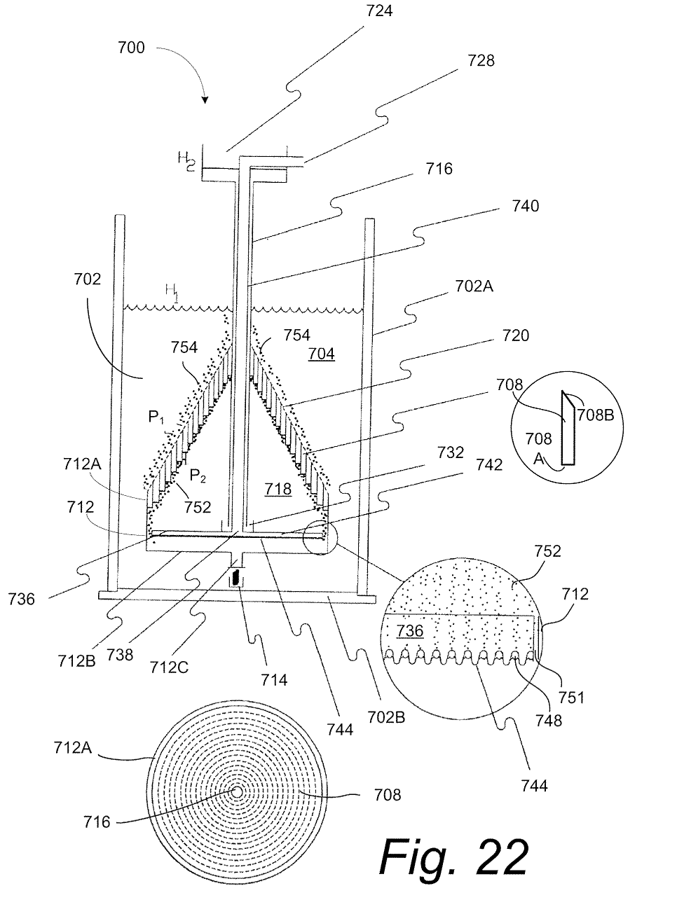

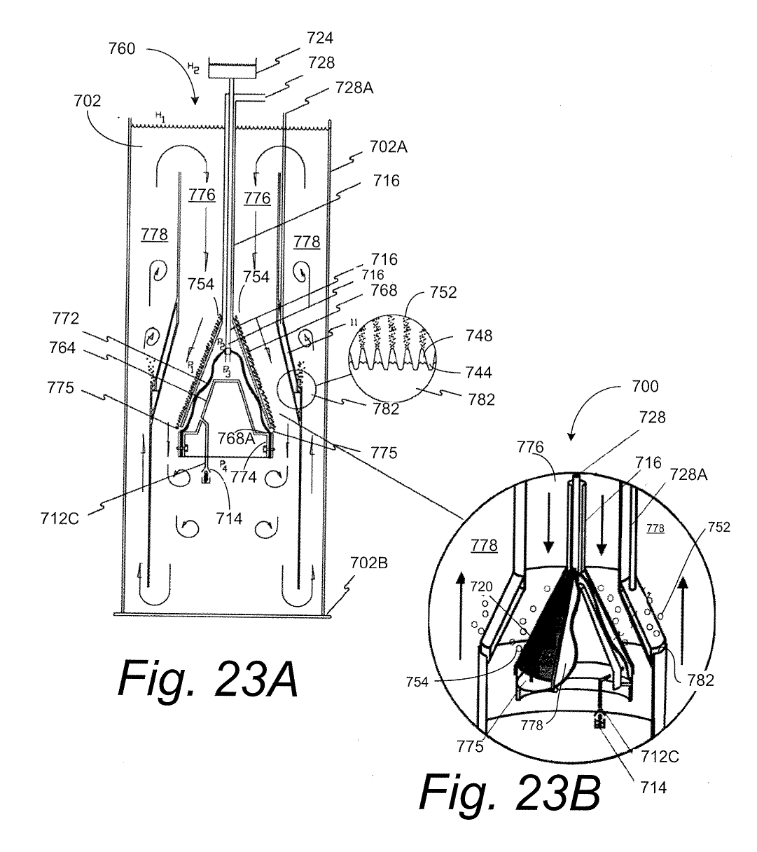

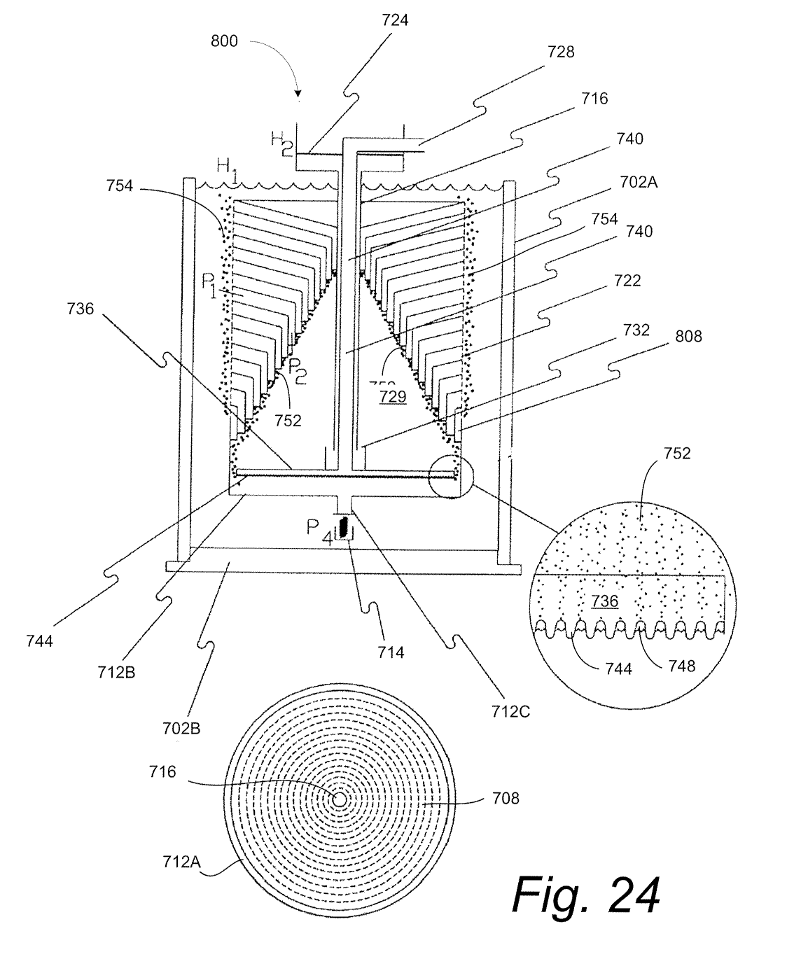

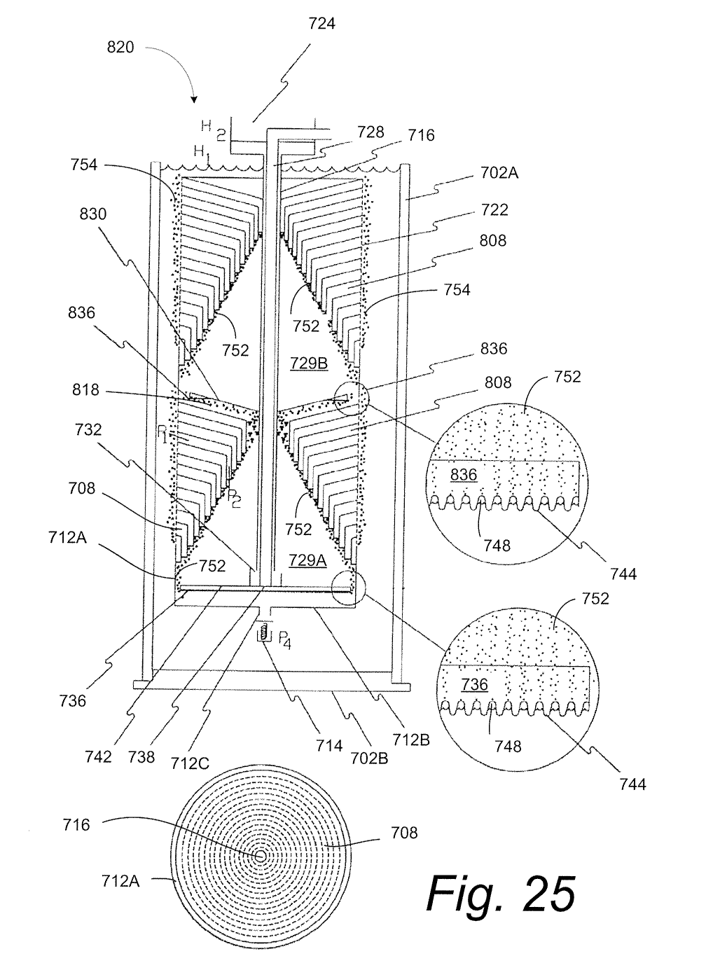

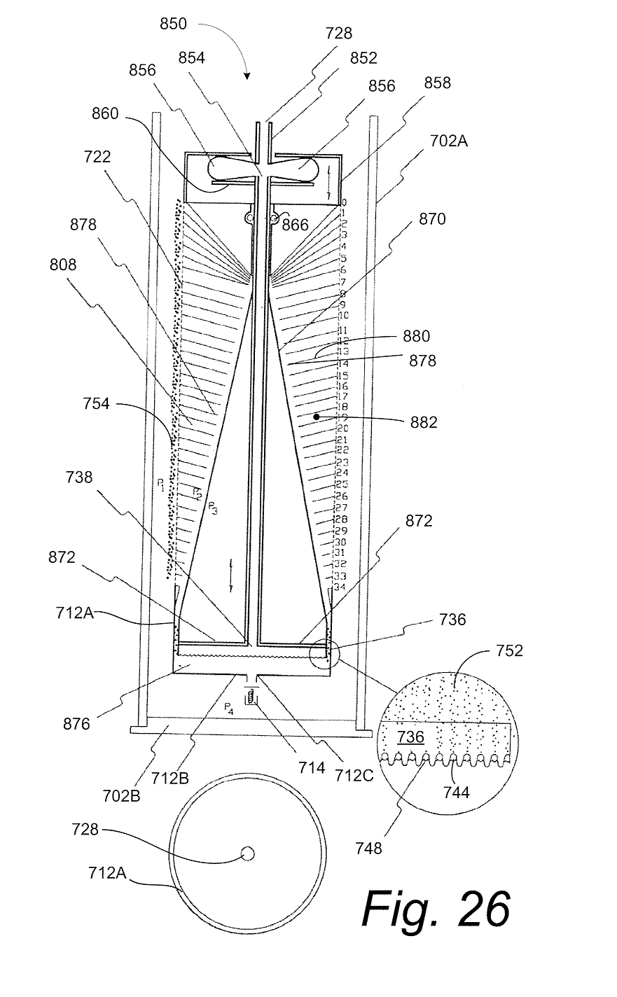

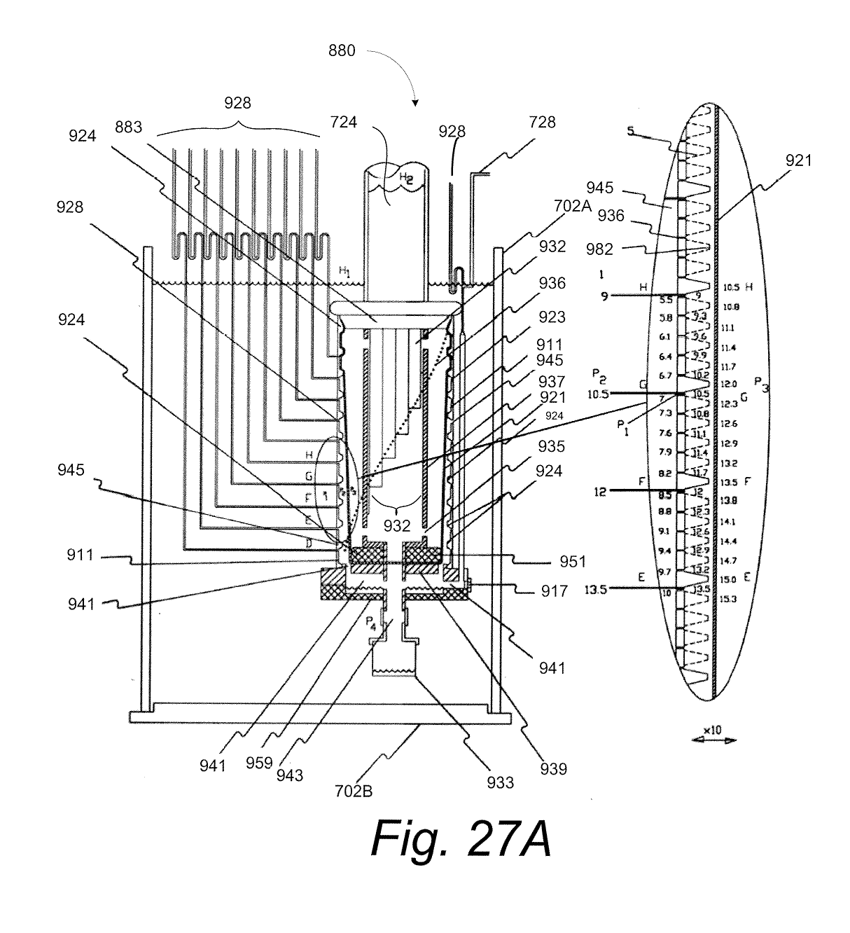

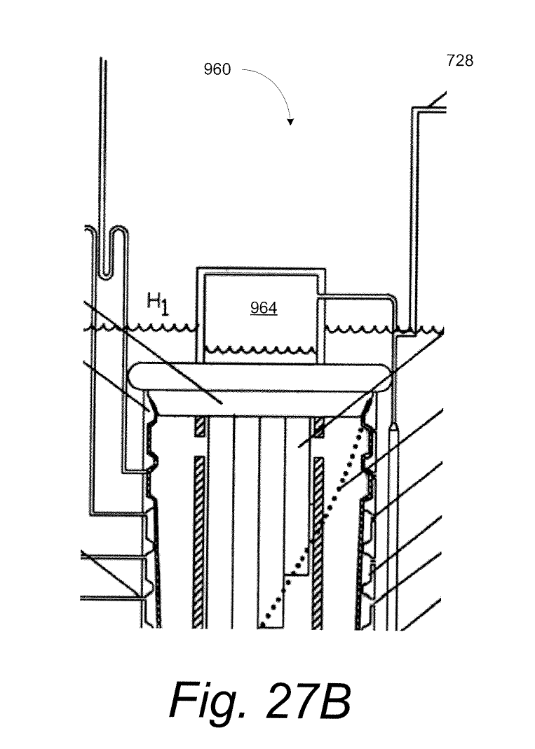

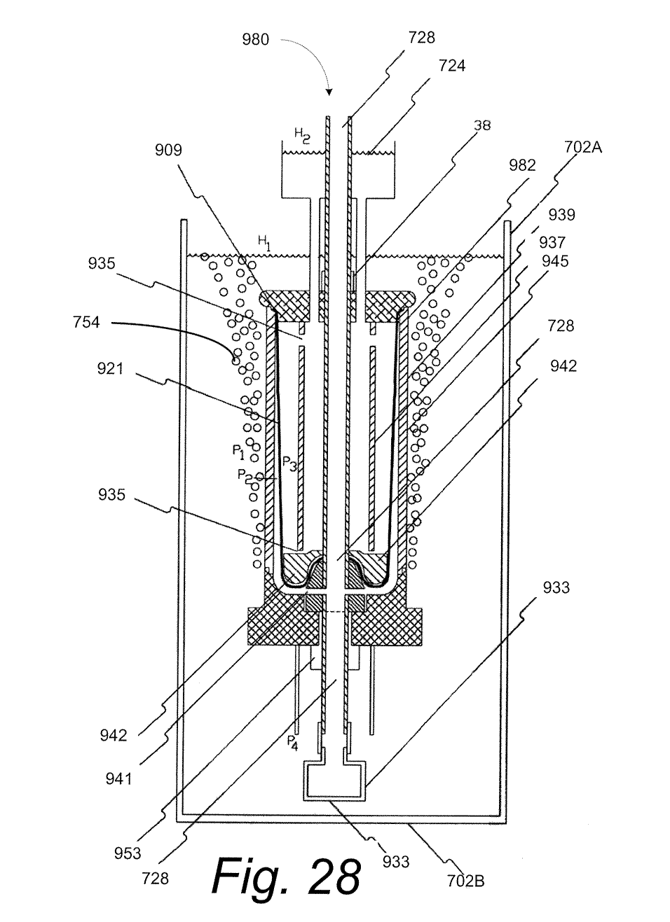

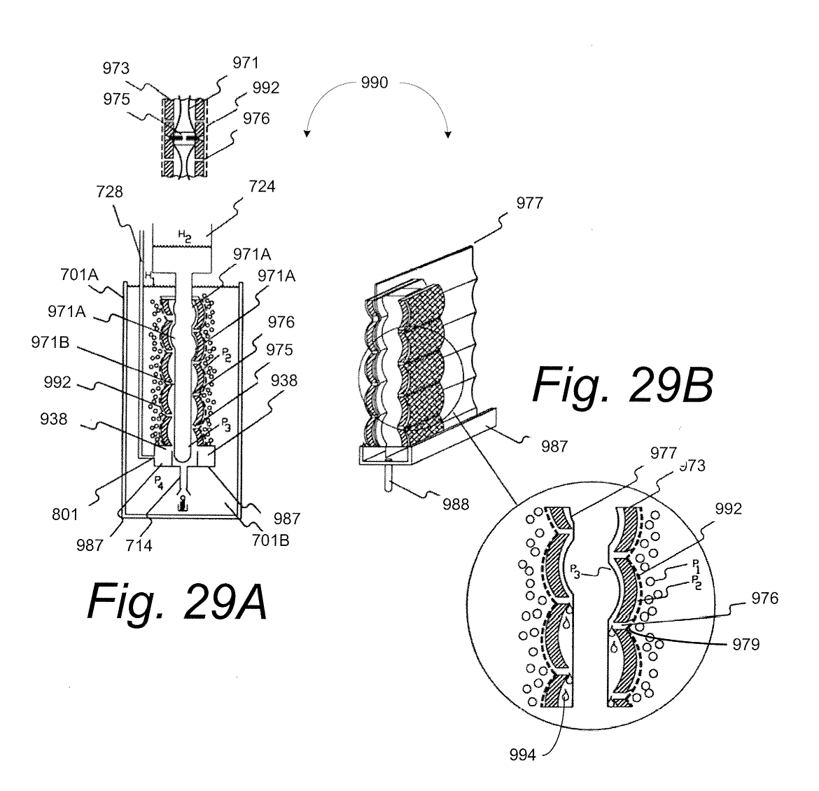

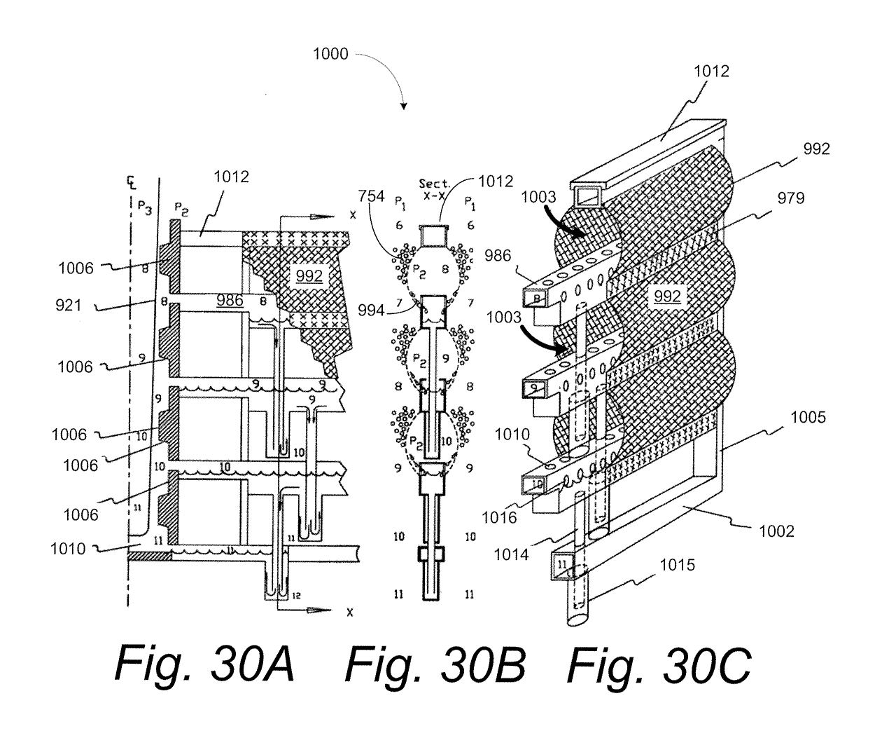

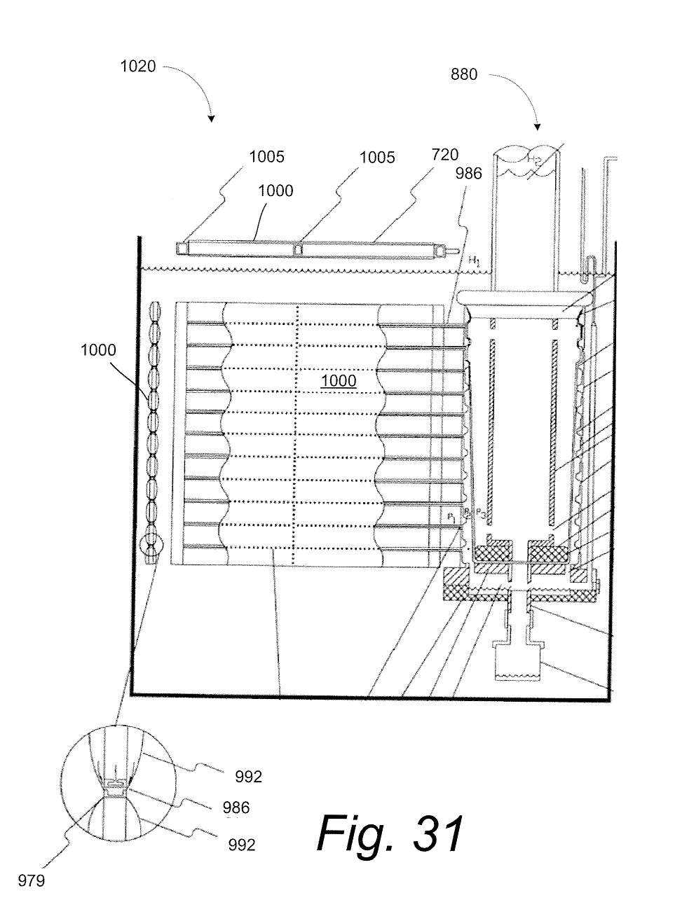

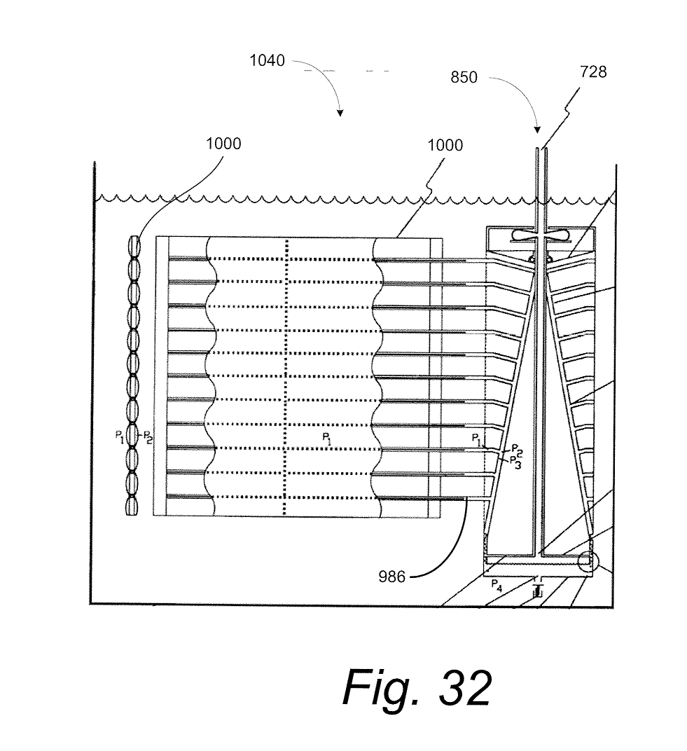

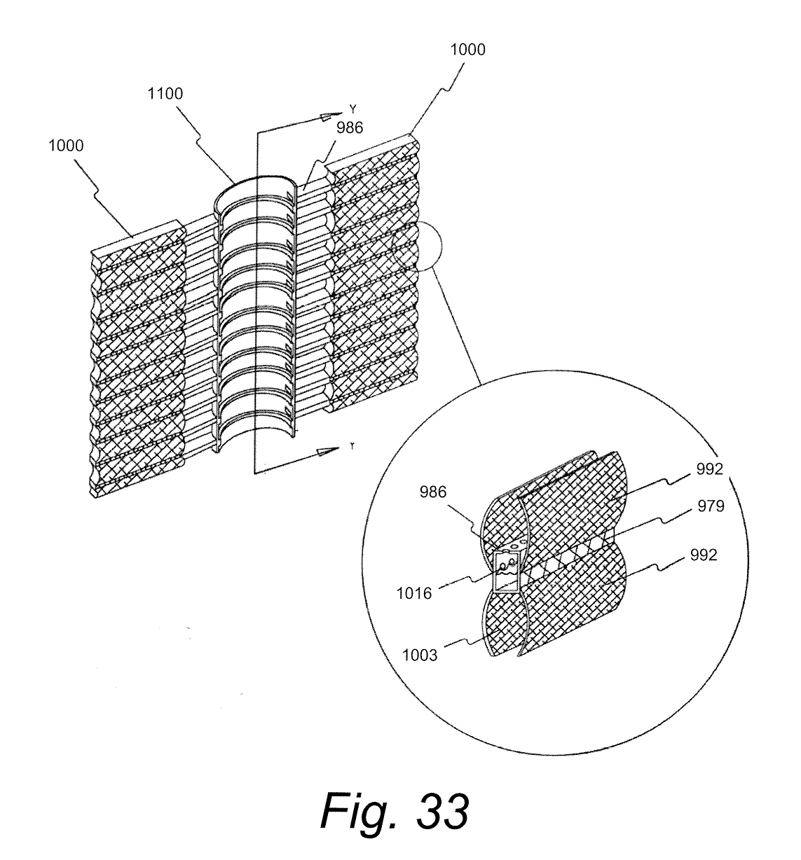

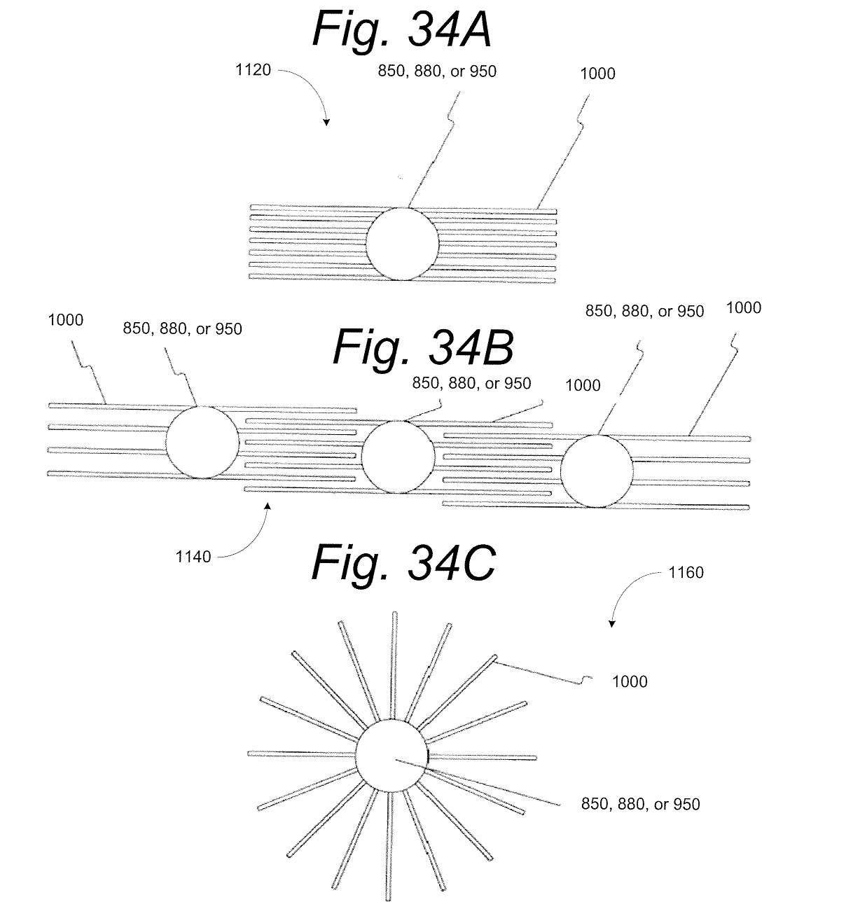

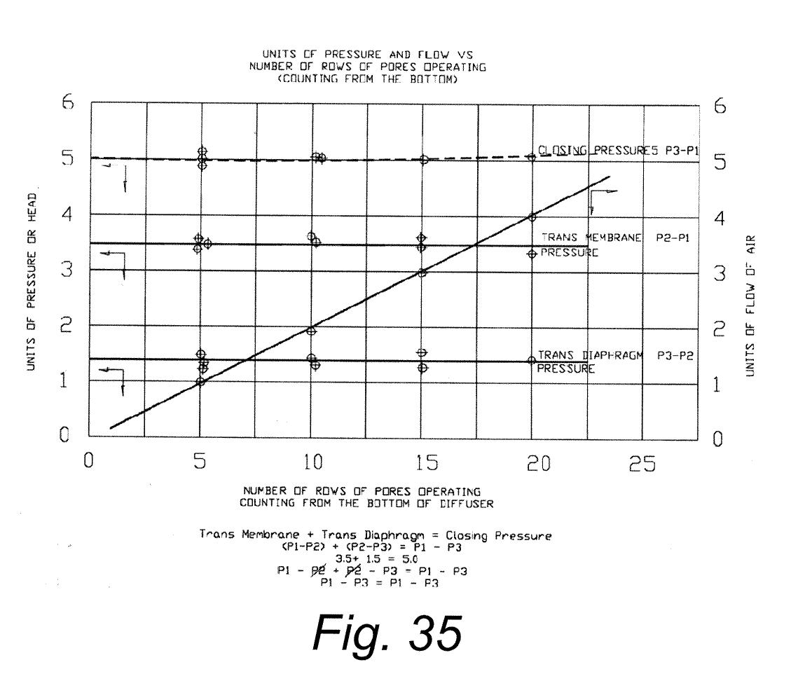

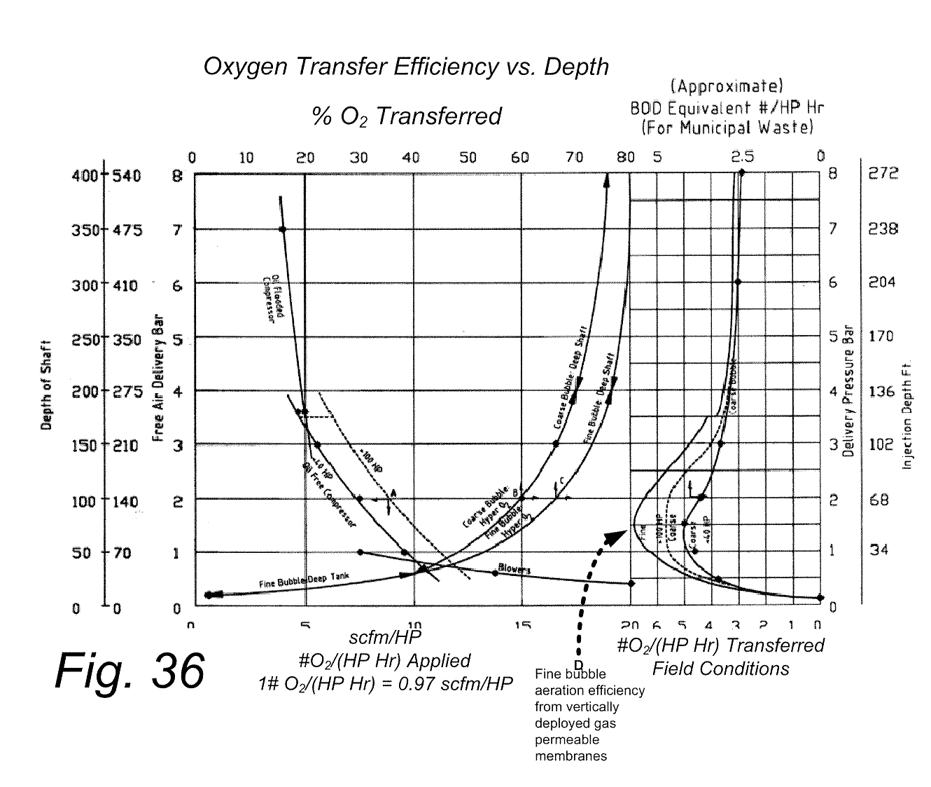

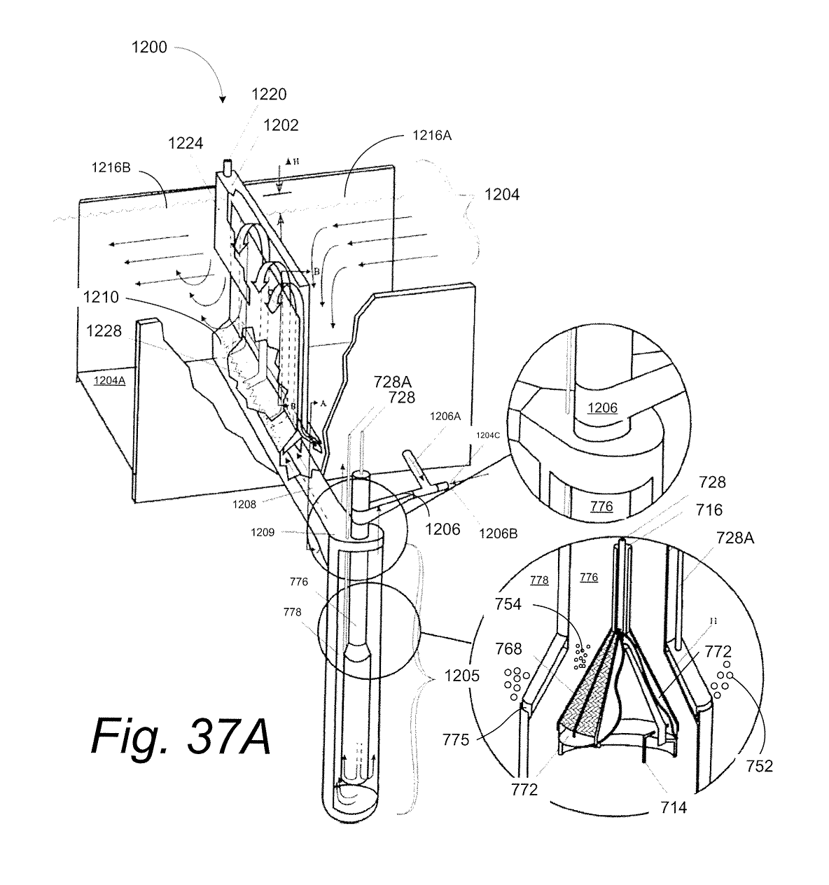

In addition to zone 1 and zone 2 being hydraulically separated by a diaphragm-less air valve (air lock 172), the lower portion of each zone functions as a pseudo plug flow zone while the top portion of each zone is circulated in the superior channels and is well mixed. As a result each of zone 1 and 2 is further divided into two additional smaller zones to double guard against reinoculation of the finished product with the raw influent. When the present invention is used as a sludge digester, baffle 86 extends to about 70-90% of the reactor depth and baffle 84 completely seals off the bottom of zone 2 from zone 1. For certainty that no cross contamination can occur, zone 2 may be further sealed with second outer wall 197 in close proximity to the outer casing 196 as shown in FIG. 10 and FIG. 11. The air locks 170 are shown penetrating the septa wall between zone 1 and zone 2 at a location above baffle 84, but below ports 34 and 152. Zone 1 has an aerated volume below zone 2 of at least one batch volume and preferably two.

The reactor/digester 10′ of FIG. 7 is thus very similar in its operation to the waste water treatment reactor illustrated in FIG. 1, but differs in four principal aspects:
1. The zone 1 surrounds zone 2;
2. Zone 2 extends downward about 70-90% of the depth of the reactor within zone 1;
3. Each zone has its own aeration means;
4. There is liquid to liquid separation between zone 1 and zone 2 through use of the airlock 172.
5. Each of zone one and zone two is further divided into an upper circulating zone and a lower pseudo plug flow zone.

Once sludge enters the reactor/digester 10′ it has a mean residence time of approximately 2 to 3 days in zone 1, and 2 to 3 days in zone 2. The EPA criteria for the production of class A bio-solids dictates the time between batches, which varies with temperature—as an example the minimum residence time for a batch at 60° C. is 5 hours, or about 4.8 batches per day. Therefore, zone 1 and zone 2 theoretically contain between 9.6 and 14.4 batches each. In practice, however, each batch would be about 8 hours, and therefore zone 1 and zone 2 would contain between 6 to 9 batches each. The overall residence time is determined by the biodegradability of the sludge. For class A bio-solids, the process must achieve a minimum of 38% volatile solids reduction which typically takes 3.5-5 days. The batching time is determined by the temperature (see, e.g., FIG. 12). The exemplary operating temperatures of 58° C.-62° C. require approximately 8-4 hours.

As noted above, the air line 62 can be operated to maintain the air pressure in the air lock 172 of the reactor/digester 10′ to control batching. Stopping the air flow in line 62 will also trigger a batch discharge after the appropriate processing time has elapsed. A batch can also be triggered by lowering the liquid level in the zone 2 head tank 15′. Once the batch in zone 2 is discharged, the head tank level in zone 1 is automatically lowered an equal amount by the action of the automatic batching valve located between the bottoms of zone 1 and 2, and the cycle repeats. When a batch is processed through the reactor, it is reduced in solids content from approximately 4-5% down to about 2-3%. This product (class A biosolids) may then be de-watered.

Published research by The University of Washington (Guild et al., Proceedings of WEF Conference, Atlanta Ga., 2001, incorporated herein by reference) indicates that when thermophilic aerobic digested sludge from a vertical shaft reactor having certain features in common with the reactor of the present invention was fed to a mesophilic anaerobic digester, the retention time in the anaerobic digester was reduced, the overall volatile solids reduction was better, the dewaterability was better and required less polymer. The thermophilic aerobic digester is operated with about a 2 day retention time and can generate enough heat to comply with Class A biosolids.

It is well documented that during the aerobic thermophilic digestion of biomass, there is minimal nitrification of ammonia at temperatures above 42° C. It is also well documented that in anaerobic digestion of biomass (where there is no air stripping), ammonia and carbon dioxide react to form ammonium bicarbonate. In a vertical aerobic thermophilic digester, it is reasonable to believe that ammonium bicarbonate also forms, due to large amounts of both ammonia and carbon dioxide remaining in solution due to pressure.

The selection of operating temperatures is very important in long, vertical thermophilic aerobic digesters because ammonium bicarbonate decomposes at about 60° C. Ammonium bicarbonate is very important in the efficiency of the solids liquid separation (dewatering) step of the process. For instance, when operating a deep vertical thermophilic aerobic digester at 55° C. to 58° C., the digested sludge samples were very granular before drying the sample but not after drying at about 104° C. On one occasion when the head tank was opened without cooling the reactor (for emergency repair of a float switch), the inside surface, particularly the uninsulated access cover, was coated with tiny white angular crystals much like white sugar or salt. These crystals subsequently disappeared and were not found again at the higher operating temperatures. Another observation that is common, is that when a batch of product is transferred into the soak zone at about 58° C. (where there is negligible biological activity), the temperature increases and holds constant for about 2 hours, then cools at the cool-down rate of the reactor when operating on hot water. The heat of crystallization of 10,000 mg/L of ammonium bicarbonate would account for the apparent heat generated in the soak zone. Empirically, these observations would suggest the formation of ammonium bicarbonate crystals below 60° C. This is contradicted by the fact that ammonium bicarbonate is very soluble in water, but less so in the presence of high levels of other dissolved solids, and perhaps the surface chemistry of the microbiology facilitates the crystallization process. For instance, Struvite (magnesium ammonium phosphate) is readily formed in anerobic digesters of plants using biological phosphorus removal but not in plants using chemical phosphorus removal. Controlling the reactor temperature to below 60° C. may allow ammonium bicarbonate crystals to form which would easily float separate with the sludge.

Table 1 compares the performance of floatation, nutrient fractionation, and dewaterability of thermophilic aerobic digested sludge that was taken from a deep vertical thermophilic aerobic digester similar to the present invention. It is known that thermophilically digested sludge will dewater better than anaerobically digested biosolids however at much higher polymer dose. Previous studies investigated the cause of the high polymer requirement and found that monovalent ions such as sodium, potassium, and particularly ammonium ions can interfere with the charge-bridging mechanisms in the floc. In conventional thermophilic aerobic digesters the nitrification of ammonia is inhibited over 42° C. and therefore the ammonia produced is in largely in solution, as evidenced by typically high pH. The carbon dioxide produced is substantially stripped out by the large air flows required in these digesters and less carbon dioxide remains in solution to form ammonium bicarbonate. Since the air bubble contact is in the order of seconds, and the rate of solution of ammonia is much faster than that of carbon dioxide, the environment does not favor the formation of ammonium bicarbonate.

TABLE 1
Nutrient Fractionation
CF is Concentration Factor

| | | | | | | | | | | | | |
|---|---|---|---|---|---|---|---|---|---|---|---|---|
| Stream | TS % | CF | TN mg/L | CF | NH₃ mg/L | CF | ORG-N mg/L | CF | TP mg/L | CF | Cake % | Poly #/T |

pH 7.8-8.0
T ° C. Under 60 (59-60.5)
4.80% Digested Vertad Sludge

| | | | | | | | | | | |
|---|---|---|---|---|---|---|---|---|---|---|
| Digested | 4.8 | | 4780 | | 1163 | | 3095 | | 970 | |
| | | 2.2 | | 2.4 | | 1.6 | | 3.1 | | 2.8 |
| Float | 10.7 | | 11347 | | 1860 | | 9487 | | 2750 | |
| | | | | 7.1 | | 1.2 | | 500 | | 24 |
| Recycle | Clear | | 1589 | | 1570 | | 19 | | 115 | |

pH 8.5-8.8
T ° C. Over 60 (61.5-63.5)
3.80% Digested Vertad Sludge

| | | | | | | | | | | | | |
|---|---|---|---|---|---|---|---|---|---|---|---|---|
| Digested | 3.8 | | 1851 | | 802 | | 1049 | | 548 | | 26-30 | 50-70 |
| | | 1.5 | | 1.7 | | 1.2 | | 2.1 | | 1.3 | | |
| Float | 5.6 | | 3185 | | 948 | | 2238 | | 704 | | 31-34 | 14 |
| | | | | 3.4 | | 1.8 | | 9.9 | | 1.6 | | |
| Recycle | Turbid | | 927 | | 702 | | 225 | | 442 | | | |

It is believed that below 60° C. ammonium bicarbonate forms in a deep vertical bioreactor due to the high level of carbon dioxide and ammonia in contact and under pressure for long periods of time. Above 60° C. ammonium bicarbonate decomposes and the carbon dioxide and ammonia are stripped out with the air stream, very similarly to the conventional thermophilic aerobic processes. When the final product, processed below 60° C., is acidified with sulfuric acid, alum, or ferrous sulphate, etc, ammonium sulfate is formed and CO₂ is released, thus floating the sludge. Unexpectedly, the floated product dewaters exceptionally well. In recent reports by Murthy et al. (Mesophilic Aeration of Auto Thermal Thermophilic Aerobically Digested Biosolids to Improve Plant Operations, Water Environment Research 72, 476, 2000; Aerobic Thermophilic Digestion in A Deep Vertical Reactor, Project 30900, Prepared for King County Department of Natural Resources, Mar. 28, 2001, each incorporated herein by reference) the concentration of biopolymer (proteins and polysaccharides) in thermophilically aerobic digestion could be minimized by limiting the residence time of the thermophilic digestion. The present invention has ⅓ to ½ the residence times of conventional thermophilic aerobic digesters. The presence of biopolymer and monovalent ions, particularly ammonia, in solution correlates well to an increase of polymer consumption. The formation of ammonium bicarbonate would significantly reduce ammonium ions.

Lowering the pH with acid to about 5.0, causes the biosolids to float to about 10-12% concentration. Lowering the pH to 4.5-4.0 and lower yields a faster float separation but may require adjustment, e.g., to pH 5.5-6.0, which is the pH range of the sludge before digestion. Digestion below 60° C. controls the reactor pH to 7.8-8.0 while digestion over 60° C. results in an operating pH of 8.6-8.8, reflecting the effect of more free ammonia due to the decomposition of the ammonia bicarbonate. Flotation separating is better below 60° C. than above 60° C., in all categories, where the less acid used yields a thicker float blanket and better nutrient fractionation. These biosolids can be further centrifuged to 30-35% solids concentration using a low polymer dose of about 15 pounds polymer per ton dry weight biomass. The acidification process may cause some cell lysis, which will also help dewater the sludge.

These results are substantially better than conventional thermophilic aerobic digestion processes which require 30-50 pounds polymer per ton dry weight biosolids and centrifuge to only 20-25% solids. Acidifying the conventional thermophilic aerobic digester product does not float separate the solids, presumably due to the lack of ammonium bicarbonate.

Examination of the data in Table 1 shows the profound effect on flotation, dewatering, and nutrient fractionation, between operating the reactor under 60° C. and over 60° C. Operation under 60° C. generates less free ammonia and more ammonium bicarbonate, therefore the pH is lower and there is less ammonia in the off-gas. In order to get a common base for a comparison between the two sets of data, a concentration factor is calculated. The concentration factor (CF) is the ratio of the final concentration to the starting concentration.

Looking at the “under 60° C.” set of data the float solids were 2.2 times more concentrated compared to the digested sludge solids; the total nitrogen in the float was 2.4 times as concentrated; the ammonia in the float was 1.6 times as concentrated; the organic nitrogen was 3.1 times as concentrated; and the total phosphorus was 2.8 times as concentrated. Except for ammonia the nutrient concentration factor ranged from 2.4 to 3.1 when the solids concentration factor was 2.2.

Looking at the “over 60° C.” set of data the float solids were 1.5 times more concentrated compared to the digested sludge solids; the total nitrogen in the float was 1.7 times as concentrated; the ammonia in the float was 1.2 times as concentrated; the organic nitrogen was 2.1 times as concentrated; and the total phosphorus was 1.3 times as concentrated. The nutrient concentration factor, including ammonia, ranged from 1.2 to 2.1 when the solids concentration factor was 1.5.

These data strongly suggest that the nutrient fractionates into the sludge solids in nearly the same ratio as the solids concentration factor (except for ammonia under 60° C. which is explained later). It is expected that the same fractionation will also occur during dewatering of the floated solids.

However, looking at the float solids concentration factor compared to the subnatent or recycle stream, a completely different and surprising discovery emerges.

The “under 60° C.” set of data shows the total nitrogen in the float was 7.1 times as concentrated as in the recycle; the ammonia in the float was 1.2 times as concentrated; the organic nitrogen was 500 times as concentrated; and the total phosphorus was 24 times as concentrated. Except for ammonia all the nutrients shifted dramatically from the clear recycle into the sludge solids. In other words, except for ammonia, the other nutrients are substantially removed from the recycle streams thus benefiting the operation of the treatment plant and improving the nutrient value of the bio-solids.

The “over 60° C.” set of data shows the total nitrogen in the float was 3.4 times as concentrated than in the recycle; the ammonia in the float was 1.8 times as concentrated; the organic nitrogen was 10 times as concentrated; and the total phosphorus was 1.6 times as concentrated. Except for ammonia and phosphorus, the nutrient shifted significantly, but less dramatically from the turbid recycle into the solids.

A possible explanation of the minimal shift of ammonia into the solids is that the acidification of ammonium bicarbonate results in ammonium sulphate which is very stable but very soluble. The shift in the organic nitrogen to the sludge solids is likely because organic nitrogen is present in the particulate matter of digested sludge and would likely float separate. The ammonium bicarbonate crystals, if any remain after acidification, might also float separate as particulate matter. The shift in phosphorus to the sludge solids by acidification of the sludge can be explained by the formation of insoluble precipitates in the presence of a high concentration of metals occurring naturally in the sludge. This effect is not so pronounced over 60° C., probably because the float separation was poor and the tiny particles formed in the precipitate are difficult to float.

In constructing and installing the improved vertical shaft bioreactor 10 of the invention, twin bioreactors (to satisfy EPA redundancy requirements) will often be placed in cased and grouted steel shafts approximately 36 inches in diameter and 250 feet deep. The exemplary scope and reactor design described here for illustration purposes is suited for a community of about 5000 people requiring a tertiary treatment plant with biological nutrient removal would proceed as follows. Also described here for illustration purposes is a novel, modular bioreactor assembly design, while it will be understood that the use of a modular assembly method is not necessary to practice the invention.

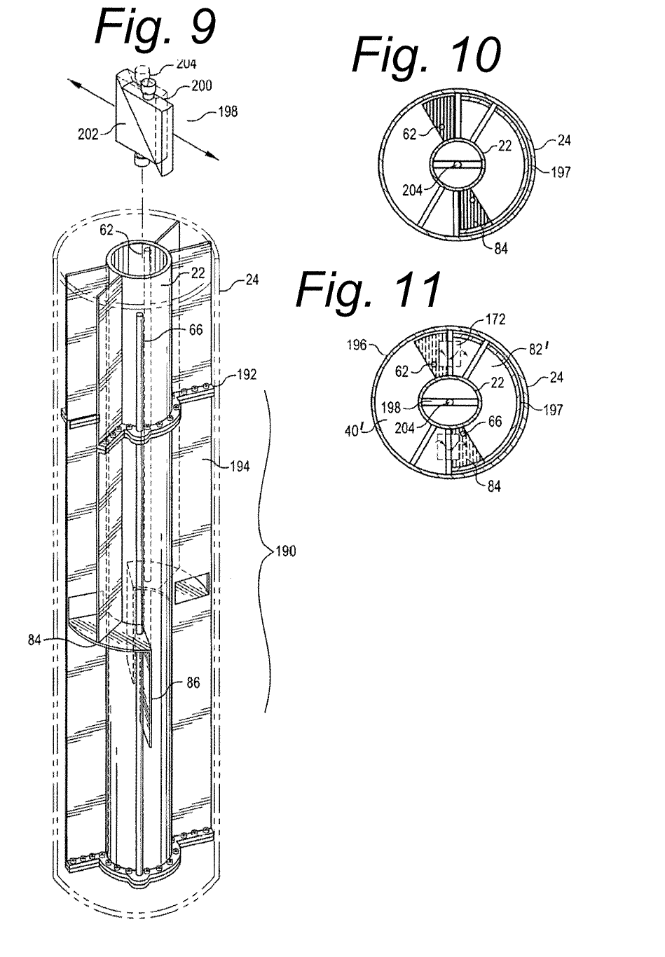

The inner head tank for this exemplary installation is about 8 feet in diameter and approximately 12 feet high. The shop fabricated reactor internals include 6 flanged tube bundles each about 40-feet long. The bottom 40-feet length (first length) is made up of the aeration distributor 60, the shear header 70, the airlines 62 and 66, attached to a short length of down corner 12. The second, third and fourth tube bundles, include 40 feet, modular sections 190 typically including a central down corner conduit 22 with airlines 62 and 66 attached (see, e.g., FIGS. 9-11). These sections are joined, e.g., bolted, together sequentially at modular section joints 192 to the preceding section as the sections are sequentially lowered into the shaft. The top two sections, 5 and 6, comprise the down corner air lines and superior channels formed as a unit by using the central down corner 22 and radial channel partitions 194. After installation, the radial partitions will assume a light press fit in the reactor shell (e.g., against an inner wall 196 of the riser conduit 24.

To facilitate modular construction of the bioreactor 10, the superior channel-forming radial partitions 194 are relaxed from the inner wall 196 of the reactor during insertion by expanding the diameter of the central (e.g., down corner 22) conduit in a direction generally perpendicular to the radial partition (see, e.g., FIG. 11). To expand the down corner conduit in this manner, FIG. 9 depicts a novel conduit expansion device 198, which is provided, for example, in the form of a spreader sized and dimensioned for insertion within the down corner conduit. The spreader typically has paired, opposed and reciprocating spreader parts 200, 202, which can be manually, reciprocatingly repositioned between relaxed and expanded configurations (e.g., by remotely turning a threaded expansion driver 204 that engages each of the reciprocating spreader parts and causes them to spread in the direction of the outwardly directed arrows in FIG. 9, or to cooperatively relax in the opposite direction). Thus, FIG. 10 provides a diagrammatic end view of the reactor internal section showing the down corner and radial baffles. The expansion tool 198 in the center of the down corner conduit 22 is shown in its relaxed position. Accordingly, in this Figure the down corner is also in its relaxed position. FIG. 11 provides a diagrammatic end view of the reactor internal section showing the down corner forced out of round by the expansion tool in its expanded configuration, wherein the radial baffles 194 connected to the down corner are forcibly retracted away from the inner casing wall 196 to allow insertion of the reactor section 190 therein. When the invention is used as a digester, a sealed zone 2 can be provided by adding a second outer wall 197 on half the assembly. Because this second wall is applied to only half the circumference, it does not prevent the spreaders from deforming the center tube thus relaxing the wall pressure of the septa partitions during installation.

After assembly to this stage is complete, the zone 1 head tank 16 is bolted to the top of the last section. The zone 2 head tank 15 is field-erected from pre-fabricated sections. The modular reactor tube bundles can be delivered to a site for installation by a single truck and the head tanks by a second truck. The clarifier 120 shell can be cast in place using concrete or made from prefabricated steel sections. The clarifier is fitted with a conventional skimmer mechanism. Finally the compressors and other ancillary equipment are connected. Because of the small footprint these small plants can easily be housed in a building.

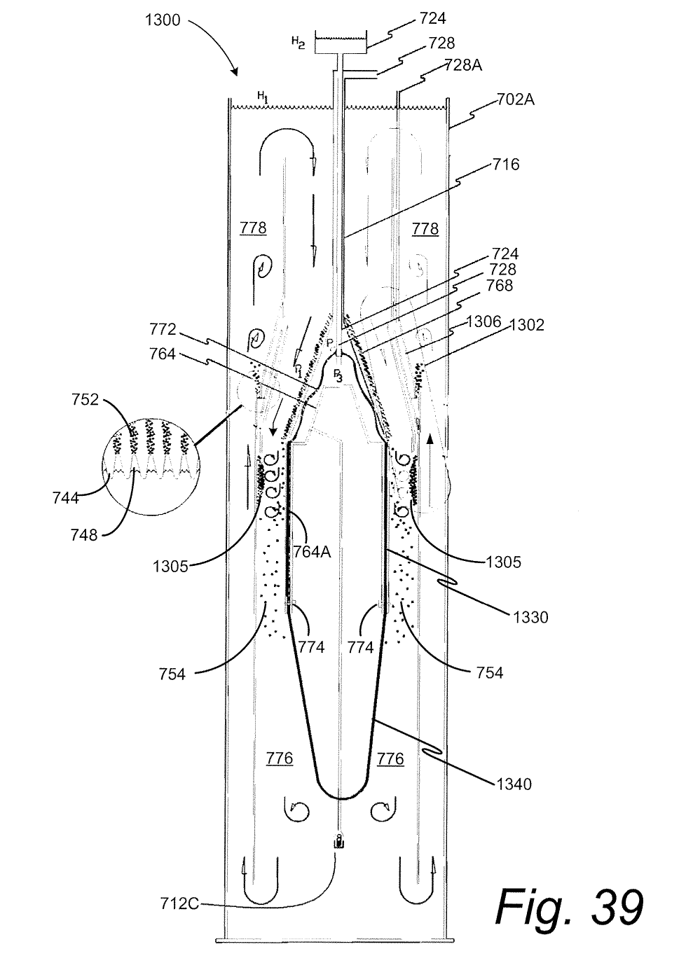

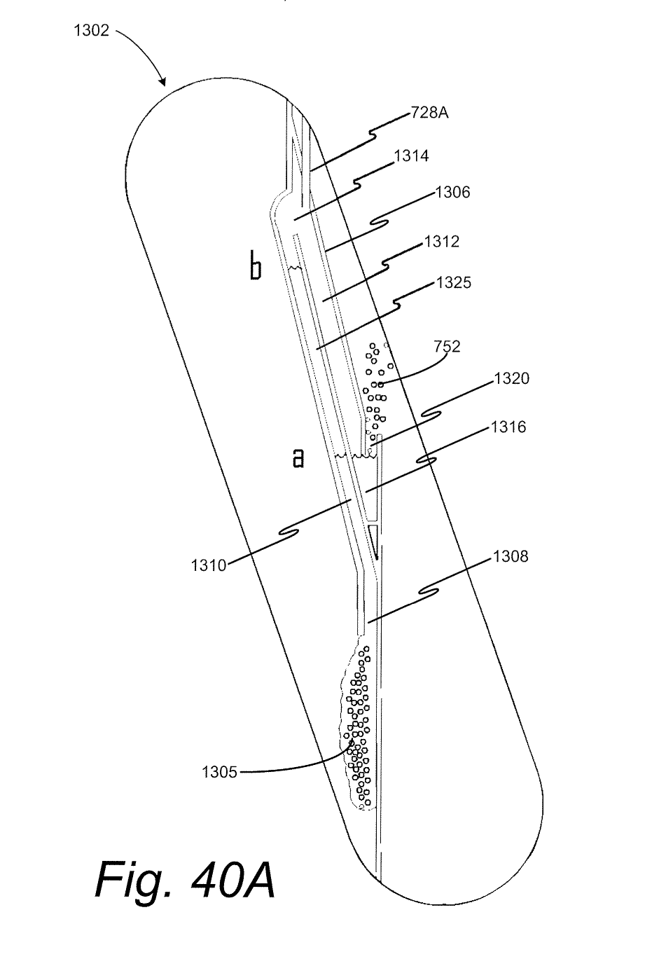

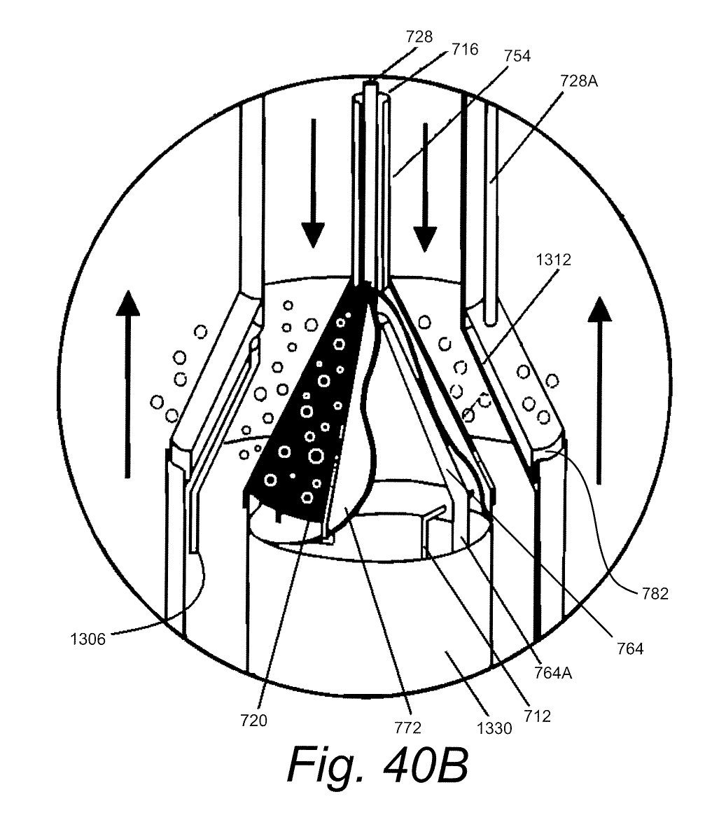

To further understand the distinct and diverse methods of waste water treatment employing the novel apparatus provided herein, FIG. 13 provides an exemplary block-flow diagram which can be used to identify the various flow patterns and further understand the inter-relationship of unit processes. FIG. 13 is divided into four areas, as delineated by the broken lines. The bottom left area is a conventional preliminary treatment area where the waste water is passed through a fine screen in unit A and is degritted in a hydroclone separator C. The screenings and grit are deposited in a hopper B and sent to landfill.

The upper left area of FIG. 13 is the wastewater treatment and BNR part of the bioreactor of the invention and represents certain exemplary components thereof. Unit D represents a deoxygenation step or pre-denitrification step and references channel 40 channel 32 and recycle 50 of FIG. 1. The unit D is agitated by the anoxic waste gas originating in lower zone 1 (channel 80 of FIG. 1. The line 301 schematically represents the waste gas transfer from lower zone 1 (channel 80) to upper zone 1 (channel 40) but in this aspect of the invention the lower zone 1 is immediately below upper zone 1 and no transfer line is needed. Unit D receives raw influent (channel 30) from unit C, recycle from head tank E and nitrified recycle from zone 2 (unit H). The purpose of unit D is to remove any useable molecular oxygen, accept nitrates from recycle and ammonia and BOD from the raw influent.
1. Unit E represents the head tank 16. This unit receives anoxic gas (309) from unit D which serves to mix the contents of head tank 16. Unit E also accepts raw waste water containing about 25 mg/L of ammonia and 1.75 volumes of nitrated recycle containing no ammonia or appreciable BOD. After mixing, the nitrate in the 1.75 volumes of nitrated recycle are converted to nitrogen gas and the influent concentrations are thus diluted by, e.g., 1 Q×25 mg/L ammonia+1.75×nil ammonia/2.75 Q=25/2.75=9 mg/L ammonia and similarly 200/2.75=72 mg/L BOD. The denitrification process liberates, e.g., about 2.6 mg oxygen/mg of nitrate denitrified and some of the alkalinity is recovered. These quantities are exemplary and beneficial to the process. Denitrification is quite a fast reaction and is accomplished by the microbes naturally occurring in the waste water.
2. Unit F receives, e.g., about 2.75 volumes of denitrified wastewater containing approximately 9 mg/L ammonia and 72 mg/L BOD. Since there is no molecular oxygen or bound oxygen, the biomass will become anaerobic and start using some of the proteins in the raw sewage to make amino acids. The poly P microbes in the system will give up their phosphorus and load up on VFA's. There is some evidence that VFA's can be produced in anaerobic sewer lines where anaerobic slime is allowed to accumulate on the pipe wall. A rope like open weave tube (131) may be hung from the head tank down inside the clean bore channel 12. There is minimal risk of plugging the channel because unlike other prior reactors there are no airlines or other pipes to become entangled with. It is to be expected that anaerobic biomass will accumulate on the rope and some VFA's will be produced allowing some biological phosphorus to be removed. Monitoring the weight of the rope will give some indication of the amount of biomass present. The flexibility of the rope and the velocity of the water should cause excess biomass to fall off and drop into the chamber 67 sump where it can be removed as waste sludge.
3. Unit G represents the lower portion of zone 1. This area is highly aerated and is designed to reaerate the anaerobic mixed liquor as quickly as possible. Since the mixed liquor that enters the lower portion of zone 1 is rich in BOD, ammonia and sufficient VFA's, the oxygen demand in the lower portion of zone 1 will be the maximum for any part of the reactor. The BOD removal step requires ammonia of cell synthesis which is 5% of the BOD or about 4 mg/L. There is a feed forward stream of 2.75 Q which is transferred into zone 2 containing about (9 in zone 1-4 consumed in cell synthesis)=5 mg/L of ammonia. Experience with vertical bioreactors has shown that some of the ammonia is actually nitrified in the lower zone 1. It is not uncommon to find 2-3 mg/L of nitrate in a bioreactor designed not to nitrify. In the case of a BNR plant designed to nitrify, some of the nitrifying bacteria will end up in zone 1 because of the 1.75 Q recycle stream from zone 2 to zone 1. Additionally there is 5 Q flow (containing 2 mg/L nitrate) from zone 1 to the deoxygenation Unit D. These flows will be denitrified further removing nitrogen from the system. Conservatively the effluent from zone 1 to zone 2 will contain no more than 5 mg/L BOD, 3 mg/L ammonia, and 2 mg/L nitrate. the 3 mg/L of ammonia will be fully converted to nitrate in zone 2. Therefore the effluent will end up being about <10 mg/L BOD, <10 mg/L TSS and <5 mg/L total Nitrogen.
4. Unit H represents head tank 15 and operates under very low loading rates. The feed rate into zone 2 head tank is 2.75 Q containing 3 mg/L ammonia and 10 mg/LBOD. Zone 2 receives its air supply from zone 1 (shown schematically as line 302). Because of the low BOD the biomass production will be low and the biomass produced by nitrification is ⅕-⅓ that of BOD reduction. Because of the slow growth of nitrifying bacteria, they cannot be permitted to be washed out of zone 2 in the 1.75 recycle flow to zone 1. Fortunately these bacteria are attachment microbes and will grow on any fixed or moving bed media. In the present invention moving bed media can advantageously be used, because the lower end of zone 2 is designed not to allow any back-flow into zone 1, and simple screening will prevent the media from escaping at the top. Fixed media may also be employed but fixed media tends to plug up occasionally and requires cleaning or changing. Moving bed media tends to be self-cleaning but does wear out over time.
5. Unit I is a conventional sedimentation clarifier which separates the bio-solids from the effluent and returns these biosolids (activated sludge, RAS) to unit D or E. In a BNR plant the RAS should never become anoxic because the nitrate in the effluent and RAS will denitrify causing the sludge to start floating in the clarifier. In the present invention there is the potential to provide an effluent from zone 2 with a high DO but a low oxygen demand, thereby preventing anoxic conditions in the clarifier. Very high DO in the effluent is discouraged because there could be some resolublizing of ammonia and phosphate in the clarifier.

Membrane separation, although expensive, eliminates many of the operational problems of clarifiers in BNR plants. In the present invention membrane separation allows much higher MLSS and a smaller reactor. Membrane separation provides a better quality recycle water than the present standards require.

The upper right of FIG. 13 is the final chemical treatment of tertiary water to meet recycle quality standards. By current law, chemical flocculation, filtration and residual chlorine must be used. Unit M is a flocculating tank with mechanical mixer. Unit N is a rotating cloth disk filter. Unit P is a ultra violet disinfection channel and combined back wash tank. Unit 0 is a chlorination step where just enough chlorine is added to maintain a residual in the pipe line. Unit Q is a back wash pump which can be used to backwash the cloth filter or the membranes if required.

The lower right of FIG. 13 is the thermophilic aerobic digestion section of the plant. Unit R represents the first aerobic stage (zone 1) of the two step process. Unit S represents the second stage of the digestion or zone 2. These two zones are connected through an air lock valve. Unit W represents the acid flotation thickening step. Unit T is an acid feeder. Unit V represents the dewatering step, in this case a centrifuge, with a unit polymer feeder U.

The BNR process above has been examined in detail in FIG. 13 in order to illustrate process advantages that are not reported in previous bioreactor designs. Among these novel process advantages are that screened and degritted influent is fed into deoxygenating channel 40 and is mixed with denitrified liquor from head tank 16. The head tank 16 is agitated with anoxic gas produced in channel 40 and with DO<0.05. Denitrified liquor from head tank 16 descends in channel 12 under anoxic or optionally anaerobic conditions completing the denitrification process or optionally creating VFA's.

In addition, it is notable that downflow in channel 12 enters the bottom of zone 1 in the vicinity of the aeration distributor in an area of vigorous mixing. Channel 80 which is the major portion of zone 1 is highly aerobic, removes the BOD, rapidly oxidizes the VFA's consuming phosphorus and in some cases nitrifies a portion of the ammonia.

Further notable is the fact that rising liquor in channel 80 splits into the deoxygenation area and a portion passes upward into zone 2. Zone 2 substantially degrades the remainder of the BOD and converts the remainder of the ammonia to nitrate.

In additional aspects, waste gas from channel 80 circulates via deoxygenation channels 32 and 40 and also provides the oxygen for bio-oxidation of BOD and ammonia in zone 2.

Also noted, a portion of nitrified liquor can be returned to the denitrification step where the nitrate —N is converted to nitrogen gas while a second portion goes to a clarification step where the biomass is separated from the effluent. The biomass is returned to the denitrification step and the clarified effluent is discharged.

In related embodiments, anoxic gas is used for mixing anoxic liquor. Unit D deoxygenates not only the various liquid streams, but the gas stream passing through the unit. This deoxygenated gas can be used subsequently to mix the contents of the denitrification unit E. This eliminates the need for mechanical mixers saving energy, maintenance and capital.

Additional embodiments of the invention provided novel anaerobic processes. Unit F is a long vertical channel which may converted to an anaerobic chamber for the purpose of creating VFA's. In the present invention there are no airlines or extraction lines in unit F. This allows the use of media such as open weave rope or tubes to be suspended in the reactor without the fear of plugging the channel or becoming entwined with other pipes. The purpose of the fixed media is to accumulate attached growth anaerobic bacteria (acid formers). The amount of fixed media and anaerobic biomass can be adjusted from the surface by rolling up a portion of the rope or fabric tube. The amount of media can be monitored on line by measuring the weight of the rope. The liquid velocity downward in channel 12 keeps excess biomass from forming and any excess will fall off. Since channel 12 is open at the bottom waste anaerobic biomass would collect in sump 67 and be removed through the flotation tank Unit J.

In still additional embodiments, wasting sludge through an air line 66 or 69 provides instant spontaneous flotation upon depressurization. Wasting sludge (WAS) from a well aerated and mixed part of zone 1, a process not contemplated in previous designs, favors the capture of phosphate in the sludge. Float solids are suitable for digestion without any further thickening.

### Membrane Separation System

This description next addresses membrane separation systems, methods and devices employing a selective, semi-permeable, microporous, or other partitioning membrane for processing, refining, and/or treating liquid compositions, for example membrane waste-water purification processes and apparatus. These systems, methods, and devices provide improved throughput and/or improved operating life of submerged membranes, particularly membrane bioreactors providing biological treatment of wastewaters.

There are several technical considerations for incorporating membrane bioreactors in wastewater treatment facilities, including long vertical shaft bioreactors. A first consideration is a popular misconception that the membranes alone produce an exceptional quality effluent. This is not necessarily accurate because membranes, in themselves, do not produce recycle quality water. The treatment of wastewater to recycle quality is primarily the result of biological treatment, however a micro filtration membrane is responsible for physically separating substantially all the microorganisms from the water, down to about 0.1 micron in diameter. Viruses smaller than 0.1 micron are also typically removed because about 99% of viruses stick to host bacteria. The better the bioreactor, the better the quality of effluent.

In cases where inorganic dissolved solids must also be removed, the effluent from the biological treatment membrane reactor can be further treated by using ultrafiltration, nanofiltration, or reverse osmosis (RO). This quality of water is suitable for aquifer recharging etc.

A second consideration is that recycle quality water not only requires the removal of biological oxygen demand (BOD) and total suspended solids (TSS), but also requires the removal of the nutrients, nitrogen and phosphorus, (N & P) to low levels that will not support aquatic growth. This requires the use of a good biological nutrient removal (BNR) process. Typical existing membrane bioreactor processes operate on a single sludge back-mixed bioreactor, which is less efficient and more expensive to build and operate than the improved long vertical shaft bioreactors.

For example, a presently proposed installation of twin 0.25 MGD (0.5 MGD total) conventional membrane biological reactors is estimated to cost about 1.2 million dollars, (reactor and membranes only), occupy about 8000 sq. feet, draw about 75 HP, and require 1000 standard cubic feet per minute (scfm) of air. By comparison, twin improved long vertical shaft 0.25 MGD reactors would cost about 1.0 million dollars including the price of the membranes estimated at $400,000. The improved long vertical shaft bioreactors would occupy about 1000 sq. feet and draw about 30 HP. Only 100 scfm of air is required for the improved long vertical shaft bioreactors, reducing the process off-gas flow to the equivalent of a household kitchen or bathroom fan. The improved long vertical shaft bioreactors operate in a plug flow configuration with internal recycle streams. Plug flow reactors are known to produce a better quality effluent than back-mixed reactors. This is because in a plug flow reactor the effluent is at the lowest possible concentration achievable with that biomass. In a back-mix reactor, the effluent constituents are at the same concentration as the contents of the reactor. Indeed, in some cases in a back-mixed reactor, a portion of the influent may short circuit directly to the effluent. It is also known that with a single sludge bioreactor, where specialty microbes such as nitrifiers must compete with more robust and faster growing BOD microbes, larger quantities of biomass are required (to prevent wash-out of the nitrifiers). This leads to larger reactors.

An additional consideration is that, aside from the biological advantages of the improved long vertical shaft bioreactors, there are certain hydraulic advantages that are not possible with other reactors. Several unique hydraulic characteristics observed in existing long shaft vertical aeration reactors suggest that membrane separation systems will operate better in a vertical aeration reactor than in a surface back-mixed reactor because of substantial concentrations of supersaturated dissolved gases.

To confirm this prediction regarding supersaturated dissolved gases, a membrane separator was adapted to an existing long vertical shaft aeration reactor. A principal hydraulic characteristic of vertical aerators is that the reactor circulates a mixture of bio-solids, liquid, dissolved gasses and dispersed gas (bubbles), in a very long vertical pathway. The pressure at the lower end of this pathway can be up to 150 psi. As a result of the pressure, there are substantial concentrations of supersaturated dissolved gasses in the liquid even when brought to the surface. These supersaturated gasses represent a significant resource of stored energy. For example, in a 0.25 MGD improved long vertical shaft bioreactor, the surface area in contact with the moving fluid in the reactor changes from about 4000 sq. feet in the reactor to about 20,000 thousand sq. feet in a membrane cell. When liquids containing supersaturated dissolved gasses contact a large surface, the dissolved gas tends to come out of solution and create a scouring action. This is like using soda water to remove spots on clothing. Actually, there are many cleaners that use foaming agents to improve scouring action.

In the case of long vertical shaft bioreactors with submerged membrane bioreactors, it is predicted that the action of supersaturated dissolved gas in the mixed liquor will help keep a membrane surface proximate to the mixed liquor sufficiently clean, thus increasing the flux rates (rate of liquid flow through the membrane) and the time between cleaning. There are several observed factors of long vertical shaft bioreactors that provide support for this prediction. For example, a vertical bioreactor that had run 22 years was recently dismantled. The head tank was made of steel plate, sand blasted and coated with 6-mil (0.006″) epoxy. The remainder of the reactor was bare steel. The epoxy coated surfaces were exceptionally clean and even the bolts in the epoxy coated head tank could be easily undone. There was no evidence of any biomass buildup on the epoxy surface, even near the down corner end of the head tank where the flow velocity would be very slow (perhaps 0.1-0.5 ft/sec). The dissolved gas content at that point would be about 25-35 Mg/L and the colloidal gas content would be about 40-50 ml/L (50-65 Mg/L). There were, a few locations where the epoxy coating had been damaged resulting in a localized accumulation of biomass attached to the bare steel. The bare steel surfaces in the rest of the reactor were coated with a gray slime layer, even in the areas of high turbulence and high dissolved gas content. This gray biomass slime, typically found on metal surfaces in these types of reactors, contains phospholipids and is useful in protecting the bare steel against corrosion, referred to as bio-passivation.

To further validate these findings, a rubber hose about 100 ft long, weighted at its lower end with 90 feet of steel pipe was used in a vertical shaft aerator for an air line in the down corner. The liquid flow velocity in the upper end of the down corner was in the order of 3-4 feet/sec. The hose could be reeled up to change the point of air injection in the down corner. On the upper end of the hose there was no biomass build up in the zone where dissolved gasses were present, but there was a significant biomass build up in the zone where these gasses were re-dissolved due to increasing pressure in the down corner. The liquid velocity was the same for both the upper and lower zones in the down corner. This hose was designed for air service and was not permeable to air from the inside. This observation also shows that in the absence of dissolved gas in the down corner biomass will build up to provide an anoxic/anaerobic zone.

In additional studies, an early design vertical bioreactor was equipped with a fiberglass down corner. This plant is still in service with no report of any failures. Another plant built at the same time, also using a fiberglass down corner, was shutdown and filled with clean water. Video inspection showed no build up of biomass on the wall of the fiberglass tube and no delamination of the resin and fibers. Fiberglass is typically not permeable to dissolved gas.

In a separate study, a small vertical aeration shaft was inspected after about 26 months of service. The ABS down corner was in good condition with no biomass build up. A similar vertical aerator was fitted with a steel down corner. Inspection revealed a phospholipid biomass coating commonly found in steel reactors.

Further validating the present findings, during the early development of vertical bioreactors rubber down corner tubes were installed to reduce the suspended weight and to prevent flow reversal. Three of these downcomers failed due to de-lamination of the tube wall between the rubber surface and the reinforcing fabric. These tubes were designed for water service and were permeable to dissolved air. The maker of the tube claimed that dissolved air had become entrapped between the inner and outer rubber layers causing the failure. This phenomenon is seen in tubeless radial tires where the air in the tire leaks into the cord layer and causes delamination.

In a separate study, another vertical aeration reactor was examined for corrosion after 20 years of service. The only part of the reactor that had any significant wear was at the outlet of the air-lift influent pump that was located in the riser section of the reactor. It would appear in this extreme duty, the air/water velocity is sufficient to remove the protective phosphate coating allowing corrosion of the bare metal.

A frequent observation regarding surface condition of several head tanks examined after long periods of operation is that in locations featuring an abrupt change in fluid flow, such as immediately following a baffle, the epoxy coating is often deteriorated. These areas may be considered “hydraulic shadows.”

Releasing a dissolved gas and its stored energy provides a powerful scouring effect on the epoxy and/or metal surfaces. This energy level is sufficient to remove the epoxy but not enough to significantly damage metal surfaces. However the bacterial slime coating found elsewhere in a reactor, even adjacent to the shadow, is removed as evidenced by the formation of a light rust coating on the metal surface.

Similarly when the test membrane was installed in the Y branch of a vertical shaft reactor described below, there was an air line, which was in close proximity to one corner of the membrane. The air line did not touch the membrane but acted as a baffle and caused a downstream “hydraulic shadow” over about 10-15% of the surface area at one corner and on one side of the membrane. In this “hydraulic shadow”, the membrane had begun to delaminate slightly. The membrane is made of non-woven polyolefin strands, perhaps 10-20 microns in diameter, compressed and sintered together by some means, probably heat and pressure. Under the microscope were hair-like whiskers, approximately ⅛ inch long, protruding perpendicularly to the surface. These whiskers were found on the membrane only on one side, and only in the proximity, of the air line. It is likely that the abrupt change in flow causes the dissolved gas to nucleate and to erode/wear the polymeric surface. Cavitation may be occurring because the whiskers are protruding outward and appears to have been lifted from the surface. The remainder of the membrane was unaffected by the high levels of dissolved gas and had no evidence of surface deterioration when examined under the microscope.

The amount of dissolved gas is surprising. As an example, the solubility of air in water is about 21 mg/L at one atmosphere of pressure. A 500 ft. deep vertical shaft reactor could theoretically dissolve 287 mg/L of air. Assuming a dissolving efficiency of 70% and a recovery efficiency of 70%, there would be about 140 mg/L of air in the liquid in the head tank of the reactor. Since 1 ml of air weighs 1.29 mg, this translates to about 10% by volume of the liquid would be derived from dissolved gas. This represents substantially more dissolved (stored) bubble volume than the dispersed bubble volume used to circulate the contents of the vertical bioreactor. Surprisingly it is more dissolved bubble volume than the dispersed bubble volume (4-6%) required to circulate either a Kubota or Zenon membrane reactor. Furthermore this stored bubble volume represents considerable stored energy.

It is predicted that by releasing this stored energy at the critical time and controlled rate across the membrane surface a very powerful cleaning action can be created. In fact, there is enough energy stored in this manner to delaminate/cavitate the membrane if released in an uncontrolled way, such as can occur in the proximity of the air line. This phenomenon now explains observations of failed rubber down corners.

The total dissolved air may be calculated quite accurately in the liquid in a vertical reactor by using a dissolved oxygen probe. Under no load conditions, i.e., no BOD load, the total dissolved air is about 2.61 times the dissolved oxygen reading. Under load, the oxygen readings are reduced but the oxygen consumption can be calculated from the BOD values. At the time of this study, the vertical bioreactor was operating under a typical diurnal organic load patterns. Note that when the riser air is maintained at substantially a constant value (55-65 scfm) the dissolved oxygen values increase by a factor of nearly two when only 43 scfm of down corner air is applied. This indicates that the down corner air is mainly responsible for dissolved gas while the riser air is mainly responsible for dispersed. More importantly, the dissolved oxygen level in the permeate (even though reduced 50-60% by the BOD reaction) reaches supersaturated values (nitrogen gas and carbon dioxide gas would therefore be even higher) proving that supersaturated gasses in the liquid easily pass easily through the membrane. As an example, if the residual dissolved oxygen in the permeate is 10 mg/L and 50% of the oxygen was consumed in the reaction, then the starting value would have been at least 20 mg/L. Therefore the starting dissolved air would then be 2.6×20=52 mg/L and the nitrogen fraction would be 32 mg/L. This is conservatively, the amount of dissolved gas going through the membrane. Remember that some of the dissolved gas, perhaps half, is also precipitating on the outside of the membrane.

In consideration of the magnitude of the observed scouring effect of uncontrolled gas nucleation on polymeric surfaces, the flow redistribution device located between each level of membranes has been redesigned within the present invention. The new design consists of a series of adjustable and/or removable baffles, which will create low level but controlled “hydraulic shadow” effect across the membrane. This controlled effect is similar to, but much less intense than, the one inadvertently created/discovered in the proximity of the air line.

The importance of this discovery is that, where it was thought this type of vertical aeration reactor could supply only a fraction of the air required to operate the membrane; there is actually more than enough air in the “stored energy” form (i.e., dissolved). It is now possible to get the stored gas out of solution in the right amount and at the critical location to achieve the novel objects and advantages disclosed herein.

Thus, the invention provides for the employment of supersaturated dissolved gasses in fluid processing methods and devices to clean surfaces that the subject fluids contact. Various observations that validate these results include:

a) Polymeric surfaces submerged in liquid flowing at wide range of velocities from about 0.1 to 4.0 feet/sec. do not experience a build up of biomass in the presence about 20-30 Mg/L of dissolved gas and/or about 30-50 Mg/L or colloidal gasses in the liquid.

b) Non polymeric surfaces, (bare metal exposed by damage to polymeric coating) submerged in liquid flowing at wide range of velocities from about 0.1 to 4.0 feet/sec. do experience a build up of biomass even when there is about 20-30 Mg/L of dissolved gas and/or about 30-50 Mg/L of colloidal gasses present in the liquid.

c) Biomass build up is experienced in the absence of dissolved gasses even at relatively high liquid velocities of 3-4 feet/sec.

d) Biomass build up can occur on metallic (steel) surfaces at flow velocities up to about 4 feet/sec. This biomass contains phospholipids that protect the metal by bio-passivation.

e) Flow velocities over about 10-feet/sec and in the presence of large amounts of air (over about 100 mg/L) prevent the build up of biomass and the build up of the corrosion inhibiting phospholipids. As a result, metal corrosion and metal erosion occur.

f) Non-permeable polymeric membranes can delaminate if the pores do not go right through the wall.

g) The high airflow rates suggested by membrane manufacturers are not necessary for efficient operation of submerged membranes in a presence of supersaturated dissolved gases. Kubota, a leading membrane manufacturer, states in its literature on membranes used for solid-liquid separation of mixed liquor that a thin film biomass is allowed to form on the surface of the membrane to increase its effectiveness in removing small particles. At a flux rate of about 0.5 gal/hr/sq. feet the time between cleaning membranes is about 6 months. A minimum air rate of about 40 scfm/1000 sq. feet is required and a minimum cross-flow liquid velocity of about 1 feet/sec is required. Zenon membranes operate at a nearly double the flux rate of the Kubota membranes, but provision is made for pulse reverse flow cleaning. In one mode of operation a ten-second pulse is applied for every ten minutes of operation. Zenon also use a mechanically-applied vacuum to draw on the membrane. Overall, the Zenon technology requires a lower air rate to stimulate and clean the membrane than the Kubota membrane.

The airflow rates suggested by these two leading membrane manufacturers is 8 to 10 times higher than the airflow rate typically available in improved long vertical shaft bioreactors. Both Kubota and Zenon have designed their membranes to operate in relatively shallow basins. The improved long vertical shaft bioreactor is configured on a vertical axis, and allows membranes to be stacked 2-5 units high and still maintain enough driving head in the reactor to circulate the system. In shallow tanks the driving head that causes air/liquid circulation through the membranes amounts to a few inches at best. In an improved long vertical shaft bioreactor plant, the driving head might be 10-12 feet. A re-distribution header is located between each deck of membranes thus allowing the same air to be used 4-5 times. By stacking membranes, the superficial cross-flow (actually up-flow) liquid velocity across the membrane increases as the cross-sectional (footprint) area decreases. Although not optimized, a first trial design of a 0.25 MGD improved long vertical shaft bioreactors plant incorporating membrane bioreactor technology indicates it would supply about half the air and about ⅓ liquid flow velocities recommended by the membrane manufacturers. For the reasons stated above and the evidence gathered, the dissolved air fraction in the liquid flow is a far more important factor in keeping the membranes clean than either the air rate or the liquid rate. Over-design is to be avoided because it is possible to clean the membranes too well and destroy the required thin bio-film. The scouring action can be adjusted by using fewer decks of membranes or less air. Conversely, one can always add air and more decks if more velocity and/or scouring are needed.

h) Dissolved salts and particles smaller than 0.04 microns pass through microfiltration membranes and therefore there is no reason to suspect that dissolved gasses will not pass through. The dissolved gasses that do pass through the membrane may help in keeping the inside of the membrane clean.

i) The membranes can be cleaned with bleach and therefore the material that is blocking the pores is probably mostly organic.

j) Typically membrane reactors need fine screening of the raw influent because the plant may be dealing with whole raw sewage.

The foregoing findings and conclusions were further validated by installing membrane bioreactors in a deep shaft vertical reactor at Virden, Manitoba, Canada, beginning in August of 2003. The Virden Reactor was the first commercial deep shaft vertical reactor installed in North America in 1978. The treatment plant was started up in 1980, and has been in continuous service since then. The plant is one of the older deep shaft designs where both down corner and riser air is used in the circulation and aeration of the shaft contents. The reactor is 30″ in diameter and 500′ deep. The down corner is 18″ in diameter and the riser is formed by the annular space between the casing wall and the down corner. At the top of the reactor there is a Y branch to allow the mixed liquor to transfer from the riser to the down corner via a head tank. The head tank is approximately 25 feet long, 6 feet wide and 4.5 feet deep. The configuration of this reactor is ideal for tests since it allows the ratio of dissolved to dispersed air to be selectively changed. Applying more down corner air results in more dissolved air while applying more riser air results in more dispersed (bubbles) air. As shown later, the ratio of dissolved to dispersed air makes up to a nine-fold difference in membrane flow rates at the same hydraulic head.

In order to install membrane bioreactors in the Virden reactor, it was necessary to cut an access-way into the top of the head tank. The access-way is located directly over the 21″ ID Y branch. When the head tank was opened after 23 years of continuous operation, the same pattern of bio-fouling was discovered on the epoxy coating as found in another long vertical shaft bioreactor opened after 22 years of operation. The patterns were almost identical. In each case, the floor of the head tank, where both the liquid velocity and the bubble content is the lowest, had a minimum of attached biomass. This is contrary to the teaching of the membrane manufacturers, who recommend a much higher velocity and higher bubble content. However it should be noted that although there would be few, if any, bubbles on the floor, the fluid would be supersaturated with dissolved gas. The conclusion that it is the dissolved gas nucleating on the polymeric surface that reduces bio-fouling is further supported by this observation. The fact that the shaft of the other examined bioreactor was used for treating high strength warm industrial waste, while the Virden shaft was treating cold low strength municipal wastewater, appears to have little influence on this phenomenon.

A test membrane solid/liquid separator was installed in the Virden deep shaft reactor for one month to assess improvements in through-put and operating life of the submerged membrane assemblies of the invention. The test membrane was removed from the reactor and carefully examined. Notably, the membranes were clean, and any matter on the exterior surface easily washed off in water despite having been operated in a thick concentration of sticky mixed liquor for a month. Additionally, it was observed that different air rates in the reactor produced different effluent water flow rates from the membrane. When down corner air was increased, (more dissolved air in circulation), the reactor circulation flow rate decreased, but the flow through the membrane increases. Conversely, when more riser air was applied (more dispersed air) the circulation velocity in the reactor increased but flow out of the membrane decreases. This is contrary to conventional understanding of membrane function and operation, as evinced by operation instructions of membrane manufacturers. In conventional membrane plants, a high aeration rate is required to maintain circulation velocity across the membrane. Typically a conventional plant would use (as a minimum) about 2 times the trans-membrane velocity and 8-10 times the airflow that is available in a deep shaft type reactor.

In additional studies to clarify the disclosure herein, the test bioreactor was fitted with a sample port in the head tank located close to the outlet of the membrane. Dissolved gas concentrations across the membrane were measured with a dissolved oxygen meter (DO meter) and reactor circulation velocities across the membrane are calculated from the time to circulate tracers such as soap. Permeate flow out of the membrane was measured in a calibrated flask, and the hydraulic head is maintained by an overflow to the flotation tanks. In this test case, the head over the membrane was maintained at 1 foot. A drop leg was provided to cause a siphon effect of one meter, a typical operating value for this type of membrane. The membrane support frame can hold a lower membrane submerged between, about 6-9 feet, and an upper membrane submerged between about 1-4 feet. The overflow heights are the same for both membrane locations.

The following Tables 2 and 3 shows the effect of various air rates on the membrane performance:

TABLE 2

| | | Riser Air | Down Comer | | Flow | MLSS | Membrane Effluent |
|---|---|---|---|---|---|---|---|
| Date | | scfm | Air scfm | Total Air | ml/min | mg/L | D.O. mg/L |
| Aug-26 | 3:00 PM | 65 | 43 | 108 | 440 | 9347 | |
| Aug-27 | 8:00 AM | 65 | 0 | 65 | 310 | 7058 | |
| Aug-27 | 2:00 PM | 65 | 43 | 108 | 450 | 7058 | 10 |
| Aug-27 | 9:00 PM | 65 | 43 | 108 | 450 | 7058 | |
| Aug-28 | 7:00 AM | 65 | 43 | 108 | 425 | 6027 | |
| Aug-28 | 8:00 AM | 65 | 0 | 55 | 310 | 6027 | 5.4 |
| Aug-28 | 10:00 AM | 65 | 43 | 108 | 412 | 6027 | 8.8 |
| Sep-22 | Before | 75 | 0 | 75 | 180 | 10226 | |
| | Inspection | | | | | | |
| Sep-23 | After | 75 | 55 | 130 | 500 | 7800 | |
| | Inspection | | | | | | |
| Sep-24 | After | 108 | 0 | 108 | <50 | 9200 | |
| | Inspection | | | | | | |

TABLE 3

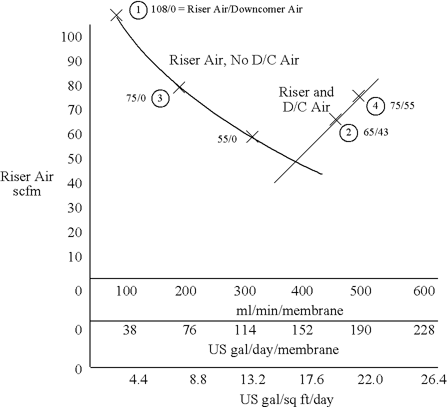

Table 3 is a plot of data points of Table 2. The data of Table 2 do not reflect the importance of the dissolved air fraction. However, the effect of varying the air rates was noted and the information provided in Tables 2 and 3. There are two data sets that illustrate the importance of the down corner air (dissolved air). Point 1 and point 2 have the same total volume of air applied (108 scfm). Point 1 has 108 scfin in the riser (mostly dispersed) and no down corner air (i.e. no dissolved air). Remember that the conventional teaching says that high velocity and high air rates yield highest flow rates in the membrane. However, in the trial run, (point 1), the highest air rate and the highest circulation rate yields the lowest flow rate out of the membrane.

At point 2, there is a total air rate of 108 scfin but this time, 43 scfm is applied to the down corner. The effect of down corner air is to slow the circulation velocity. Conventional teaching predicts that the flow out of the membrane would also slow but in the trial run the flow out of the membrane increased nine fold.

Further, at points 3 and 4, both points have 75 scfm of air in the riser but point 4 has 55 scfm in the down corner that serves to slow the circulation velocity. The output from the membrane increases three fold.

Therefore, the dissolved air fraction in the wastewater has a dominant effect on the throughput of the membrane. Other factors will also influence the performance of the membrane. Among these factors are the concentrations of biomass, the sludge age, the biological health of the sludge, the amount of exo-cellular polymer present, the condition of the membrane, etc. These factors are expected to have a minor impact on overall results since most of the results are from one-day's operation during which sludge conditions are not predicted to change much during the subject period.

One important cause of increased membrane through-put within the present invention relates to gas dynamics of vertical bioreactors. In particular, deep shaft reactor systems provide significant advantages over other bioreactors and fluid treatment apparatus by providing a high dissolved air fraction. In addition, they involve distinct biochemical and physicochemical processes, for example oxidation of organic carbon, and dissolution of oxygen and other gases that result in supersaturated levels of desired gases, e.g., carbon dioxide.

In fluid dynamics, the term “rheology” describes a complex, non-linear relationship between fluid deformation and stress occurring in fluid flow patterns. The increased throughput phenomenon is believed related to a change in rheology on a membrane surface. Because of high amounts of dissolved gas in the fluid, the rheology of both the biomass (solids containing fluid and gas) and the fluid media change on contact with the membrane, perhaps making the membrane more permeable.

The test membrane was fitted with clear vinyl tubing, which allowed visual observation of the permeate stream. The permeate stream contained a significant amount of bubbles, perhaps 1/16 to ⅛ inch in diameter. It is estimated that as much as 10-15% of the permeate flow is made up of discrete bubbles. It is believed that the dissolved gas passes through the membrane unimpeded and then nucleates at or near the membrane surface, which may include nucleation between the surfaces, at the membrane surface, or within a fluid proximate to the membrane surface, and causes an air-lift effect proximate to the membrane surface. It is reasonably expected that discrete bubbles will not pass at high levels through a semi-permeable membrane. Unless there is dissolved air present in the water passing through the membrane, (or alternatively air bubbled into the clean water side of the membrane) no air-lift can be expected on the permeate side of the test membrane. This air-lift caused by the bubbles has a significant pumping effect because during the installation of the permeate line, permeate flow from the membrane can be raised almost to the surface of the liquid level in the head tank. Since the liquid being filtered located outside the membrane contains about 9% air voidage, the nucleating gas volume inside the membrane would be likewise be about 9% gas voidage in order for liquid to flow out of the membrane at similar interior and exterior hydraulic heads. It is apparent that the dissolved gas fraction helps keep the membrane outside surface clean and therefore, the dissolved gas fraction inside the membrane will also help keep the inside of the membrane clean.

In a conventional membrane application, the water inside the membrane (on the permeate side) contains very little air and is much more dense than the water outside the membrane which contains the air required for scouring. Therefore, in conventional systems the water will not flow out of the membrane unless a slight vacuum is applied to the effluent side (Zenon uses a vacuum pump) or the influent is pressurized (Kubota uses compressed air). When a vacuum is applied, water tends to flow preferentially through the pores closest to the top of the membrane. When pressure is applied with compressed air, the resulting head is the sum of the heads due to density difference between the water inside and outside the membrane plus the head required to cause flow through the pores plus any hydraulic losses due to fluid motion. In the improved long vertical shaft bioreactors system, the head due to density differences is largely eliminated and potentially enough dissolved gas could enter the membrane to cause enough air-lift to overcome the head loss through the pores as well.

FIGS. 14-1 through 14-7 illustrate several aspects of a submerged permeable membrane assembly 400 for membrane separation according to the invention. In this exemplary embodiment, the membrane assembly is a “U-shaped” assembly, while it will be appreciated that various alternative designs and configurations of the assembly can be constructed and operated according to the disclosure herein. As illustrated in FIG. 14-1 (a cross-sectional view along a vertical axis 402 of the submerged membrane assembly), the exemplary membrane assembly includes a “U-shaped” container 405 that is 6 feet tall and has a first fluid compartment 420 and a second fluid compartment 430. Also in this exemplary embodiment, the compartments are separated by a separator member 414 and a membrane 410 that is 3 feet high and installed at the bottom of the “U” where the two fluid compartments connect. The membrane 410 has a first surface 411, a second surface 412, and a vertical axis 402. The first fluid compartment 420 is configured to contain a first fluid 424 in fluid communication with the first surface 411 of the membrane 410. The second fluid compartment 430 is configured to contain a second fluid 434 in fluid communication with the second surface 412 of the membrane 410. The first fluid 424 has a first specific gravity, or density, and the second fluid 434 has a second specific gravity.

The membrane 410 schematically represented in FIGS. 14-1 through 4-7 may be any membrane structure, including plate and frame, tubular, hollow fiber, and spiral wound. The membrane may be any selective, semi-permeable, microporous, or other partitioning membrane for processing, refining, and/or treating liquid compositions, for example membrane waste-water purification processes and apparatus. The membrane may be made from any material, and may include one or more selected from cellulose acetate, polyvinyl chloride, polysulfones, polycarbonates, and polyacrylonitriles. The membrane 410 is generally permeable by molecules of less than a predetermined size, and includes pores 415 between the surfaces 411 and 412 having a pore size permitting movement of molecules smaller than a removal size between the first and second surfaces 411, 412 and rejecting movement of larger molecules. The particle removal size for semi-permeable membranes used in membrane bioreactor applications typically range between 10.0 and 0.05 microns. While a particle removal size may be selected in conjunction with other parameters relevant to a particular use of the membrane, in a certain embodiment a semi-permeable membrane having a particle removal size in a range of between approximately 0.05 to 0.1 microns generally produced good results filtering wastewater. This range removes most viruses, most long-chain molecules (macromolecules), and all bacteria. In another embodiment, a membrane that substantially removes particles larger than 0.1 microns is generally expected to produce satisfactory results filtering wastewater.

FIGS. 14-1 through 14-7 also illustrate the fluids 420 and 430 being contained at various vertical column heights in the assembly 400. The exemplary, “U-shaped” assembly has a maximum column height of six feet, and the Figures include other illustrative dimensions of the vertical column height from zero to six feet along the vertical axis 402, with zero feet starting at the maximum height of the assembly 400, and six feet at the maximum depth of the membrane 410. In FIG. 14-1, the first fluid compartment 420 contains the first fluid 424 at a first column height 422 of six feet. Also, the second fluid compartment 430 contains the second fluid 434 at a second column height 432 of six feet.

As further illustrated in FIGS. 14-1 through 14-7, the vertical axis 402 of the membrane 410 is typically aligned with a corresponding first chamber vertical axis 423 and a second chamber vertical axis 433. Generally, the first chamber vertical axis 423 and second chamber vertical axis are approximately parallel and correspond to an effective vertical gravitational axis that is roughly coincident with a direction of bubble rise in the first and/or second chambers. Typically, the direction of bubble rise is vertical within the first and second chambers. When the membrane is oriented vertically, the membrane vertical axis is roughly parallel to the first chamber vertical axis 423 and second chamber vertical axis. However, in certain embodiments the membrane may not be oriented vertically, for example it may be positioned with the first and second surfaces tilted relative to the direction of gas bubble rise and vertical axes of the first and second chambers. In these embodiments, the membrane vertical axis 402 is not parallel to the first and second membrane surfaces, and instead corresponds to the direction of bubble rise in the first and/or second chambers.

As illustrated in FIG. 14-1, the first fluid compartment 420 contains the first fluid 424 for filtration, such as dirty water, wastewater, or sewage to be filtered, and the second fluid compartment 430 contains the second fluid 434 as filtrate, such as clean water, recyclable water, or permeate. The submerged membrane assembly 400 is illustrated with the first fluid 424 illustrated as dirty water, and the second fluid 434 illustrated as clean water. Both fluids (420, 430) have a specific gravity of one. In FIG. 14-1, neither the second fluid 434 in the second fluid compartment 430 nor the first fluid 424 in first fluid compartment 420 have any air or bubbles present. It can be easily calculated that the pressure at the surface of each fluid (“0” fluid column height) is 0 psig, the pressure at 3′ depth is 1.298 psig, and the pressure at 6′ is 2.597 psig. At any particular depth on the membrane there is equal pressure on each side of the membrane. Pressure at any depth in a liquid column is the average density times the height of the column. For example, the density of water is 62.4 #/cu. feet. A column of 6 feet of water would have a pressure of 6×62.4=374.4 #/sq. feet or 2.6 #/sq in. Gauge pressure does not take into account atmospheric pressure so the pressure at the bottom of a column of water in this case would be approximately 2.6 psig.

As illustrated in FIG. 14-2, gas in the form of air bubbles 426 is present in the first fluid 424 contained in the first fluid compartment 420. The air bubbles 426 may be added to scour and clean the first membrane surface 411. In a typical conventional membrane installation, the amount of air bubbles 426 present in the first fluid 424 (dirty water) to adequately scour the first surface 411 of the membrane 410 reduces the specific gravity of the first fluid 424 from 1.0 to about 0.9. Again, it can be calculated that the pressures at the top of the assembly 400 is 0 psig. The pressure on the second membrane surface 412 (the clean water side) at the top of the membrane 410, i.e., at the three-foot elevation on the column height, is 1.298 psig, and the pressure on the first membrane surface 411 (the dirty water side) is 1.168 psig. Similarly, the pressure on the second membrane surface 412 (the clean water side) at the bottom of the membrane 410, i.e., at the six-foot elevation on the column height, is 2.597 psig, and on the pressure on the first membrane surface 411 (the dirty water side) is 2.337 psig. In this static water test, the second fluid 434 (clean water) will try to flow through the membrane 410 into first fluid 424 (dirty-water) of the membrane 410 because of the reverse pressure differential. Also note that the pressure differential across the top of the membrane 410 is 0.13 psig while the pressure differential across the bottom of the membrane is 0.26 psig. Not only will water try to flow in the wrong direction, but more water will flow across the membrane at the bottom than at the top.

FIG. 14-3 shows that, if the second column height 432, or liquid level, on the second fluid 434 contained in the second fluid compartment 430 (clean water) is reduced by 0.62 feet with respect to the first column height 422, then the pressure on both the second membrane surface 412 (clean water side) and on the first membrane surface 411 (dirty water side) at the bottom, i.e., six-foot elevation of the column height, will be equal at 2.337 psig. Note however that the pressure on the second membrane surface 412 (the clean water side) at the top of the membrane 410, i.e., at the three-foot elevation on the column height, is 1.03 psig, while the pressure on the first membrane surface 411 (the dirty water side) is 1.168 psig. This creates a pressure differential of 0.13 psig at the three-foot elevation. Under the above-described conditions, fluid will flow the correct way, from the first membrane surface 411 (dirty water side) of the membrane 410 to the second membrane surface 412 (clean water side). Since the pressure differential at the bottom of the of the membrane 410 is 0.0, no water will flow either way, but at the top of the membrane the water will flow from the dirty water side (430) of the membrane 410 to the clean water side (420). As a point of interest, if the second fluid column height 432 is reduced by 0.4 feet water will flow the correct way at the top of the membrane 410 and the wrong way at the bottom of the membrane. The second fluid column height 432 may be varied with respect to the first fluid column height 422 by any suitable method, device, or means, including providing an outlet or overflow for the second fluid 434 at a selected elevation, applying a vacuum to the second fluid 434, and/or applying a pressure to the first fluid 424.

FIG. 14-4 illustrates a pressure differential across the membrane 410 resulting from a change in the specific gravity of the second fluid 434 of the membrane assembly 400 of FIG. 14-3, according to an embodiment of the invention. In FIG. 14-4, a gas, in the form of air bubbles 426, is present in the first fluid 424 (dirty water) contained in the first fluid compartment 420 and forms aerated water. Sufficient air bubbles 436 may be added to the second fluid 434 (clean-water) contained in the second fluid compartment 430 to change or adjust the specific gravity of the second fluid to more closely approximate the first specific gravity of the first fluid 424 contained in the first compartment 420. This reduces the second specific gravity of the second fluid 434 to the first specific gravity of the first fluid 424. As in FIG. 14-1, the pressures with respect the membrane 410 at various depths along a column height can be calculated. The pressures will be 90% of the pressures in FIG. 14-1 because, in this case, the aerated water (434) specific gravity is 90% of unaerated water specific gravity. Note that the pressure differential across the membrane 410 at all elevations is zero. In addition to creation of an equalized pressure differential along a vertical axis of the submerged permeable membrane 410, the presence of rising bubbles of the air 436 proximate to the second surface 412 (clean water or permeate side) of the permeable membrane imparts a scouring action on the second surface of the membrane 412, according to an embodiment of the invention.

FIG. 14-5 illustrates a submerged membrane assembly 401 having a selected differential hydraulic head 452 imposed between the first fluid 424 contained in the first fluid compartment 420 and the second fluid 434 contained in the second fluid compartment 430, according to an embodiment of the invention. Alternative embodiments for imposing the differential hydraulic head are described below. If the specific gravity of the second fluid 434 is adjusted to more closely approximate the specific gravity of the first fluid 424, and a selected differential hydraulic head 452 is imposed between the first fluid 424 and the second fluid 434, a selected pressure differential across the membrane 410 results along the vertical axis of the membrane 410. As illustrated in FIG. 14-5, the second specific gravity is adjusted to equal the first specific gravity, and a 2.0-foot differential head 452 is additionally imposed between the first fluid 424 and the second fluid 434. As before, the pressures at the top and bottom of the membrane 410 can be calculated. The pressure differential across the membrane 410 is uniform (0.779 psig) along its vertical axis, from top to bottom. Now, each pore on the membrane 410 sees approximately the same driving pressure, and each pore will transmit about the same amount of water. Using the entire membrane surface and every pore equally, the membrane assembly 401 typically produces more flow than the membrane assemblies having unequal pressure differentials of FIG. 14-3 and FIG. 14-6 for example. If the adjusted or changed second specific gravity does not closely equal the first specific gravity, the selected pressure differential across the membrane is expected to vary only a minor degree along the vertical axis of the membrane. For example, variation of the pressure differential along the vertical axis is expected to be generally uniform, i.e., not vary more than +/−30% per vertical linear foot, when the second specific gravity is adjusted to within approximately +/−5 percent of the first specific gravity.

In the embodiment illustrated in FIG. 14-5, the differential hydraulic head 452 is imposed by selecting the second fluid column height 432 with respect to the fist fluid column height 422 to produce a selected pressure differential across the membrane 410 along the vertical axis at the first specific gravity and the adjusted or changed second specific gravity. FIG. 14-5 illustrates a selected second column height 432 of 4.0 feet and a first column height 422 of 6.0 feet producing a selected differential hydraulic head 452 of 2.0 feet. As described in conjunction with FIG. 14-4, the second fluid column height 432 may be varied with respect to the first fluid column height 422 by any suitable method, device, or means, including providing an outlet or overflow for the second fluid 434 at a selected elevation, applying a vacuum to the second fluid 434, and/or applying a pressure to the first fluid 424. In an embodiment using gravity, the column heights 422 and 432 may be established by providing fluid outlets or overflows from the fist fluid compartment 420 at 6.0 feet and from second fluid compartment 430 at 4.0 feet.

In an alternative embodiment, the differential hydraulic head 452 can be imposed by enclosing the first fluid compartment 420 and applying a pressure, such as by compressed air generated by a mechanical compressor, thus increasing the first column height 422 without physically increasing the vertical dimension of the first fluid compartment. In another alternative embodiment, the differential hydraulic head 452 can imposed by applying a vacuum, such as generated by a mechanical vacuum pump, to the second fluid compartment 430, thus decreasing the second column height 432 without physically decreasing the vertical dimension of the second fluid compartment. Using gravity solely to impose the differential hydraulic head 452 may be considered preferable because gravity does not require any mechanical devices that consume power and require maintenance, such as pumps. In addition, using gravity solely eliminates any problems associated with maintaining an enclosed fluid compartment.

Additional features of the embodiment illustrated in FIG. 14-5 include flowing the first fluid 424 past the first surface 411 of the membrane 410 while maintaining the first column height 422. This embodiment also allows the second fluid 434 to be collected from the second fluid compartment 430 as filtered, clear, or clean water while still maintaining the selected second column height 432 to impose the differential hydraulic head 452.

FIG. 14-6 illustrates a comparison of how existing Zenon and Kubota membranes typically react with the 2.0-foot differential hydraulic head 452 imposed as illustrated in FIG. 14-5. The existing apparatus and methods for operating these membranes do not change or adjust the specific gravity of the second fluid 434 to closely approximate the specific gravity of the first fluid 424. Simply imposing the differential hydraulic head 452 across the membrane 410 does not achieve a generally uniform pressure differential across the membrane along the vertical axis. It only results in a pressure differential that is considerably higher at the top of the membrane than at the bottom. In other words, the pressure differential varies along the vertical axis of the membrane.

This description will next address embodiments for changing or adjusting the second specific gravity by including diffused gas or air bubbles 436 in the second fluid 434 as previously described in conjunction with FIG. 14-5. As described in conjunction with FIG. 14-5, an aspect of the invention includes changing and/or adjusting the second specific gravity to more closely approximate the first specific gravity in value. In a certain embodiment, the second specific gravity is adjusted to within approximately +/−5 percent of the first specific gravity. In another embodiment, the second specific gravity is adjusted to within approximately +/−2.5 percent of the first specific gravity.

FIGS. 14-5 and 14-7 illustrate alternative embodiments of the invention for including bubbles 436 in the second fluid 434 to change the second specific gravity, and optionally to impart a scouring action to the second surface 412 of the membrane 410. In an embodiment illustrated in FIG. 14-5, the bubbles 436 are sourced from supersaturated dissolved gases present in the first fluid 424. As previously described, long shaft vertical reactors receive at their head tank substantial concentrations of fluid having supersaturated dissolved gases. If the fluid 424 is such a fluid having a substantial concentration of supersaturated dissolved gases, a portion of the supersaturated dissolved gas will nucleate on the first surface 411 of the membrane 410. This nucleated gas will impart a scouring action on the first surface 411 as the nucleated bubbles rise in the fluid 424. Another portion of the supersaturated dissolved gases of the fluid 424 permeate the membrane 410 by passing from the first surface 411 through the pores of the membrane and emerging on or proximate to the second surface 412 and in the second fluid 434. A portion of this passed-through supersaturated dissolved gas will nucleate and form gas bubbles 436, thus adding diffused gas to the second fluid 434. The mechanism by which the supersaturated dissolved gas nucleates in the second fluid 434 is not fully understood. The nucleation may be caused in whole or in part by a mechanical action of the dissolved gas passing through the membrane 410. Alternatively, the nucleation may be caused in whole or in part by the pressure differential between the first fluid 424 in the first compartment 420 and the second fluid 434 in the second fluid compartment 430 imposed by the differential hydraulic head 452. Also alternatively, the nucleation may be caused by a difference in dissolved gas levels between the first fluid 424 and the second fluid 434. The nucleation may be on the second surface 412, within the second fluid 434, within the second fluid 434 proximate to the second surface 412, or within the membrane 410. The gas bubbles 436 nucleate on or proximate to the second surface 412, and impart a scouring and/or cleaning action on the second surface as they rise in the second fluid 434.

FIG. 14-7 illustrates a submerged membrane assembly 402 with differential hydraulic head 452 and gas inlet 438, in accordance with an embodiment of the invention. The assembly is substantially similar to the membrane assembly 401 of FIG. 14-5, with an added optional inlet 438 coupled to the second fluid compartment 430. The optional inlet 438 includes configuration for adding air or gas into the second fluid compartment 430, and forming bubbles 436 in the second fluid 434. The air may be added by providing air or a gas to the inlet 438, and diffusing the air or gas within the second fluid compartment 430. A diffusing device may be included with the inlet 438 to assist bubble formation within the second fluid compartment. Alternatively, the air or gas may be first diffused in another liquid, which is then flowed through the inlet 438 into the second fluid compartment 430 and added to the second liquid 434 in sufficient quantities to adjust the second specific gravity to closely approximate the first specific gravity, and optimally, equalize the first and second specific gravities. In a further alternative embodiment, the bubbles 436 of air or gas may be proved by other sources, such as a chemical reaction, an ultrasonic device, and a microwave device.

The Zenon and Kubota submerged membrane processes of FIG. 14-6 can be improved by adding air or gas to the second fluid compartment 430 (clean water side) of the membrane 410 using the submerged membrane assembly 402 with the gas inlet 438 as illustrated in FIG. 14-7. While adding a gas directly to the second fluid compartment 430 of the Zenon and Kubota processes comprises an improvement to those processes, it is not expected to produce a similar degree of scouring of the second membrane surface 412 in the clean water side to that produced by bubble nucleation on the second surface resulting from a supersaturated mixed liquor media as is present in long vertical shaft bioreactors.

FIGS. 15 and 16 illustrate an improved long vertical shaft bioreactor 500 for treatment of waste waters having a membrane bioreactor head 503 that includes plurality of submerged membrane bioreactor assemblies 510, according to an embodiment of the invention. The long vertical shaft bioreactor may be any type of long vertical shaft bioreactor that has substantial concentrations of supersaturated dissolved gas at the head tank 502 level, such as the bioreactors of FIG. 5 or FIG. 8. FIG. 15 is a top perspective view of a bioreactor head tank 502, and a membrane bioreactor head 503 having plurality of saddle tanks 506A-D mounting the membrane bioreactor assemblies 510. FIG. 16A is a top view of saddle tank 506A of the membrane bioreactor head 503, illustrating the top membrane bioreactor assembly 510D that includes a plurality of flat plate semi-permeable membranes 511. FIG. 16B is a cross-sectional side view of the bioreactor head tank 502, and of the saddle tank 506A having a stack of four membrane bioreactor assemblies 510A-D positioned vertically above each other.

FIGS. 15 and 16 illustrate an embodiment of a membrane bioreactor head 503, having four stacks or columns of membrane bioreactor assemblies 510 arranged circumferentially around the outside of and in fluid communication with the head tank 502. In practice, eight saddle tanks typically would be used to entirely surround the periphery of the head tank 502 and maximize membrane filtration. In FIG. 15, each saddle tank 506 includes four tiers of submerged membrane assemblies 510A-D positioned vertically above each other. Each assembly 510 is approximately 4 feet high, for a total membrane bioreactor head 503 column height 424 of approximately 16 feet. If a membrane fails, it may be replaced by shutting down only one of the saddle tanks 506, thus allowing the reactor and the other seven saddle tanks to continue operation. The uppermost submerged membrane assembly 510D can be serviced from the top of the saddle tank 506, while the lower three submerged membrane assemblies 510A-C can be serviced through tip out (mail box like) drawers as illustrated in FIG. 15 for assembly 510A and in FIG. 16B for assembly 510C.

Each membrane bioreactor assembly 510 includes a plurality of flat plate semi-permeable membranes 511 coupled by a membrane output line 512 to an exterior manifold 514. The exterior manifold 514 is coupled by a collection line 516 to a collection trough 538. The plate membranes 511 may include a frame that supports two rectangular semi-permeable membranes having their second surfaces 412 facing each other and defining in cooperation with the frame an interior second fluid compartment 430 between. The first surfaces 411 of the semi-permeable membrane are exposed to a fluid surrounding the exterior of the membrane assembly 510. The collection line 516 may be made of any tubular member suitable for carrying permeate or fluid outputted by the plate membranes 511. The collection line 516 may be transparent or clear, allowing a user to visually inspect the bubble 436 content and clarity of the output from each individual plate membrane 511.

The collection lines 510A-C flows permeate upward into the collection trough 538 as illustrated in FIG. 16B. The collection line 510D is formed into a siphon that flows permeate from the membrane 511 downward, discharging into the trough 538. The first column height 422 is defined between the lowest point of the lowest membrane 511 and the level of the outflow 528 from the saddle tank 506. The second column height 432 is defined between the lowest point of the lowest membrane 511 and the level of the trough 538.

In an embodiment of the invention, each membrane assembly 510 includes 75 flat plate membranes. Using eight separate saddle tanks 506A-D and 506E-H (not shown) around a head tank 75 provides a total number of flat plate membrane bioreactors 511 in this configuration of 75/tier×4 tiers/saddle tank×8 tanks=2400 flat plate membranes. Experience with the plate membrane indicates that this arrangement would process about 0.3 MGD on average and 0.6 MGD at peak flow. The head tank 502 diameter in this embodiment is approximately 9 feet, and with the saddle tanks 506 makes the reactor about 13 feet in diameter.

In operation, the first fluid 424 as inflow 526 of effluent from the long vertical shaft bioreactor flows into the bottom of the saddle tank 506A from a long vertical shaft bioreactor (not shown). The first fluid 424 has a first specific gravity, and includes bubbles 426 and supersaturated dissolved air. The first fluid 424 rises through the saddle tank 506A past the column of submerged membrane bioreactor assemblies 510A-D, and becomes outflow 528 as it overflows the saddle tank at a 12 foot elevation. The outflow 528 returns to the long vertical shaft bioreactor for further processing or removal from the reactor. The individual flat plate membranes 511 filter the first fluid 424 as described in conjunction with FIGS. 14-1 through 14-7, and primarily as described in conjunction FIG. 14-5. The first fluid 424 has a first column height 422 of 16 feet between the bottom of the bottom flat plate membranes 511 and the out flow 528. The second fluid 434 has a second vertical column height 434 of 12 feet established by the collection trough 538 and the collection lines 516 leading into it. As a result, a differential hydraulic head 452 is imposed between the first fluid 424, the effluent, and the second fluid 434, the permeate or filtered water.

Furthermore, by nucleating the dissolved gas of the first fluid 424 in the second fluid 434 as described in conjunction with FIGS. 14-1 through 14-7, and creating a gas fraction on the second surface 411 (clean side) of the membranes (including the vertical conduits leading to the collector trough) equal to the gas fraction on the first surface 410 (dirty side) of the membrane, it is possible to maintain a generally uniform pressure differential along the vertical axis of each membrane 511 of each submerged membrane bioreactor assembly 510 at 1.168 psig. As in FIG. 14-5, the pressure differential at the top of each membrane 511 is the same as it is at the bottom and the pressure differential across the top tier of membranes 510D (which is under a siphon head) is exactly the same as the pressure differential across each of the other three tiers of membranes 510A-C. As a result, it is expected that each and every membrane in the saddle tank 506 will produce the same flow. The pressure differential of 1.168 psig is equivalent to about 33 inches of water.

In conventional systems, there is no gas nucleation in the second fluid 434, and therefore the difference in pressure differential between the top and the bottom on a 1 meter (40″) high membrane 511 is 40″×10%=4 inches of water. This may not appear significant, but it is enough to cause unequal flow through any particular membrane.

For peak flows, the pressure differentials across all the membranes 511 can be raised equally by simply increasing the height of the dirty water column, the first column height 422. Note that the air bubbles 426 are used four times as they travel from the bottom membrane assembly 510A to the top tier 510D.

In an alternative embodiment, the membrane bioreactor assemblies may be arranged within the head tank 502, and the saddle tanks 506A-H eliminated.

FIG. 17 illustrates a folded saddle tank system 550 that includes a first folded saddle tank 556A and a second folded saddle tank 556B that collectively carry the membrane assemblies 510A-C, according to an embodiment of the invention. In some cases, four vertical tiers of submerged membrane assembly's 510A-C, for example, as illustrated in FIGS. 15 and 16, may create a plant that is too high. In that case, a folded saddle tank, such as the folded saddle tank 556 can be used advantageously. In the configuration of FIG. 17, the membrane assemblies 510A-B are contained in a first saddle tank 556A, and the membrane assemblies 510C-D are contained in a second saddle tank 556B. The second saddle tank 556A includes an inlet 568 for fluid coupling the inflow 526 of effluent from a bioreactor (not shown). A fluid coupling member 558 couples the out flow 558 of the first saddle tank 556A into the second saddle tank 556B.

The second saddle tank 556B is open to the atmosphere, but the first saddle tank 556A is not. The second column height 432 exists in two segments across the folded saddle tank system 550, a fist portion 432A across the first saddle tank 556A, and a second portion 432B across the second saddle tank 556B. The first column height 422 is not shown in FIG. 17, but its effective dimension is from the out flow level 558 of the second saddle tank 556B at atmospheric pressure to the lowest point of a membrane plate of submerged bioreactor assembly 510A of the first saddle tank 556A. The system 550 includes two collection troughs 538A and 538B receiving permeate or clean water (532) from the submerged membrane bioreactor assemblies 510A-D of the first and second saddle tanks 556A and 556B respectively.

In operation, the folded saddle tank system 550 functions substantially similarly to the system 500 of FIGS. 15 and 16. Inflow 526 enters the first saddle tank 556A through inlet 568, and flows upward past the submerged membrane bioreactor assemblies 510A and 510B. The liquid overflow and pressurized off-gas 559 are piped through the fluid coupling member 558 into the bottom of the second saddle tank 556B, and flows upward past the submerged membrane bioreactor assemblies 510C and 510D. The hydraulic calculations are the same as for the four tier high arrangement. As before each membrane sees the same pressure differential top to bottom and from tier to tier. A generally uniform pressure differential of approximately 1.75 psig is created between the first and second surfaces 411, 412 of the membranes of the membrane assemblies The outside diameter of the head tank 502 (not shown) remains at 9 feet, but the overall outside diameter with the folded saddle tank system 550 increases to 18 feet. Again, the air bubbles 436 (not shown) are used four times as it passes through each of the four tiers of membranes 510.

FIG. 17 illustrates several pressure gages [P] 571 and valves 570 introduced for clarity and understanding. The pressure, in psig, at each gage location is shown next to the gage. There are no pressure gages or valves in an actual plant because when the valves are closed the dissolved air would come out of solution and change the density of the liquid in the membrane discharge lines. However for this illustration, assume that, at any moment in time under normal operation, the valves may be closed momentarily, resulting in the pressures shown on the gages. The selection of 1.75 psig is the nominal pressure exerted by 4 ft. of water, which is typical for this type of saddle tank design.

Note that all the gage pressures on the discharge lines from the membranes are equal. The pressure (head) in the discharge lines of the membranes in saddle tank 556A is due to the 3.5 psi of off-gas pressure (equivalent to 8 ft. of water) superimposed on the liquid in tank 556A. The pressure at the collection trough 538A is reduced by the 1.75 psi (4 feet of liquid standing in the discharge line of membranes 510B), and 3.5 psi (8 ft. of water) standing in the discharge line of membrane 510A.

Similarly, the discharge line from membrane 510C is under a hydraulic head of 1.75 psi (4 feet) and the discharge line from membrane 510D is under a siphon (vacuum) of 1.75 psi. Experience in the field shows that air bubbles are permitted in a siphon line provided the lines are sized properly to maintain adequate discharge flow velocities, generally of greater than 2 ft./sec.

To further elucidate various aspects of the invention, a bench test apparatus was constructed according to the teachings herein and was used to conduct a series of bench tests of membrane throughput under varying membrane conditions and levels of diffused gas in water. FIG. 18 illustrates results of a series of tests conducted on the bench test apparatus.

Field observations show that the membrane permeability increases with an increase in dissolved gas. For example, see Table 3 above where adding dissolved air resulted in a significant increase in the permeate throughput. Other field observations demonstrate a scouring effect that the pressurized gasses in the reactor liquor exert on membrane and other surfaces. In vertical shaft bioreactors, a significant cleaning action occurs at strategic locations within the reactor, which typically are locations where dissolved gasses come out of solution.

As noted above, the bench test apparatus was devised using a Kubota membrane of the same type used in field tests described in Table 3. These tests demonstrated that increasing the dissolved gas content by adding down corner air in the reactor liquor had a large effect on permeate flow. FIG. 18 shows the performance of a section of the Kubota membrane that had been previously used in a reactor for more than two months. A series of eight permeability tests were done over a period of a week on the Kubota membrane using the bench test apparatus. The test apparatus membrane section was approximately 1/130 of the area of both sides of a full size (½ m×1 m) Kubota membrane.

The test apparatus was configured like an aeration shaft with an outer casing of 3.488″ ID with a down corner of 1″ inside diameter. The liquid circulation was driven with a large aquarium air pump with two injection ports near the bottom of the down corner. The membrane was located in a machined recess at the bottom of the 3.5″ diameter tube and a removable bottom cover supports the membrane from movement in the downward direction. The bottom cover plate included a series of machined grooves dimensioned similarly to the grooves in the Kubota membrane. A piece of coarse felt blotter membrane, taken from the field trial membrane unit, is installed between the membrane and the permeate collection system. Membrane discharge tubes were installed both vertically upward and downward from lower surface of the membrane. Additionally, the lower tube can be used as a siphon or drain to remove permeates from the lower side of the membrane.

Permeability tests were conducted to measure the effect of dissolved gas on flow rates through the membrane. In order to do this the influence of air-lift effect in the membrane discharge line must be separated from the effect of increased flow due to degassing. As a result the membrane is oriented horizontally at the bottom of a Plexiglas tube 24″ tall and 3.5″ in diameter. The first tests used a membrane glued to the bottom of the cylinder. This test simply determined that gas saturated liquid would pass through the membrane but there was no provision for the effect of vacuum, the effect of the felt wicking layer under the membrane skin, or the effect of the permeate channeled collection system.

The test apparatus used a porous felt layer under the membrane and a channeled permeate collection system similar to the Kubota design. The area of the test membrane is 9.5 sq. in. or 1/130 of the area of both sides of the field test Kubota membrane. The membrane used in the field was (½ meter×1 meter) and had a rated surface area of 8.6 sq.ft. or 1238 sq.in.

In the field trials, only 1 foot of positive head was available. In order to get flows over 150 U.S. gal per membrane per day, a vacuum of up to 28″ was successively applied to the permeate side. Actually, the field unit will self prime the siphon by using only the 1 ft. of positive head. However, in the test apparatus, the ⅛ inch diameter clear vinyl discharge line from the membrane worked quite well when used as a siphon on test runs 1, 3, and 4 when there was little or no gas in the permeate. In fact, on run 3 the number and size of bubbles in the siphon could be visually estimated.

In the saddle tank design described above in conjunction with FIG. 15, the top tier of membranes operates under siphon flow. Test data was collected from the test apparatus data under negative head. Note that on run 5 (fresh soda water) there was enough dissolved gas transfer through the membrane to interrupt the operation of the siphon however using soda water about 12 hours old, (run 7) the siphon effect worked well again.

Air-lift circulation through a riser and down corner: Initially, it was thought that tap water and/or soda water would permeate the membrane over long periods of time without loss of throughput. This was not the case. When tap water is left standing in the test apparatus, the flow slows over time. When soda water is left to stand in the test apparatus there is virtually no deterioration in flow. However when an air-lift circulation was employed with tap water there was no noticeable deterioration in flow perhaps due to surface scouring of the membrane. The soda water product likely uses reverse osmosis water while the city water is sand filtered. Initially it was thought that there might be a measurable difference in the quality of water but that turned out to not be the case on run 8. Later it is shown that the gas nucleation effect on the downstream side of the membrane has the dominate effect on permeate flow.

Flow calibrated in micro-litres/min: The method employed to measure flow involved measuring the change in liquid height in a small diameter cylindrical catch tube and a stopwatch. This method is quite accurate with a high degree of repeatability (+/−25 micro litters.) as demonstrated by the good fit of the curves to the data points.

FIG. 18 plots the test run results. A first step was to establish. The first two runs were to establish permeate flow base line data similar to that observed in the field. Run 1 was on tap water and used the dirty membrane. The water was airlift circulated. Run 2 was done in the same way but using fresh soda water as the liquid. Air-lift circulation was not used in run 2 because it caused too much foam.

A second step was to clean the membrane according to field observations. Soda water was air circulated across the face of the membrane overnight. This simulated the bubble nucleation concept seen in the field.

A third step was to establish permeate base line flows on clean membranes. Run 3 used the stale soda water that had been aerated overnight. Run 4 used tap water.

A fourth step was to determine the effect of gas content (function of soda water “out of the bottle” age) on permeate flow compared to tap water. Run 5 was on 1 hour-old soda water. Run 6 was on tap water. Run 7 was on 12 hour-old soda water.

A fifth step was to approximate the gas content of the liquor in a typical bioreactor. Run 8 was on 50% tap water and 50% soda water. The soda water/tap water mixture was changed frequently to keep the age of the soda water to less than 30 minutes out “of the bottle.” In the field the CO2 in a long shaft vertical reactor is replenished every 6-10 minutes, so run 8 is conservative.

The plot of test run results in FIG. 18 illustrates several aspects of the invention. For the purpose of comparisons between runs, a 24″ hydraulic head is used as a common pressure.

1) Tap water with, air circulation, was run through a dirty membrane and at 24″ of head pressure and about 1050 micro liters per min of permeate was produced. There were no bubbles visible in the siphon line and a vacuum was easily maintained.

2) Fresh soda water was then processed on the same dirty membrane and about 1875 micro liters of permeate was produced or about a 78% gain in flow. This is approximately the same gain in performance as in the field trial when the bioreactor fluid was supersaturated with dissolved air, (i.e. down corner air was added). It is interesting to note that the soda water used was fresh, between 1 and 5 hours old, yet the degree of nucleation on the membrane was sufficient to preclude the use of a siphon from 24 to 32 inches of head. This was interpreted as proof that the dissolved gas permeates the membrane easily.

3) Soda water was then air circulated across the membrane face for a further 12 Hours. The permeate lines were blocked off so that the dissolved gas impinged on the membrane surface and very little, if any, fluid or gas transferred through. This simulates the conditions in the reactor where it is alleged that a polymeric surface can be effectively cleaned by bubble effervescence. The permeate discharge lines were then unplugged and the permeate flow reached 2200 micro liters/min at 24″ of head. Stale soda water (run 3) achieved a 40% increase in flow over tap water (run 4) when both were processed on a clean membrane. Note that the test runs illustrate that it does not matter whether the tap water or the fresh soda water is run first, the fresh soda water always outperforms the tap water. Note also that the lack of dissolved gas allowed full siphon effect and no bubbles were observed in the discharge lines. Also remember that the differential transmembrane pressure effect must be ignored in all of these runs because the membrane is horizontal. When the membrane is clean, the improvement in permeate flow appears to be related only to the effect of dissolved gas nucleating in or on the membrane. It is predicted that these results are related to a substantial change in the partial pressure of the gas in the fluid. The dissolved gas is at super-saturation pressure in the liquid on the upstream side of the membrane, but is at atmospheric pressure on the down stream side of the membrane. Consequently, the gas is moving from high pressure to low pressure across the membrane and possibly taking the fluid with it.

The Zenon membrane produces about 50% more flow per sq. ft. than the Kubota membrane but the Zenon membrane uses a vacuum on the permeate discharge line. It may be that Zenon membranes are influenced by the drop in partial pressure across the membrane thus causing a nucleating gas effect. From a differential density across the membrane perspective, a 40″ tall Kubota membrane should perform better than a 60″ tall Zenon membrane.

4) To quantify the effect of the membrane cleaning process of step 3, tap water was re-run on the alleged cleaned membrane. This time the permeate flow increased from 1050 micro liters per min. in test 1) to 1575 micro liters in test 4. This represents a 50% increase in permeate flow due to impingement/nucleating gas cleaning.

5) Fresh soda water (1-6 hr old) was processed on the clean membrane and the permeate flow (2400 micro liters per minute) was marginally better (9%) than run 3 (2200 micro liters per minute) which used soda that had been air stripped for 12 hrs. Again it is seen that extremely high levels of dissolved gas are not needed to create an effect.

6) Run 6 was on tap water and the permeate flow rate increased (44%) to 2275 micro liters per min. from 1575 micro liters per min. over the earlier run 4 also on tap water, both using a clean membrane. Run 6 on tap water produced slightly less permeate flow (5%) than fresh soda water in Run 5.

7) Stale soda water (12 hrs old) was run on a clean membrane. The permeate flow (1950 micro liters per min.) was 23% less than the 1-6 hr old soda permeate rate of (2400 micro liters per min.). The permeate flow rate for 12 hr old soda (1950 micro liters per min.) was surprisingly (16%) lower than for the tap water run 6 (2275 micro liters per min.). It would appear that when the filters are clean the rheological properties of the stale soda water and the tap water behave similarly. The data indicates that the difference in permeate flow of the two soda water runs, is related to the age of the soda which in turn is a function of the amount of dissolved gas present. However, in this case the tap water permeate flow exceeded the stale soda water run indicating that there is really no difference in the rheology of the two fluids when processed on a clean membrane. This gives credence to the idea that the increase in permeate flow is indeed a function of the gas nucleation phenomena rather than a difference in the physical/chemical properties of the two fluids.

8) Having determined that the rheology and the physical/chemical properties of the two water sources are similar (once the dissolved gases are equilibrated), a final run (8) of a 50% tap water and 50% fresh soda water was evaluated. In this case the mixture was replenished often, at less than 30-minute intervals, to more closely approximate the nature of a vertical shaft bioreactor. In this run 8, the permeate flow reached 2600 micro liters per min. for a 15% increase over tap water alone, and 8% over fresh soda water alone. Run 8 at 2600 micro liters per minute is equivalent to 130 U.S. gal per day per full size membrane. Also keep in mind that these figures are at only 24″ of head, while in the field up to 39 inches were run.

The above observations strongly indicate that dissolved gas nucleation does play a role in membrane flow rate. These data also strongly indicate that the dissolved gas is instrumental in the cleaning process. The amount of dissolved gas effects the flow rate but the amount of dissolved gas in the bench test apparatus is time dependent. Fortunately the dissolved gas content of the liquor in the field test is constant unless changed purposely.

Another test run was performed to correlate a relationship between dissolved gas content and time of exposure to the atmosphere. Fresh soda water was processed on the dirty membrane at three pressure heads. The flow rate changed as follows:

TABLE 4
At 18″ head

| | | change in rate of flow- |
|---|---|---|
| Elapsed Time (minutes) | micro liters per minute | micro liters per minute |
| 3 | 1790 | |
| 8 | 1650 | 28 |
| 20 | 1500 | 12.5 |
| 40 | 1450 | .625 |
| 60 | 1435 | .75 |

TABLE 5
At 8.5″ head

| | | change in rate of flow- |
|---|---|---|
| Elapsed Time (minutes) | micro liters per minute | micro liters per minute |
| 10 | 900 | |
| 18 | 700 | 25 |
| 38 | 650 | 2.5 |
| 108 | 625 | .35 |

TABLE 6
At 7″ of head (Same soda water as above, slight
change of head pressure from 8.5″ to 7″.)

| | | change in rate of flow- |
|---|---|---|
| Elapsed Time (minutes) | micro liters per minute | micro liters per minute |
| 300 | 615 | |
| 360 | 590 | .4 |

These tests indicate that soda water more than 1 hour old is fairly stable (less than 0.75 micro liter per minute) and therefore all the data points on the curves (except for run 8) are for fresh soda water at least 60 min old. On the clean membrane the difference in permeate flow between 1-5 hr old soda and 12+-hour-old soda is about 25% at 24″ of head. In the field, the fluid in circulation is always freshly saturated with CO2 every 6-10 minutes, and may therefore achieve a much larger throughput than these tests indicate.

These tests also indicate that soda water, either stale or fresh, outperforms tap water in all cases on dirty or semi clean membranes. Once the membrane is clean with soda water (which also contains a small amount of citric acid) there is not much difference between tap water and soda water. The membrane in the test apparatus was visibly cleaner, after 5 days of exposure to soda water and tap water, than at the start of the test.

The pressure differential variation from top to bottom of a Kubota membrane is 4-6″ of water and for a Zenon membrane it is about 6-8″. Run 8 using a mixture of 50% tap water and 50% soda water on a clean membrane shows a throughput of 2600 micro liters/min at a head of 24″. A 4″, 6″ and 8″ pressure differential accounts for 15%, 25%, and 35% of the total permeate flow respectively. The influence on flow due to the pressure differential variation from top to bottom of the vertically oriented membrane is in addition to the increase of flow due to the degassing phenomenon, cited above, occurring at the face of the membrane. Combined, these two effects could potentially double membrane throughput. Based in part on the above, it is contemplated that the increase in flow of permeate through the membrane is due to one or more factors selected from a change in partial pressure of the gas effect, a nucleating gas effect, or a release of stored energy effect.

FIG. 19 illustrates results of a series of temperature, viscosity, and flow tests conducted on the bench test apparatus. Several trials were performed on a test apparatus to see what difference temperature would make on membrane permeate flow. Viscosity and temperature are inversely related, and throughput fluid flow was expected to be strongly related to temperature. FIG. 19 quantifies these factors based on several trials on the test apparatus and confirms these expected relationships. An important point is that viscosity varies about 10% between 15 and 25° C. However, between 15 and 25° C., the fluid flow varies almost 50%, or 550 micro liters/min. As illustrated in FIG. 19, the membranes are sensitive to temp and viscosity changes in the 15-25 degree range.

The vertical long shaft bioreactors are installed in the ground, and develop over time a huge thermal flywheel effect. That is to say, the effluent temperatures are much less variable than a conventional plant and therefore should have much less difficulty dealing with temperature variations than conventional treatment processes.

While the above description describes with respect to FIGS. 14-19 aspects of the invention using submerged membranes to separate useable water from wastewater, sewage or sludge, the invention are not so limited. The methods and devices of the invention are also readily employed for membrane separation of other desired fluids from a stream containing the untreated fluid and any unwanted matter. For example, aspects of the invention may be used to improve membrane throughput and/or membrane self-cleaning in saltwater desalination, separation in a chemical process, or in any other situation where membranes are used to separate solute particles, suspended materials and other contaminants from a fluid or solvent.

Particular embodiments therefore include treating an influent that includes removal of a targeted fluid from the influent with increased membrane throughput. The method typically involves a flowing influent stream that includes a fluid that includes a dissolved gas, and a flowing permeate stream that consists essentially of the fluid and the gas. The two streams are separated with a permeable membrane having a first surface in fluid communication with the influent stream, and a second surface in fluid communication with the permeate stream. The membrane is permeable between the surfaces by molecules of less than a predetermined size, the permeability size being selected to allow the targeted fluid to pass and reject unwanted components of the influent stream. The gas may be dissolved in the fluid by any manner or means, for example by injection and as a result of a chemical process occurring within the influent. The amount of the dissolved gas in the fluid of the influent stream is an amount that increases the permeate stream flow over the permeate stream flow when the fluid of the influent stream does not include the dissolved gas. This amount may vary depending on the nature of the fluid, the gas, and operating parameters of a system performing the membrane separation. The amount of dissolved gas in the fluid of the influent stream may be at least the saturation level of the gas, or may be a supersaturation level of the gas. The dissolved gas may include air, or a component of air such as carbon dioxide. The targeted fluid may be water, blood, or any other fluid.

Another aspect of the invention includes treating an influent that includes imparting a self-cleaning action on membrane surfaces. The method includes a flowing influent stream that includes a fluid that includes a dissolved gas, and a flowing permeate stream that consists essentially of the fluid and the gas. The two streams are separated with a permeable membrane having a first surface in fluid communication with the influent, and a second surface in fluid communication with the permeate. The membrane is permeable between the surfaces by molecules of less than a predetermined size, the permeability size being selected to allow the targeted fluid to pass and reject unwanted components of the influent stream. The fluid of the influent stream includes the dissolved gas in an amount that permeates the membrane and nucleates proximate to the second surface. The fluid of the influent stream may include the dissolved gas in an amount that imparts a scouring action on the first surface. The fluid of the influent stream may include the dissolved gas in an amount that nucleates on the second surface and imparts a scouring action on the second surface. The nucleation of the gas proximate to membrane surface imparts a scouring action on the surface that helps clean the surface. This increases operating life of the membranes by increasing time between scheduled membranes cleaning cycles that remove the membrane from service. Previous FIGS. 14 through 17 describe aspects of the invention creating a selected pressure differential across membranes along a vertical axis in a liquid-liquid system. However, an embodiment of the present apparatus can be used for creating a selected pressure differential along a vertical axis of membranes in a gas-liquid or a gas-gas system.

### Membrane Diffuser

A common conventional technology uses low-pressure horizontally orientated membrane diffusers, typically flat plate membranes placed horizontally on a floor of an aeration tank. The floor area, even if completely covered with membranes, has a relatively small area compared to the tank volume to be aerated. In such horizontal applications, a liquid being aerated is contained above the membrane. This liquid subjects the entire membrane surface to a hydrostatic pressure. A disadvantage of this horizontal membrane design is that bubbles generated are quite large when they leave the surface of the membrane. This is because a bubble must grow in low-pressure horizontal membrane systems until buoyancy exceeds attraction force before the bubble is released. Low-pressure, horizontal membrane systems typically generate bubbles about 1-2 millimeters in diameter. Current practice is to force the bubble from the surface of the horizontal membrane by increasing the internal gas pressure to about twice the static liquid pressure. This makes small, fine bubbles, but requires substantially more energy in compressing the gas.

An emerging design places membranes in a vertical configuration, and allows the liquid being aerated to flow between the membranes. The membrane surface area in an aeration tank is greatly increased by arranging the membranes vertically, and the bubbles generated are smaller due to the shearing action of the liquid flow between membranes. Very low energy requirements that are 20-30% of conventional horizontal membrane systems have been reported. However, in the vertical layout, a top portion of the membrane sees a lower pressure from the liquid than a bottom portion of the membrane because the bottom portion is at a greater depth. This results in an unequal airflow along a vertical axis of the membrane surface. A common complaint in this design is that vertically orientated membranes “wet out” and cease air flow through the membrane. The “wet out” generally begins with a portion of the membrane at the greatest depth, and proceeds upward. The lack of airflow in the lower membranes allows water to enter the membrane, which restricts or stops gas diffusion by the membrane.

FIG. 20 schematically illustrates a submerged membrane gas diffusion apparatus 600, according to an embodiment of the invention. FIG. 21 is a partial cross-sectional front view of the gas diffusion apparatus 600 of FIG. 20 and illustrates several aspects of the apparatus, according to an embodiment of the invention. The membrane gas diffusion apparatus 600 includes three separate compartments, a fluid treatment compartment 601, a bubbling fluid compartment 602, and a static fluid compartment 603. The compartments (601, 602, and 603) are preferably located proximate to each other for convenience. The membrane gas diffusion apparatus 600 also includes at least one membrane bundle that diffuses a gas into a liquid. In the exemplary embodiment illustrated in FIG. 20, three hollow tube membrane bundles 610A-C are positioned at different elevations in the fluid treatment compartment 601 of the gas diffusion apparatus 600. This embodiment of the invention can alternately employ one or more membranes. The membranes can be of any type suitable for membrane gas diffusion, such as plate and frame, tubular, hollow fiber, and spiral wound membranes. Further, the membranes can be made from any suitable material, such as cellulose acetate, polyvinyl chloride, polysulfones, polycarbonates, and polyacrylonitriles.

Elements of the submerged membrane gas diffusion apparatus 600 include a membrane bundle 610, a membrane-mounting member 612, a fluid treatment compartment 601, a bubbling fluid compartment 602, and a static fluid compartment 603. For clarity in viewing FIG. 20, detailed reference numbers are generally provided only for the bottom membrane bundle 610A and its associated membrane-mounting member 612. Membrane bundles 610B and 610C are substantially similar to membrane bundle 610A. Typically, each membrane bundle is about 6 inches in diameter and about 30 inches long, and typically includes a plurality of hollow tubular membranes. The hollow tubular membranes have a typical inside diameter of about one inch. FIG. 21 illustrates the membrane bundle as including three hollow tubular membranes 610A-1, 610A-2, and 610A-3. However, there may be any number of tubular membranes in each tier of membrane bundles 610. The membrane bundles 610A-610C are oriented such that the fluid to be treated 634, such as a mixed liquor, flows among tubular membrane bundles of each of the several tiers during aeration. Each tubular membrane has a first surface, a second surface, and is permeable between the surfaces by molecules of less than a predetermined size, such as described in conjunction with FIGS. 14-1 through 14-7.

Each membrane-mounting member 612, which is a tubular member with a right hand 612R and a left hand 612L portion in an exemplary embodiment, mounts or carries a respective end of the membrane bundle 610 at a membrane-mounting portion. Each membrane-mounting member 612 includes a chamber 614 that provides the fluid communication FC between the bubbling fluid compartments 602, the first surface 411 of each membrane of the membrane bundle 410 mounted to the mounting member, and the static water compartment 603. The chamber 614L of left-hand portion 612L of the membrane mounting member 612 includes a substantially vertically orientated bubble capture chamber 617 and a bubble capture aperture 619, which are illustrated in FIG. 21 as part of a rising gas bubble capture member 615. The member 615 is coupled with the mounting member 612L to form an assembly. The chamber 614R of the right-hand portion 612R of the membrane mounting member 612 includes a substantially vertically orientated gas reservoir chamber 618 and gas release aperture 611, which are illustrated in FIG. 21 as part of a release member 616. The member 616 is coupled with the mounting member 612R to form an assembly. The chambers 617 and 618 each have a vertical length, the vertical length 654 of the chamber 617 being greater than the vertical length 656 of chamber 618.

For purposes of describing an embodiment of the invention, a fluid to be diffused 620 is described as air 620. In other embodiments, the fluid 620 to be diffused may be any type of gas, or may be a liquid. Diffusion will be described herein as aeration, but the invention is not so limited. Further, a liquid 634 to be treated into which the diffusion occurs will be described as wastewater or water. In other embodiments, the fluid 634 to be treated may be any type of liquid or gas.

The fluid treatment compartment 601 includes a configuration that contains the wastewater 634, such as a reactor basin tank that contains high concentrations of suspended solids or mixed liquor for aeration in conjunction with treatment. Typically, the wastewater 634 flows into the fluid treatment compartment 601 for aeration, receives aeration, and flows out, usually for further processing or disposal.

The bubbling fluid compartment 602 includes a configuration that contains a first fluid 632 and the rising bubbles 626 of the air 620. The first fluid 632 will be described as clean water 632, but may be any fluid having a specific gravity greater than the air 620. The compartment 602 optionally includes a source for the bubbles 626, which may include a gas inlet port 622 that receives the air 620 to be formed into air bubbles 626 in the water 632. The port may receive the air 620 from an external source that, upon entry into the bubbling fluid compartment 602 and the clean water 632, forms the bubbles 626. Alternatively, the port 622 may receive the clean water 632 including the bubbles 626 into the compartment 602. The gas inlet 622 may include any apparatus that forms the air bubbles 626 in the water 632.

The static fluid compartment 603 includes a configuration that contains a static fluid 636, described as clean water 636, but which may be any fluid, but may be any fluid having a specific gravity greater than the air 620. Optionally, the compartment 603 includes a configuration allowing a user to visually observe whether any bubbles of the gas 620 are being discharged from the gas release aperture 611 of the gas release member 616, or are otherwise present.

FIG. 20 illustrates the assembly 600 arranged with the bubbling fluid compartment 602 and the static water compartment 603 each abutting the fluid treatment compartment 601. The compartments may be defined in a single tank or structure. Alternatively, the compartments may be separate tank structures, one of more of which abuts another. In an alternative arrangement, the compartments 602 and 603 can also abut each other. In another alternative arrangement, one compartment may be a distance from another compartment. FIG. 19 also illustrates a “zero” elevation at a lowest point in the apparatus 600, with the elevation increasing in an upward or vertical direction. In the assembly 600, the three tiers of hollow tube membrane bundles 610A-C are mounted in a fluid treatment compartment 601 at elevations 4.0, 6.5, and 9.0 feet respectively. In practice, any suitable number of the membrane bundles 610 may be used, the membrane bundles may have any separation, and can be only inches apart.

As illustrated in FIGS. 20 and 21, the rising bubble capture portion of the first chamber 614L, shown as capture member 615 and bubble capture aperture 619, are located in the bubbling fluid compartment 602. The gas reservoir portion of the second chamber 614R, shown as release member 616 and gas release aperture 611, are located in the static water compartment 603. The rising bubble capture members 615 are illustrated with a 2.5 foot-long vertical length measured from the bubble capture aperture 619 to the lowest elevation of the respective membrane bundles 610 to which they are coupled. Gas release members 616 are illustrated with a 2.0 foot-long vertical length measured from the gas release aperture 611 to the lowest elevation of the respective membrane bundles 610 to which they are coupled. The rising bubble-capture members 615 and the gas release member 616 may be any length. However, the gas release members 616 are shorter that the rising bubble-capture members 615. A length differential of 0.5 feet is expected to provide satisfactory results. If there is a significant difference in the specific gravity of the aerated clean water 632 and the static clean water 636, the length differential between the gas release member 616 and the bubble-capture member 616 is adjusted to provide the automatic gas release functionality described below.

In use, the bubbling fluid compartment 602 is filed with aerated clean water 632, and the static water compartment 603 is filled with static clean water 636. The fluid treatment compartment 601 is filled with the wastewater 634 to be aerated to a level sufficient to submerge the membranes 610A-C. The wastewater 634 optimally is flowed through the compartment 601 from a low elevation to a high elevation proximate to the second surfaces of the membranes in a manner that facilitates aeration, and then flowed from the compartment.

FIG. 20 illustrates an initial static water level of 12 feet in the assembly 600, which then increases to 12.6 feet in the compartments 601 and 602 as the water 632 and wastewater 634 are aerated. The air 620 is pumped at a relatively low pressure into the bubbling fluid compartment 602 through port 622, and the air bubbles 626 are formed in the clean water contained in the compartment to form the aerated water 632. Only a small amount air pressure is required to pump the air 620 through the port 622 and into the compartment 602, saving energy compared to existing systems requiring an increased pressure to force air bubbles from diffusion membranes. The bubbles 626 are formed in a diameter sufficient to cause the bubbles to rise in the aerated water 632. The bubbles 626 rise in the aerated water 632 and a portion of the bubbles rise through the capture member bubble capture aperture 619 and are captured in the rising bubble capture member chamber 617. In the chamber 617, the rising bubbles 626 coalesce and ultimately release the air 620 above an aerated water 632/air 620 interface 658 within the capture member chamber 617. Because the capture member chamber 617 is in fluid communication with membrane-mounting member portion of the chamber 614, which is in turn in fluid communication with the first surface of the membranes of the membrane bundle 610, the released air 620 flows or is communicated with the first surface of the membranes along the fluid communication path FC.

The vertical position of the aerated water 632/air 620 interface 658 within the capture member chamber 617 with respect to a lowest elevation of the membranes of the membrane assembly defines a gas column 652 having a vertical length, which can also be described as a hydraulic head or differential hydraulic head. The gas column 652 imposes a hydraulic head on the air 620, which is a function of the buoyancy of the air 620 in the aerated water 632. That imposed hydraulic head is transmitted to the portion of the air 620 in fluid communication with the first surface of the membrane of the tube membrane bundle 610. If the specific gravities of the aerated water 632 and the wastewater 634 are substantially similar, the hydraulic head between the first membrane surfaces 411 exposed to the chamber 614 and the second membrane surfaces 412 of the membranes of the membrane bundle 610 exposed to the fluid 634 in the fluid treatment compartment 601 will approximate the hydraulic head created by the gas column 652. FIG. 20 illustrates the gas column length 652 as one foot of the water 632, establishing hydraulic head equal to one-foot of water. The one-foot hydraulic head applies a pressure to the molecules of the air 620 in fluid communication FC with the first surface 411 of the membranes of the membrane bundles 610, forcing some of the air molecules through pores of the membranes to form aeration air bubbles 628 in the water 634.

The gas column 652 vertical length and resulting differential hydraulic head are established by the amount of the bubbles 626 in the bubbling fluid compartment 602 that enter the bubble capture aperture 619. Increasing the number of air bubbles 626 formed in the aerated water 632 increases the number of air bubbles rising into the bubble capture aperture 619, thus increasing the flow of air into the membrane-mounting member chamber 614. This increased air flow will exceed that which can permeate the membranes 610 at the existing imposed hydraulic head. The air 620 will accumulate in the chambers 614, 617, and 618, and the vertical elevation of the aerated water 632/air 620 interface 658 will decrease. This increases the gas column length 652, and increases the imposed hydraulic head on the released air 620, thus increasing the air flow through the membranes until an equilibrium is reached in response to the amount of bubbles 626 in the bubbling fluid compartment 602. The internal air pressure of the membrane bundles 610 self adjusts to the air flow provided by the bubbles 626. The higher the air flow provided by the bubbles 626, the lower the water 632 level in the rising bubble capture member 615, and the greater the differential hydraulic head 652.

If a hollow tube of the membrane bundle 610 becomes blocked, or if the captured bubbles 626 produce more air 620 than the membranes of the membrane bundle 610 can diffuse, the air will build up in the tube membrane bundle 610 until the air fills and overflows the air release member chamber 618 from the gas release aperture 611, transferring the air to the static water compartment 603. This release occurs because the air release member chamber 618 has a smaller vertical length 656 than the rising bubble capture member chamber 617 vertical length 654, and will vent the air 620 before the air 620 fills and overflows the rising bubble capture member chamber. An appearance of air bubbles in the clean water 636 of the compartment 603 indicates that excessive air 620 is being supplied to the membrane bundle 610 or that the membrane bundle needs cleaning. Because the membrane bundle 610 is connected to clean water compartments 602 and 603, no internal fouling of the membranes should occur.

On startup, the membrane surfaces of the membranes of the tubular membrane bundle 510 have differing vertical elevations. Using the membrane bundle 610C as an example, a top hollow tube membrane of the bundle is at elevation 9.0 feet and a bottom hollow tube is at 8.5 feet. Initially, the top membrane in the tube membrane 610C bundle will see a little greater pressure differential than the bottom membrane because it is at a lesser depth, and will therefore produce a little more air bubbles 628 until its maximum flow rate is achieved, thus increasing the internal pressure on the air 620 and causing the bottom membrane to approach maximum transfer as well.

The hydraulic head created by the gas column 652 can be calculated as follows: Since the water 634 in the fluid treatment compartment 601 is aerated as a result of its processing, there is a voidage of between about 2-10%. For purposes of describing the system 600, a voidage of 5% will be assumed. The dynamic water levels in both the fluid treatment compartment 601 and the bubbling fluid compartment 602 are established at 12 feet×105%=12.6 feet. The hydraulic head across the membrane surfaces of the top bundle tubes of the membrane bundle 610C is the pressure of the water 634 outside the second membrane surface 412 minus the pressure of the air 620 inside at the first membrane surface 411. The outside water 634 pressure is (12.6−9.5)/2.31×0.95=1.27 psig while the inside air 620 pressure is (12.6−8)/2.31×0.95=1.89 psig. The hydraulic head is 0.62 psig. Similarly the outside water 634 pressure on the bottom membrane bundle 610A is (12.6−4.5)/2.31×0.95=3.33 psig and the inside air 620 pressure is (12.6−3)/2.31×0.95=3.94. Again, the hydraulic head is 0.62 psig. These calculations illustrate an aspect of the invention providing a selected hydraulic head or pressure differential across all the membranes of the assembly 600.

Occasionally it will be necessary to shut down the gas diffusion apparatus 600, and clean water 632 and 636 will enter the membranes 610. When the air 620 is restarted, the water will be forced out of the air release members 616 and into the static water compartment 603, thus self-purging the airways of the tubular membranes of the membrane bundles 610. In an alternative embodiment, the compartment 603 could be filled with a cleaning fluid for periodic cleaning of the membranes by stopping the air bubbles 626.

It should be noted that there are many applications where the apparatus 600 could be used. Some examples are ozonation (O₃), chlorination (C₁₂), or recarbonation (CO₂) of drinking water, disinfection of wastewater or re-oxygenation of effluent using pure O₂, or biochemical nutrient addition or feedstock, such as NH₃, CH₄, SO₂, etc.

FIGS. 22-40B, as discussed below, concern the design of hyper oxygenated or hyper O₂ devices, systems, and operational methods to generate hyperbaric conditions in liquids, liquid compositions, and/or liquid suspensions. The devices may include a fluid submerged, vertically oriented membrane diffuser or screen that is hydraulically connected to a gas source and designed and operated such that fine bubbles are evenly distributed throughout the membrane's vertically orientated surface. The devices may include at least one fluid submerged, vertically oriented membrane, porous tubing, porous plate, screen, or multiples thereof in the form of a membrane, tubing, plate, or screen assembly that are hydraulically connected to a gas source, such as compressed air or oxygen. Gas permeable membranes typically have pore sizes approximately between 0.05 and 10 microns while porous tubing or porous plates will have pore sizes approximately between 10 and 100 microns. Screens typically will have pore sizes greater than 100 microns. When describing a general principle, these terms may be used interchangeably. In the operation of some membrane, tubing, plate or screen assembly embodiments, there may be a transitory “wetting out” or hydro locking effect resulting in the cessation of gas transfer across at least a portion of membrane. In these embodiments, the transitory wetting out is subsequently mitigated by diffuser design as will be explained below. In other embodiments, the gas distribution occurs without significantly experiencing a transitory wetting out effect.

Embodiments described below further include vertically orientated gas diffusers that present differing gas emerging patterns from the surface of the vertical membranes. For example, embodiments include diffusers having gas emerging from one section of the membrane with a discernable front, and then progressively growing toward another section of the membrane surface. The discernable migration front includes bubble patterns that begin at the bottom and move towards the top of the membrane. Once the migration front ceases to move, the vertically orientated membrane continues to bubble evenly throughout the vertical membrane surface. Other embodiments have a gas emerging pattern having the near-simultaneous emerging of gas bubbles throughout the whole vertically orientated membrane surface without a discernable upwardly migration front.

FIG. 22 illustrates cross-sectional and plan views of a Hyper O₂ gas diffuser 700 having a cone-shaped configuration. The gas diffuser 700 resides substantially submerged in a tank reservoir 702 defined by reservoir walls 702A and reservoir bottom 702B. The reservoir 702 may also reside inside a deep shaft having liquid compositions and/or liquid suspensions 704 available for aeration treatment. The submersion depth of the diffuser 700 within the tank reservoir 702 may be fixed or adjustable beneath a height H₁ of the liquid suspension 704.

The gas diffuser 700 includes a conical array of staggered vertically orientated gas interceptor channels or gas bubble collectors 708 located above a plenum 712. The plenum 712 includes plenum outer walls 712A, a plenum bottom 712B, and a plenum drip tube 712C. The channels 708, with plenum walls 712A and plenum bottom 712B, defines a inner diffuser space or inner diffuser chamber 718 having a substantially conic configuration. Residing within the inner diffuser chamber 718 located on the bottom end of the gas interceptor channel 708 is an inner orifice or inner aperture 708A. The inner orifice 708A may have a substantially right angle cut to the vertical orientation of the gas interceptor channel 708 and serves to collect or catch air bubble streams appearing within inner chamber 718. On the upper end of the gas interceptor channel 708 is a beveled-shaped outer orifice or outer aperture 708B that faces the exterior side of the liquid or liquid suspensions 704. The beveled configuration of the outer orifice or outer aperture 708B of the gas interceptor channel 708 confers a smooth and even conical surface for the overlaying of a gas permeable membrane 720. The gas permeable membrane 720 covers over the exterior of the beveled outer apertures 708B of the gas interceptor channels 708. The membrane 720 may take the form of a gas permeable screen, membrane, or flexible sheet. The membrane 720 forms a sealed apex along the fluid equalization pipe 716 and a sealed skirt along the outer plenum wall 712A. Beneath the plenum drip tube 712C is a pressure relief valve or check valve 714. The check valve 714 is designed to release fluids accumulating in the inner chamber 718 at or above a preset pressure value to limit the internal pressure P₂ within the inner chamber 718. The check valve 714 includes a plenum orifice to release fluids from the inner chamber 718 via the drip tube 712C. The interceptor channels 708 ascend stepwise between peripherally located plenum outer walls 712A to the centrally-located pressure equalization pipe 716. The gas interceptor channels 708 are concentric or annularly disposed in a stepwise configuration to each other, shown in the cross section, and concentric to each other as shown in the bottom projection.

In fluid communication with the equalization pipe 716 is a head tank 724 in which clean fluid resides to a height H₂. The inner chamber 718 receives the clean and non-fouling fluid delivered through the pressure equalization pipe 716 and is hydraulically dampened from baffles 732 extending from the top exterior of a gas distributor plate 736 located above the plenum bottom 712B. The height H₂ of the clean fluid provides an inner pressure P₂ within the inner chamber 718.

Coaxially extending from the head tank 724 and to the bottom exterior of the distributor plate 736 is a gas supply pipe 728 in fluid communication or pneumatic contact with a gas source (not shown) and a gas port 738 in fluid communication with the distributor plate 736 through a gas distribution plenum 742 that is shorter than the plenum wall 712A to provide a gap 751 to permit the flow of liquid and gas bubble streams into the inner chamber 718. Referring to the magnified inset in FIG. 22, the bottom of the distributor plate 736 includes a plurality of notches or serrations 744 that radiate to the periphery or perimeter of the bottom of the distributor plate 736. The serrations 744 in turn have a plurality of holes (not shown) through which the gas emerges to contact and forms into gas pockets 748 in the upper parabola portion of the serrations 744. As gas emerges from the bottom of the distributor plate 736 the gas pockets 748 are incrementally dislodged from the parabola portion between the serrations 744 and emerge from the periphery of the bottom of distributor plate 736 to form gas bubble streams 752. The bubble streams 752 travel in the gap between the edge of the distributor plate 736 and plenum walls 712A and into the inner chamber 718.

Inside the chamber 718, the gas interceptors 708, being staggered and stepwise configured, captures the gas bubble streams 752 flowing in the chamber 718 and delivers the captured gas across the gas permeable membrane 720 into the fluid suspension 704 as fine gas bubbles 754. This gas bubble transfer process from inner chamber 718 to the external fluid suspension 704 occurs if external membrane or first pressure P₁ of the fluid suspension is sufficiently less than the internal membrane or second pressure P₂ of inner chamber 718. That is, the trans-membrane pressure differential P₁-P₂ is of significant magnitude to cause the migration of captured gas to be delivered as fine bubble steams 754 into the fluid suspension 704. The trans-membrane pressure differential is controlled by regulating the clean fluid height H₁, the fluid suspension 704 height H₂, and the amount of clean fluid released from inner chamber 718 through the check valve 714.

Referring again FIG. 22, the air bubble streams 752 flow around the perimeter of the distributor plate 736 and into the clean fluids contained in the conically configured inner chamber 718. The vertical air bubble interceptor channels closer to the perimeter catch more air bubbles 752 than those interceptor channels closer to the equalization pipe 716 due to an increased surface area of the larger annular channels at the periphery. Similarly, the membrane surface area decreases toward the top of the cone resulting that the differential pressure is substantially constant along parts of the membrane surface. This design advantageously allow recovery from “wetting out” effects that occurs when incoming fluids prevent the emergence of fine air bubbles 754 from the surface of the membrane 720 in that the local pressure differential along the height of the diffuser 700 can be adjusted to either prevent or otherwise mitigate wetting out effects. The internal hydraulic pressure P₂ within the conically shaped inner chamber 718 is controlled by the fluid height H₂ in the head tank 724, the amount of cumulating air bubble streams 752 captured by the staggered interceptors 708, and the amount of fluid delivered through drain 714. The pressure differential P₁-P₂ is attained and maintained to establish sufficient aeration of fluid compositions and/or suspensions by adjusting heights H₂ and H₁, the gas flow rate, and the fluid delivered from the inner chamber 718 through drain 714. Thus the pressure differential P₁-P₂ can be controlled by 1, varying the submerged depth of the diffuser 700, for example, several feet to several hundred feet, 2, by controlling the height differential pressure differential H₂-H₁ between the gas treated fluid in reservoir 702 and the height of the clean fluid in head tank 724, and 3, by releasing fluid from inner chamber 718 through check valve 714.

FIG. 23A illustrates in cross-section a cone-shaped Hyper O₂ gas diffuser embodiment fitted with an impermeable flexible diaphragm configured to adjustably occlude the gas permeable membrane. FIG. 23B is an isometric illustration of the adjustably occluded gas diffuser. As will be described below, the diffuser alternate embodiment is configured to control the hydro locking of gas permeable membranes and to optimally aerate water suspensions moving sequentially in down and upward flows. As shown, a gas diffuser 760 is submerged within the reservoir 702. The gas diffuser 760 includes an internal conical element support 764 to serve as a cavity support for a conically shaped gas permeable membrane 768. Interposed between the element 764 and membrane 768 is a non-gas permeable or gas impermeable flexible diaphragm 772. The diaphragm 772 is sealably secured to the peripheral flanges 768A via bolts 774. Along the periphery of the gas impermeable diaphragm 772 is a plenum (not shown) that defines a gas inner space (not shown) located between the gas impermeable diaphragm 772 and the porous membrane 720, and a hydraulic space (not shown) defined by the inner space between the gas impermeable diaphragm 772 and the plenum. Representations of the gas inner space 718 and hydraulic space in this particular embodiment is shown in another particular embodiment illustrated and described in FIGS. 27A and 28 below in relation to the operation of the gas impermeable diaphragm 921 of these figures. The hydraulic space between the diaphragm 772 and element 764 is in fluid communication with head tank 724. Fluid is delivered from the head tank 724 via pipe 716 to generate a hydraulic pressure P₃ in proportion to the height H₂ of the fluid in head tank 724. The gas space between the diaphragm 772 and membrane 768 is in fluid communication with a gas source (not shown). Gas is delivered from the gas pipe 728 into the gas space to generate a hydraulic pressure P₂ in proportion to the quantity of gas delivered and the proportion of membrane 768 surface area occluded by the sealably engaged diaphragm 772. Near the bottom of the membrane 768 is a gap that serves as a fluid drain port 775 to release any water or other fluid accumulation to prevent or lessen hydro locking along the membrane 768.

The amount of fine air bubbles 754 emerging from the membrane 768 depends on the gas permeable pore coverage by the gas impermeable diaphragm 772 that has collapsed onto the membrane 768. The collapsing direction occurs from top to bottom, sequentially covering each lower row of membrane pores due to a greater differential pressure across the top portion than at the bottom portion of the membrane 768. The pressure differential is greater at the top portion of the membrane 768 because the outside of the membrane 768 is immersed in liquid and the inside is exposed to gas. As a result, more air will flow from each top pore than from each bottom pore because of the greater differential pressure at the membrane top. Due to the conical shape of the membrane 768, the number of holes at any depth on the screen increases linearly as the depth increases as the increasing diameter allows for an increased placement of holes along the membrane periphery. Simultaneously, the differential pressure across the membrane decreases linearly as depth increases. As a result, the cone shape allows an equal volume of air to flow from the screen at any elevation, or row of holes, top to bottom. This is because the bottom row has less pressure but more pores and the top row has fewer pores but greater pressure.

Though the gas based operation of diffuser 760 lessens the likelihood of membrane “wetting out”, when the gas source is compressed air, the water content condensed from the incoming compressed air may accumulate to create a transitory “wetting out” or hydro locking situation. The bottom row of pores in use will be exposed to a pool of water and hydro lock or membrane plugging could develop, as would commonly occur with 1 micron mesh and smaller mesh membranes. To lessen the likelihood of hydro locking, the membrane 768 may be configured with a mesh size that does not permit the accumulation of water. Typically, a mesh size of approximately 300 micron will avoid water accumulation and subsequent hydro locking. In the event that water does pool at the intersection of the diaphragm and the screen the air pressure will increase thus collapsing the diaphragm downward. Eventually the drain ports 775 at the very bottom of the diaphragm will become exposed to allow rapid discharge of the accumulated water that is generally clean and non-fouling. The drain port 775 can also be conveniently used to chemically wash the screen with peroxide or bleach injected into the down corner air line 728 to maintain the screen's cleanliness and capacity. The ball check valve 714 at the bottom of the line prevents sludge from getting into the diaphragm chamber. There is also a check valve (not shown) on top of the diaphragm air line 728A and at the top of the down corner air line 728A which will prevent sudden reverse flow across the membrane in the event of a power failure or sudden loss of air pressure.

The gas diffuser 760 is submerged within a down corner channel 776 more clearly seen in the isometric projection. The down corner channel 776 is fitted within a riser channel 778. The down corner channel narrows by virtue of the placement depth of the diffuser 760, restricting liquid suspension flow. An annular gas distribution plate 782 is in fluid communication with auxiliary gas line 728A. The annular plate 782 has serrations 744 shown in the magnified inset that gather gas pockets 748 in the parabola spaces. Bubble streams 752 emerge into riser channel 778 to provide a fluid boost or airlift effect and to pre-aerate the ascending portion of the liquid suspension. The aerated liquid in riser channel 778 flows around and into the down corner channel 776 toward the diffuser 760 to receive an additional aeration from fine bubbles 754 emerging from the membrane 768. The downward flow of the liquid suspension in the down corner channel 776 imparts a shear velocity effect to form fine air bubbles approximately 0.1 mm or of diameters approaching the boundary layer on the membrane 768 surface. The rising fine air bubbles 754 flow counter to the downward traveling pre-aerated liquid suspension and serves to increase aeration contact time.

FIG. 24 illustrates a tubular or cylindrical Hyper O₂ gas diffuser 800 embodiment of FIG. 22 having a cylindrical shaped overlaid gas permeable membrane 722. In this embodiment the staggered vertical air bubble interceptor channels 808 are funnel shaped and provide upwardly converging channels that capture the larger air bubbles 752 flowing around the bottom of gas distributor 736 and into conically shaped inner chamber 729. The bubbles 752 are then routed toward the to the gas permeable membrane 722 and released as fine air bubbles 754. The gas interceptor channels 808 are formed from staggered concentric funnels having decreasing diameter from the perimeter to the most interior location. The channels 808 are annularly disposed in a stepwise configuration to each other on the interior side and beveled on the cylindrical wall side to provide a uniform surface for applying the cylindrically configured membrane 722. The cylindrically overlaid membrane 722 provides additional surface area than the conically configured membrane 720 of FIG. 22. In operation larger air bubbles 752 enter the conical internal chamber 729 in gas bubble communication with the gas distributor plate 736 along the periphery and are incrementally caught by the sequentially positioned bubble interceptors 808 as the bubbles streams 752 upwardly course along the inner conic periphery of the internal chamber 728. Similarly, collected larger air bubble steams 752 pass to the exterior of the membrane 722 and emerge as fine bubble steams 754 provided that hydraulic conditions are sufficient as previously described for FIG. 22.

FIG. 25 illustrates a Hyper O₂ gas diffuser 820 cylindrical array embodiment of FIG. 24. Here a larger cylindrical gas diffuser is obtained by a tandem vertical configuration of the cylinder arrangement depicted in FIG. 24 to increase the surface area of vertically deployed gas permeable membrane 722. The gas diffuser 820 includes two inner conical chambers, a first or bottom chamber 729A and an upper or second chamber 729B. Upper inner chamber 729B is under a second hydraulic pressure and is in fluid communication with the lower chamber 729A under a first hydraulic pressure via a shortened uppermost distributor channel 818 that does not make sealing contact with membrane 722 but instead leaves a gap to allow passage of larger bubbles 752 into the upper inner chamber 729B. Uppermost channel 818 includes a bubble chamber 836 that includes a serrated bottom similar to the serrated bottom of gas distributor 736. Gas accumulates within the parabola portion between the serrations 744 of upper distributor 836. A new steam of relatively large gas bubbles 752 similarly course through the upper inner chamber 728B for collection by interceptors 808 and emergence from gas permeable membrane 722.

FIG. 26 is a cross-sectional elevation illustration of a needle valve diffuser 850 that operates without a gas impermeable flexible diaphragm. The needle valve diffuser 850 includes a needle valve diaphragm 870 and needle valve 872 that is slidably in contact with wall 712A. Diffuser 850 can handle larger volumes of air as compared to diffusers 700, 800 and 820 because diffuser 850 is not as affected by the internal pressure loss due to high gas content in the internal fluid of their respective inner chambers. The equalization of pressures across the membrane 722 or screen is substantially mechanical. The needle shaped semi-rigid diaphragm 870 is substantially conical and rubber or silicon coated to provide good seating characteristics with the ends of valve seats or lands 878 that are the endpoints of runners 880, the lands being that are recessed from the diaphragm 870 to form a gap. In this illustration 34 runners 880 have 34 lands or valve seats 878 that have differing internal radii depending on their conic position location. The gap between the recessed lands and diaphragm 870 varies with the position occupied within the movement limits of the illustrated double arrow. The movement extremes are caused by compressed gas filing a bellows 852 having expansion lobes 856 that push lobe bar 860 connected to the needle valve 872. Downward movement of needle valve 872 decreases the gap width and gap annular surface area for a given land number, and upward movement increase gap width and donut-shaped gap annular surface area. The quantity of air passage between the gaps at a given gas flow rate is determined by the land position number and concomitant donut-shaped surface area created at a given land position number by a specific movement location of the needle valve 872.

Water saturated compressed gas is supplied in gas pipe 728, through the bottom of gas distributor plate 736, and upon cooling, a water condensate pools within catch chamber 876. The volume of water condensate within catch chamber 876 is regulated by the check valve 714. Once the water in catch chamber 876 is at a sufficient volume, air bubbles 752 flow up through the donut-shaped gaps between the lands and thence into the inter-land channels 882. Thereafter, fine air bubbles 754 emerge from the external surface of cylindrically shaped gas permeable membrane 722. The aeration rate of fine air bubble 754 emerging across the vertical distance of the cylindrical membrane 722 is substantially uniform and equal due to the conical shape of the needle valve 870 imparts a larger donut gap area at of the bottom annular space or land position is than the top land or annular space. Gas flow through an orifice is roughly proportional to the open area when the pressure drop and temperature across the orifice is constant. Another embodiment includes the 34 annular orifices of the diffuser 850 to be approximately having a 2 foot diameter and 17 foot height. Since the open area of the orifice is equal to a product of π, land diameter and land gap width, the open area of the orifice is therefore linearly proportional to the diameter of the orifice and is proportional to the height of a given land 878 height position. When closed, diaphragm 870 fits tightly up against the lands and substantially no air is passed.

Referring again to FIG. 26, the pressure drop across each orifice inter-land gap is a constant, being fixed by the external pressure on the screen or membrane 722. The pressure on the outside of the membrane or screen 722 is proportional to the submergence depth of the diffuser 850. As a result the flow through the orifice gap bottom orifice is 34 times larger than the flow through the top orifice but the bottom orifice is 34 times greater than the uppermost orifice defined between lands 0 and 1. Similarly, the flow through the mid height orifice is half the flow through the bottom orifice, but the open area of the mid height orifice is also half. The foregoing is a generalized principle, not accounting for corrections in runner spacing required around the air line 728 penetration points into the diffuser body. The top five lands can be altered slightly, as shown, to provide clearance for the air line 728. As long as the gap between the lands 878 of runners 880 and the cone is correct for the flow required, the flow will be sufficient to provide a uniform emergence rate of fine gas bubbles 754 from the cylindrical membrane 722. These corrections are small and are easily adjusted by changing the spacing between the runners 880.

FIG. 27A illustrates a gas ribbed diffuser embodiment 880 having a flexible diaphragm 921, air ports 924 equipped with a panel of manometers lines 928 to obtain pressure measurements of a spiral pattern of tapped holes 936 and to permit the observation of emerging bubbles within observation lanes 932 mounted on the outside of the diffuser 880. The holes 936 are space in 5-hole increments per observation lane 932 in the spiral pattern, are approximately 0.030 inches in diameter, and spaced approximately 0.3 inches apart. The ribbed diffuser is tapped for manometer pressure measurements circumferentially for a plurality of 0.030″ diameter holes tapped at different elevations. The spiral pattern allows for direct observation of air-bubble streams at different elevations due to the lateral displacement along the spiral pathway. Otherwise, had the holes been place more or less in horizontal ascending rows, the simultaneous emerging of multiple bubble streams would have obscured or make it harder to determine the elevation location of the emergence of bubble streams. A single 0.030″ diameter hole was selected as being equivalent in an open area to the sum of the pore holes in 0.300″ vertical section of porous membrane 1.5″ in diameter. Due to hole-to-hole clustering, it was not possible to measure the pressure on every hole that was 0.300″ apart because such small diameter tubing on a manometer results in significant errors due to capillary effects. As a consequence, every fifth hole, counting from the bottom, was tapped for a manometer tube reading.

The flexible diaphragm 921, when no gas is applied, blocks the passage 911 leading to the air ports 924 located between adjacent extensions 923 whenever sufficient hydraulic pressure is conveyed to diaphragm 921 created by clean water H₂ in head tank 724. The clean water H₂ from head tank 924 is conveyed to the diaphragm 921 via passages 925 of inner cylinder 937. Applying compressed gas to the gas pipe 728, air enters bottom cavity 941. The manometer installation reads the pressure between the diaphragm and the membrane at every fifth hole or every 1.5″ change in depth. On the outside of tube observation lanes 932 provided six viewing channels to establish visual verification that only the correct group of holes was producing bubbles. For example, if the test run was to measure the pressure on the lower 10 pockets which contained holes 1-10 on outer cylinder 945 then it was possible to see clearly if hole number 11 was operating because it would be on the other side of the divider and quite visible if operating. Because the bubbles start from the bottom, it could be verified that the first ten holes were operating if hole 11 was just beginning to produce a bubble intermittently. Initially drip tube 943 was open ended and was intended to measure the internal pressure in tap D but since this reading is nearly equal to the lowest manometer reading, the practice was discontinued. A drip can 933 was attached to see how much water, if any, would accumulate above base plate 959 and seep in from the other holes in outer cylinder tube 945. The air supply was delivered through two pressure tanks in series, of known volume, each with its own air regulator. This proved to be very accurate way to control pressure and it was possible to dial in the pressure to 0.30″ of water. By shutting off the air supply to the pressure tanks and measuring the pressure drop over the time, air flow rate could be calculated.

In order to understand the principle of operation of the diffuser 880 three conditions are presented. First the diaphragm is removed and H₂ is exactly equal to H₁ because they are hydraulically connected. Second, inner cylinder 937 and outer cylinder 945 are removed from the test tank 701 and the diaphragm 921 is installed. Outer cylinder 945 is filled to water level H₂ as shown and catch can 933 emptied and reinstalled. After checking for leaks tubes in outer and inner cylinders 945 and 937, the tubes are lowered into the test tank 701. Typically, H₂ should be about 5 inches above H₁ to prevent water from leaking into the catch can 933. Height differential H₂-H₁ causes pressure differential P₃-P₁ that is called the closing pressure. This is the pressure required to seat the diaphragm 921 against the air passages 911 leading to air ports 924 the of inner cylinder 937. After the manometers are connected, air is introduced via gas pipe 738 into the air cavity 941 located beneath the inner cylinder 937 and the bottom clamped region 939 of diaphragm 921. As gas pressure builds, the bottom pore holes begin to release bubbles within the 5-pore groupings confined within observation channels 932. This process is repeated for each group of 5 holes for 25 holes, in this test run, and the manometer pressures are recorded.

The closing pressure P₂-P₁ is constant at 5 inches of water for all runs because this is controlled by the liquid levels H₂ and H₁. Clean liquid H₂ is conveyed to the diaphragm 921 through inner cylinder ports 935. The trans-membrane differential pressure P2-P1, measured by the manometers, is also constant at 3.5 inches of water for all air flow rates. The trans-diaphragm differential pressure P₃-P₂ is constant for all air flow rates. The data collected on flow, shows that the air consumption is directly proportional to the number of holes being used. This is to be expected, since the trans-membrane pressure does not change with the number of holes being used.

Referring still to FIG. 27A, this data shows that it takes about 1.5 inches of water to move the diaphragm because it is installed under tension between the upper base plate 939 of inner cylinder 937 and the tapered sealing surface 951 of inner cylinder 937. The diaphragm 921 also has some hoop tension. The trans-membrane pressure is 3.5 inches of water for each hole in operation and the air flow is 0.2 units of flow per hole for all holes in operation. Air flow is defined in units of standard cubic feet per minute (scfm). The air flow was measured at 0.02 scfm per hole at a trans-membrane pressure of 3.5 inches of water. A second trial produced 0.03 scfm per hole at a trans-membrane pressure of 5 inches.

FIG. 27B illustrates a portion of an alternate embodiment of the gas diffuser 980 of FIG. 27A. Similar to the gas diffuser 880, diffuser 960 includes a gas pressurized clean water head tank 964. The pressurized head tank 964 allows for direct pressure regulation of flexible diaphragm 921 via the water content within head tank 964 and the unveiling of the diaphragm 921 to open the air passages 911 to the air ports 924.

FIG. 28 illustrates a porous tube gas diffuser 980 equipped with a flexible diaphragm 921. Diffuser 980 operates substantially the same as diffuser 980, except that there is not a series of annular spaces, but a continuous, vertical distribution of gas permeable pores. Diaphragm 921 is secured between outer cylinder cap 909 and inner cap 942. Water condensate from compressed gas delivered from gas pipe 728 is collected in catch basin 933. Excess condensate may be released via a check value (not shown) similar to the check vale 714. As with the prior embodiments, the extent of diaphragm 921 occlusion or air passage blocking of the inner side of porous diffuser 982 is controlled by the pressure P₃ conveyed by clean water head height H₂ in head tank 724 conveyed through inner chamber port 935. Conversely, the pressure P₂ needed to overcome or unseat the flexible diaphragm 921 is controlled by the gas delivered from gas pipe 728 into the gas cavity 941.

As gas is accumulates in gas cavity 941, there is an upward unmasking or unblocking of pores in a bottom to top direction as gas pressure P₂ becomes sufficient to float or lift the flexible diaphragm 921 away from the inner side of gas permeable membrane 982. As the diaphragm 921 is peeled away from the inner side, gas emerges from the outer side as fine bubbles 754 (not shown). The fine bubbles 754 continuously emerge in an upward pattern and establish a substantially uniform emergence rate per vertical height of the porous membrane 982 and fan out in a funnel like pattern near the top. The increase in bubbles near the top of the diffuser imparts a slightly lower density in the exterior liquid than compared with the middle and bottom portions of the diffuser. This slight density decrease results in the closing pressure P3-P1 to be slightly greater at the top than at the bottom of the diffuser.

FIGS. 29A and 29B illustrates top and side cross-sectional and isometric views of a flat plate diffuser 990 alternate embodiments of the cylindrical diffusers of FIGS. 23 and 27A-28. Flexible diaphragm 971 is interposed between gas porous sheets 973 constructed of corrugated material 977. Porous sheets 973 are braced by supports 975 spanning across the sheets 973 and have gas and water passages 976. A gas permeable membrane 992 is stretched or applied over the porous sheets 972 and ultrasonically welded at seams 979. Gas is delivered from pipe 728 into gas cavities 938 located in gas plenum 987. Attached to the gas plenum 987 is check valve 714 to drain excess fluid condensate from the gas.

FIG. 29A illustrates in cross section the operation of the plate diffuser 990. As shown, the diaphragm 971 is partially expanded via water head 724 that exerts tension in the upper portions as shown to form bulbous regions 971A and block the transport of gas to the membrane 992 by making sealable contact with the passageways of the porous sheets 973, thereby blocking or preventing the flow of air to and through these passageways. Those lower regions of the diaphragm 971, referred to as unexpanded regions 971B, leaves sufficient gaps to allow passage of air to the membrane 992. In this partially engaged scenario, gas delivered from port 801 into gas plenum 987 accumulates in gas cavity 938 and then is able to course to the lower portions of the plate diffuser 990 as the unexpanded diaphragm region does not occlude or block the passage of gas to the membrane 992. In contrast, air passages to the upper regions of the plate diffuser 990 are blocked by diaphragm bulbs 971A. In this case no air would emerge from the upper regions of the gas permeable membrane 992. As pressure P₂ increases inside the spaces between the diaphragm 992 and porous sheets 973, a layer of gas is able to penetrate between the bulbous region 971A and force the bulbous region 971A to lift away from the porous sheets 973. In so doing, the pushed away diaphragm allows access to the upper regions of the gas permeable membrane 992. In such a case, the plate diffuser uniformly aerates along the vertical length of the membrane 992.

FIG. 29B illustrates the passage of air and water condensate from the unblocked lower membrane regions. Water drops 994 courses downward in the straighter sections of the diaphragm 971 and is not permitted to flow from the diaphragm expanded regions that blocks air and water passages of the porous sheets 973. Gas plenum 987 is shown supported by legs 988.

FIGS. 30A-C illustrates in partial cross-sectional and isometric views a plate diffuser extension 1000 that is connectable with the cylindrical diffusers 850, 880, and 950. Diffuser extension 1000 is not equipped with either a flexible or semi-rigid diaphragm or the corrugated based porous plates of diffuser 990. Diffuser extension surface to expand the surface area of the vertical diffuser cylinders 850, 880, and 950. Plate diffuser 1000 includes a tubular frame 1002 where intermediate longitudinal frame 986 elements are fabricated from extruded tubing have air and water passage ports 1010 and 1016. A top frame member 1012 supported by ascending member 1005 provides a conduit between longitudinal frame element 986. A gas permeable membrane or screen 992 is ultrasonic welded to the longitudinal frame members 986 at seam welds 979. The top frame member 1012 is also supported by a series of hollow drop legs 1014 and water traps 1015 that are used to allow water drops 994 to drain from the membrane cavities 1003 without the loss of air pressure inside the membrane cavity 1003 and to serve as channels to back flush with cleaning solutions during servicing events. Condensate returns to the bottom of the frame 1002 by successively transferring from one elevation to the next lower one through the drop legs 1014. Membrane cavity 1003 is sealed at the terminus by cavity end caps 1006.

FIG. 30A show a portion of the diffuser extension 1000 connected near the gas ports of diffusers 850, 880, or 950 that are affected by the sealing and lifting action of the gas impermeable diaphragm 921. To understand the operation, the flow of gas through the diffuser extension 1000 will be discussed first and then the return flow of water. For convenience the internal pressure P3 on the diaphragm 921, the pressure P2 at the pore holes 936 which equivalent to the pressure in the membrane cavity 1003, and the outside pressure P1 of membrane 921 is indicated in feet of water for each elevation (non-element numbers identified as not having lead lines nor being underlined). For discussion purposes, a differential pressure head of one foot of water was chosen for all cases. Air, or any gas or mixtures of gasses, is introduced at the air distributor holes 1010 between the flexible diaphragm 921 and the cylindrical diffusers 850, 880, or 950.

In this case the air pressure at the point of entry into the diffuser extension 1000 is 11 feet of water. Note that there is also air pressure of 11 ft. of water inside the bottom rail 1002 In order for air to enter the drop leg 1014 the liquid level in the water trap 1015 would have to be depressed to 12 ft. of water, but since the pressure holding the flexible diaphragm 921 against the inner diffuser body 850, 880, or 950 is only 11 ft of water, the air will preferentially flow into the next higher pore hole. The head loss through each successive variable orifice, created between the flexible diaphragm 921 and the inner diffuser wall is similarly equal to 1 ft. of water.

The air is transferred into the plate membrane extension 1000 through tubular members 986 through the row of holes 1010 at the top to allow the air into the membrane cavity 1003. A row of holes 1016 on the side of tubular member 986 allows drainage of condensate water and infiltration water from the respective membrane cavity 1003. This condensate water fills the water traps 1015 first and thereby prevents air flow in the drop legs 1014. There is always condensate in compressed air when the outside of the membrane is colder than the compressed air.

The air that is inside the membrane cavity is at a higher pressure than the water pressure outside the membrane cavity and thus air will flow through the membrane. In any one cavity, the differential pressure across the membrane is higher at the top of the cavity than at the bottom. Airflow through a pore responds approximately proportionally to the square root of the change in differential pressure from top to bottom of the membrane cavity. Consequently, there is not much change in flow through the pores of the membrane located at the bottom to those at the top, provided the cavity height is small, in this case about 10 inches. The deeper the submergence of the membrane aerator and the greater the pressure drop across the membrane, the less pronounced the difference in air flow through the pores from top to bottom. The membrane fabric is allowed to bulge between support members. This reduces the initial pre-tension on the membrane during construction. Some flexing of the membrane has shown to assist in cleaning the pores.

FIG. 31 illustrates a combination ribbed cylinder and plate diffuser 1020 as illustrated in FIGS. 27 and 30. Membrane plate extension 1000 is in gas communication with the vertical pores of diffuser 880. A side view demonstrates the relative scale of the plate extension 1000 to cylinder diffuser 880 via longitudinal member 986. Close-up view of side view illustrates details of the longitudinal member 986, seam weld 979, and permeable membrane or screen 992.

FIG. 32 illustrates a combination needle valve cylinder and plate diffuser 1040 as illustrated in FIGS. 26 and 30. Membrane plate extension 1000 is in gas communication with the vertical pores of diffuser 880 via longitudinal member 986. A side view demonstrates the relative scale of the plate extension 1000 to cylinder diffuser 850.

FIG. 33 illustrates an isometric view of the plate extension 1000 embodiment of FIG. 30 having a receiver shell 1100 to receive the cylindrical diffusers 850, 880, or 950. Close-up view of a portion of the plate extension 1000 details the arrangement of the membrane 992, seam weld 979, longitudinal member 986, air holes 1016, and membrane cavity 1003.

FIG. 34A illustrates a plan view of a combination diffuser having multiple parallel plate extensions. Here a diffuser assembly 1120 includes centrically deployed cylindrical diffusers 850, 880, or 950 from which 14 parallel plate diffusers 1000 extend in two 7-plate sets to increase the cumulative vertical aeration surface area.

FIG. 34B illustrates a plan view of an array of combination diffusers with interleaved plate extensions. In this embodiment a three diffuser assembly 1140 includes centrically deployed cylindrical diffusers 850, 880, or 950 from which 8 parallel plate diffusers 1000 extend in four parallel sets are interleaved with flanking diffuser assemblies having four parallel plate sets. This assembly 1140 greatly increases the cumulative vertical aeration surface area.

FIG. 34C illustrates a plan view of a combination diffuser 1160 having a radial assembly of plate extensions. Here a diffuser assembly 1180 includes centrally deployed cylindrical diffusers 850, 880, or 950 from which 16 parallel plate diffusers 1000 extend radially to increase the cumulative vertical aeration surface area. The numbers of combinations or arrangements are not limited to that as illustrated in FIGS. 34A-C.

FIG. 35 illustrates a plot of closing pressures, trans-membrane pressures, and trans-diaphragm pressures of manometer reading taken during the experimental operations of ribbed diffuser 880 of FIG. 27 when subjected to applied pressure, shown in the ascending diagonal line, delivered from the clean water head 724. The manometer readings are obtained are plotted against pore groupings from the bottom to the top of the diffuser 880 in 5-pore increments bracketing and within the observation lanes 932. The first horizontal plot is the trans-diaphragm pressure P₃-P₂, the second horizontal plot is the trans-membrane pressure P₂-P₁, and the third horizontal plot is the closing pressure P₃-P₂. The trans-diaphragm and trans-membrane pressures are substantially the same across from the bottom to the top. However, the closing pressure P₃-P₂, that is the pressure required to seat the diaphragm 921 against the lands or air passages 911, is slightly greater at the top than in the middle bottom of this 2 ft tall diffuser. In diffuser 880, the closing pressure is approximately 5% greater. This means it takes more pressure to close the diaphragm 921, or conversely, it takes more pressure P₂ to lift the seated diaphragm 921 away from the air passages 911 so that air can pass to the upper pores.

The advantage of this phenomenon is that the holes open sequentially from the bottom of the diffuser toward the top as the diaphragm 921 is lifted away by an incoming gas layer that interposes underneath the diaphragm 921 and migrates upward. Thus uniform aeration occurs along the vertical height of the gas permeable membrane in this flexible diaphragm diffuser instead of being routed to the top as would occur in a diffuser not equipped with a pore-occluding diaphragm. This slight, but measurable non-linear increase in diaphragm clamping pressure would increase in taller diffusers employed in the field, say in the range of 5 to 20 feet, and so provide an easier ability to more precisely deliver pressure gas pressure to establish and maintain uniform vertical aeration.

FIG. 36 is a data graphic of pressure measurements taken vertically along the wall the rib diffuser embodiment illustrated in FIG. 27 and having a flexible diaphragm similar to FIG. 23. The data graphic defines the operational performance of the Hyper O₂ gas diffuser 880 embodiment in terms of oxygen transfer efficiency (OTE) as a function of diffuser submerged depth and energy expenditure. The OTE efficiencies expressed as oxygen mass transferred per horse power-hour (#O₂/Hp-hr) vs. diffuser depth. For diffuser 880, the OTE is optimal for a diffuser submerged approximately 100 feet in a shaft. This can be understood in greater detail by examining different regions of the graph. The left side of FIG. 35 shows a plot of the free-air-delivery (FAD) pressure in bars vs. air flow in standard cubic feet per minute per horsepower (scfm/Hp). Conveniently, one pound of oxygen per horsepower hour is 0.97 scfm/HP, as indicated by compressor manufacturers, so the mass flow of oxygen in #/Hp-hr is numerically substantially equal to the volume flow of air in scfm/Hp.

In the case of the Hyper O₂ aerator, the design is based primarily on oxygen transfer and shaft hydraulics. Biological considerations do not govern the design as they do in a Clearbrooke or Deep Shaft process. The candidate existing wastewater treatment plant to be retrofitted with a Hyper O₂ aeration shaft, presumably has been sized to accommodate the biological requirements of hydraulic retention time, mixed liquor concentration of biomass, and sludge retention time, etc. Because the Hyper O₂ adjacent shaft aerator adds only a small additional volume to a typically large surface aeration basin, there will be minimal change in the design parameters of an existing plant. The primary purpose of the Hyper O₂ shaft is to supply adequate levels of dissolved oxygen very inexpensively. The compressed spent gas from the shaft, which is mostly nitrogen, will provide the mixing, the pumping for return activated sludge (RAS) and influent, and in the case of an oxidation ditch, will circulate the entire full channel flow in the ditch.

Referring still to FIG. 36, the operational performance of diffuser 880 depends on the type of compressor used. To read the output for any of the compressors, the output pressure in bars is on the left and the mass or volume flow is on the bottom of the graph. While the oxygen contained in the compressed air is partially consumed by the biology in the shaft, the kinetic energy stored in the compressed nitrogen is recovered by the expanding gas in the up-flow stream of circulating liquid in the shaft. This stored energy allows the total shaft depth, shown on the extreme left, and thus the ultimate saturation pressure, to be about 1.5 to 2 times, depending on diameter, the injection depth which is shown on the extreme right of the graph.

The solubility of gasses increase in proportion to the total applied fluid pressure. A plot of the % saturation of the applied O₂ transferred, shown across the top of the graph, at any depth of the aeration shaft (shown on the left) is plotted for both coarse and fine bubble diffusers.

On the right of FIG. 36 graph is the plot of the oxygen transfer efficiency OTE vs. injection depth. The OTE graph is generated by multiplying the compressor output times the transfer efficiency. For example, point A on the graph represents a 100 HP low pressure compressor delivering 9 #O2/HP-hr at 2 bars. Point B represents a 2 bar injection depth and the coarse bubble diffuser efficiency is 60%. The OTE is 9×0.6=5.4 #O₂/HP-Hr. If a fine bubble diffuser is selected as shown in point C on the % O₂ transfer curve, then the OTE at 2 bars will be 9×0.70=6.3#O2/HP-Hr. By using the fine bubble diffuser of the present invention, as shown by the curved dashed arrow, a 10% increase in oxygen transfer efficiency is obtainable in that an improved OTE values around 7 to 8 #O2/HP-Hr are achieved.

From the foregoing it is adequately demonstrated from FIG. 36 that the optimum power economy occurs at about 1.5 bar and shaft depths of about 100 ft (see curved dashed arrow “D”). This is true for processes where the injection depth is approximately the depth of the tank and aeration occurs at the injection pressure over long periods. Examples would be the deep tank at Lake Haven, Wash. at 23 ft deep, the German Bayer Biohoch process at 66 ft deep, the Dutch Multi reactor at 65 ft deep, or the Idaho State University at 90 ft deep. All of these examples fit closely to curve D on the OTE graph.

The dissolved gas concentration in liquid is proportional to the pressure but the concentration is also dependant on the time under aeration, and the rate of solution is dependant on the residual concentration and the removal rate. In the Hyper O2 process, the aeration time required is short because the rate of removal is very high due to the reaction rate of RAS and whole raw influent in the aerator. Also the bubbles travel downward to a lower zone of sub-saturation and higher pressure at the bottom of the shaft which increases the rate of solution.

FIGS. 37A-E schematically illustrates the operation of a combination in-channel and fine bubble deep shaft aeration system to provide adjunctive oxidative treatment of a portion of the water treatment facility's wastewater burden processed by non-shaft aerations systems.

FIG. 37 illustrates the aeration system 1200 having an in-channel distributor 1202 spanning a channel 1204 and a deep shaft aerator 1205 in isometric and cutaway views. The deep shaft aerator 1204 includes the diaphragm based vertically deployed gas permeable diffuser 760. Gas lines 728 and 728A are connected to the diffuser 760 to be the respective gas supplies for fine bubbles 754 and coarse bubbles 752. The deep shaft aerator 1205 is hydraulically connected to the in-channel distributor 1202 by influent channel 1206 and horizontal effluent chamber 1208. Influent channel 1206 may receive liquids destined for fine aeration from an existing aeration basin pipe 1206A, return activated sludge pipe 1206B, or a pipe 1204C attached to a primary clarifier (not shown). The deep shaft aerator 1204 receives liquids intended for fine aeration treatment from influent channel 1206 that siphons a portion of liquid upstream received from pipes 1206A and B. The siphoned liquid is transferred to down corner 776. Inside down corner 776 is the diffuser 760 described in FIG. 23A-B that is used to aerate with fine bubbles 754 emerging from the vertically deployed membrane 720. The downward flowing siphoned and fine bubble 754 aerated liquid then enters riser 778 and receives coarse bubbles 752 to provide an airlift to the liquid. The airlifted liquid in riser 778 is conveyed to the effluent chamber 1208. The airlifted liquid is turbulent and is confined within the chamber 1208 by chamber cover 1209. The chamber 1208 spans across the bottom of the channel 1204A and makes available the aerated and turbulent liquid to a gas disengagement apparatus contained within the distributor 1202. That portion of the chamber 1208 spanning across the channel bottom 1204A includes a substantially gabled chamber attic roof 1210.

Extending above the chamber roof 1210 is an in-vessel distributor 1212 that divides the liquid flow to an upstream section 1216A and a downstream section 1216B resulting in a delta H between the fluid sections as shown. The in-vessel distributor 1212 provides a gas disengagement process and includes an off gas vent 1220, a dispersion baffle 1224, and serrated edges 1228 of the attic roof 1210. The serrated edges 1228 serve to generate coarse air bubbles for utilization within the distributor 1202.

FIGS. 37B and C illustrate expansions of cross sectional views along lines A-A and B-B of the in-channel distributor 1202 of FIG. 37A.

FIG. 37B presents a cross-section of in-channel distributor 1202 along line B-B. Hydraulic head pressure from upstream liquid section 1216A, suitably dampened from chamber baffle 1211, causes the aerated liquid in channel 1208 to traverse baffle skirt 1257 and into ascending channel 1244. Simultaneously coarse and substantially deoxygenated bubbles 1248 are released from attic space 1252 that have gathered in the notched regions of the serrated edges 1228. The deoxygenated coarse bubbles 1248 upwardly travel within ascending channel 1244 and are released into an off-gas collection hood 1254 that is then vented in off-gas vent 1256. The turbulent water, aerated and now degassed, is conveyed over a downstream baffle 1260 and around dispersion baffles 1264 into downstream liquid section 1216B.

FIG. 37C presents a cross-section of in-channel distributor 1202 along line A-A. Attic space 1252 is seen in this cross-sectional view that is in front of the in-channel distributor 1202 cross-section view of FIG. 37B.

FIGS. 37D and E illustrates expansions of cross sectional views along line B-B of the in-channel distributor 1202 of FIG. 37A that is submersed in a liquid stream. In these alternate embodiments, gas disengagement does not use the off-gas collection hood 1254 or the off-gas vent 1256 of FIGS. 37B and C. In both views off gassing occurs directly in the submerged ascending chamber 1244 where coarse bubbles 1248 are released from the orifice of the ascending chamber 1244 just beneath the surface of the liquid stream or pond, or baffled by float assembly 1270 connected with slip joint 1272.

Under some circumstances, flow reversal in deep shafts can suddenly occur that introduces complications to wastewater treatment and aeration processes. As discussed in U.S. Pat. No. 4,351,730 to Bailey et al., circulation stability in vertical shaft aerators is substantially dependent upon the bulk density of the down flow stream being greater than the bulk density of the up flow stream. Under dynamic conditions, the circulation velocity of the fluid continues to increase until the sum of the hydraulic head losses just equals the differential head pressure created by this density difference. When the total driving head or pressure equals the total head loss or pressure loss, the circulation is at its most unstable condition and can slip into a reverse direction with the slightest perturbation in equilibrium conditions. Perturbations in equilibrium conditions may, under certain circumstances, be caused by imbalanced air injection into the down corner and up corner shafts.

Air injection in the down corner can create unstable circulation conditions dependent of the amount of air injected, the range of bubble sizes injected, and the changes to bulk densities in down corner and up corners caused by the injected air. that result in unpredictable, and sometimes energetic flow reversals that disrupts the operation of the process and lead to damaging the internal piping of the reactor. In larger shafts, the expulsion of large amounts of fluid from the head-tank, sometimes in the order of many tons, constitutes a safety hazard. Flow reversal in down corners depends upon the size of air bubbles injected, and the local bulk density mass of the wastewater within the down corner caused by the amount and distribution of air bubble sizes in the down corner.

FIG. 38 is a plot of terminal velocity of air bubbles as a function of bubble size. The plot illustrates that bubbles ⅛″ in diameter when compared to bubbles 4 times smaller [ 1/32″ in diameter] decrease in rise rate from 0.75 ft./sec to 0.25 ft./sec., or about 3 times slower than the rise rate. Bubbles in the range of ⅛″ in diameter when compared to bubbles 4 times bigger in diameter [½″ in diameter] have a nearly constant rise rate of about ¾ ft. per sec. In reactors with deep shafts, the rise rate of bubbles can be accurately measured by turning on the deep injection air, measuring the time for bubbles to arrive in the head tank, and plotting the bubble arrival times. According to this plot, the average size of bubble in a deep shaft reactor would be between ⅛″ and ½″ inch in diameter

In normal operations, introducing air into the down corner requires that the downward circulation flow velocity be approximately 3 to 5 times greater than the rise rate of the injected bubbles. However, the air bubbles, once injected into the down corner cause the local circulating liquid to become a compressible fluid. The extent of compressibility is often directly related to the size distribution of the bubbles. Even when the size distribution of injected air is substantially in the form of small air bubbles within a given fluid volume. Thus, it only takes a few large bubbles in a given air bubble distribution within a given fluid volume to disproportionately affect fluid compressibility within that given fluid volume. Flow reversal is more prevalent in large bubble air injection into down corner shafts, and significantly, less prevalent when the air is injected in smaller air bubbles into the down corner shaft 776. However, even when small air bubbles are injected into the down corner 776, air bubbles can coalesce or combine into large air bubbles, accumulate into larger gas pockets, and so threaten fluid circulation equilibrium.

FIG. 39 illustrates a cross-section of an alternate diffuser embodiment 1300. The alternate diffuser embodiment 1300 includes a bubble-shunting member 1302, a porous membrane cylindrical extension 1330, and a bubble barrier 1340. The bubble-shunting member 1302 collects larger gas bubbles or bubbles that have coalesced into gas pockets in the down corner 776 and shunts or delivers the bubbles and/or gas pockets to the up corner 778 to maintain flow circulation stability between the down corner 776 and up corner 778. The bubble-shunting member 1302 includes an inverted U-tube assembly 1306 configured to stabilize hydraulic flow between the up corner and down corner channels 776 and 778. The porous membrane cylindrical extension 1330 is continuous with the conically shaped diffuser membrane 720 and increases gas diffusion surface area in the net vertical deployment of emerging gas bubbles. The conical shape of the bubble barrier 1340 discourages the accumulation of micro air bubbles and thus prevents gas pocket formulation due to coalescing micro air bubbles beneath the porous membrane cylindrical extension 1330. The conically shape also assists the downward flow in the down corner 776.

The alternate diffuser embodiment 1300 combines the cone-shaped diffuser 760 of FIG. 23A with a porous gas diffuser cylinder membrane 1330 that extends from the conically shaped diffuser membrane 720. The cone-shape diffuser includes the conical support element 764 substantially similar to that illustrated in FIG. 23A that also includes a cylindrical support extension 764A that is continuous with the conical support element 764. Porous surface 720 extends from the conical region onto the cylinder. Located in-between the cylinder 720 porous region and the cylinder support extension 764A is a longer version of the gas impermeable flexible diaphragm 772 that extends over the conical support 764 onto the cylindrical extension support 764A. 1330. The cylinder extension 1330 is capped with the bubble barrier 1340. Particular embodiments of the bubble barrier 1340 includes an inverted cone shape and may be made of metal materials to thwart gas accumulation underneath the cylinder extension 1330. The impermeable diaphragm 772 and the bubble barrier 1340 may be secured to the cylindrical support extension 764A by bolts 774.

The impermeable membrane 772 of the cone-shaped diffuser 764 extends onto the cylinder extension 1330 to increase effective vertical surface area for the scouring or release of micro air bubbles 754. Micro air bubbles 754 emerge or are scoured from at substantially the same rate along the vertical axis of the cone shaped 770 and cylindrical extension 1330 gas diffusers. The substantially vertical emergence rate of the air bubbles 754 occurs by regulating the unmasking of pores along the vertical axis as a consequence of manipulating the pealing away of the impermeable membrane 772 from the respective regions of the cylinder 1330 and conical 760 diffusers as previously described by hydraulic pressure manipulations of reservoir 724. Micro air bubbles 754 may coalesce or combine into larger air bubbles 1305 that would present a threat to re-circulation dynamics in the down corner 776. The inverted tube U-tube 1306 receives the larger air bubbles 1305 to shunt them over to the up corner 778, thereby averting flow reversal in the down corner 776.

FIG. 40A illustrates an expansion of the structural detail of the bubble-shunting member 1302. The bubble-shunting member 1302 includes the inverted U-tube 1306 located in the wall region between the down corner 776 and up corner 778 near the air injection locus shown in FIG. 38. The inverted U-tube 1306 includes a bubble collection port 1308 in fluid communication with the internal wall of down corner 776, an ascending channel 1310, a descending channel 1312, a curved space 1314 continuous with the ascending and descending channels 1310 and 1312, a fluid reservoir 1316, and a bubble release port 1320 in fluid communication with the up corner 778. The bubble collection port 1308 is located beneath the conical membrane diffuser 760 and near the upper end of the cylinder extension diffuser 1330. The larger, upward faster flowing air bubbles 1305 that present substantial threat to flow circulation equilibrium entrain or coalesce along the wall of the down corner 776 and enter the bubble collection port 1308. The collected, large air bubbles 1305 are re-directed through internal U-tube 1306 and shuttled to the up corner 778 to provide the airlift and insure that up corner fluid density remains lower than down corner fluid density, thereby securing stable one-way circulatory flow without flow reversals in the down corner 776. Additionally, by removing of the larger air bubbles, in the zone immediately below the down corner air injection point, the smaller remaining bubbles remain and provide the greater contact time for efficient oxygen exchange. Commonly, but not limited to, the smaller air bubbles may be approximately 1/32 inch. Moreover, the removal and shunting of troublesome large air bubbles allows slower circulation velocity, increased contact time, and greater air lift pumping to the up corner or riser. In other particular embodiments, the down corner air injection point is approximately between 50% and 65% of the reactor total depth, with the mean injection depth near 68 feet.

In operation, the pressure at any point across the inverted U tube 1306 within the wall between the down corner 776 channel is slightly greater within the inside than within the up corner 778 channel to establish stable fluid circulation. That is, hydraulic pressure is greater internally than internally partly due to the position of the bubble collection port 1308 being lower than the in that the bubble release port 1320, and partly due to the hydraulic lift provided by the emerging bubbles 752 in the up corner 778 and in lowering the effective fluid density in the up corner 776. The inverted U tube 1306 allows flow destabilizing air pockets to form inside the U tube 106 instead of forming and growing within the down corner 776. As the air pocket grows in the inverted U tube 1306, the excess air is vented into the ascending channel 1310, the descending arm 1312, and curved space 1314 connecting the ascending and descending arms 1310 and 1312. The inverted U tube 1306 allows passage of large air bubbles or coalesced air bubbles or air pockets while preventing the substantial transferring of liquid from the down corner 776 to the riser or up corner 778. As shown, a lower air-water interface a and an upper air-water interface b demarcates where a fluid bolus 1325 is captured within the ascending arm 1310 of the inverted U-tube 1302. The blocking of fluid transfer between the down corner 776 and riser 778 is enhanced by the formation of large air pockets from coalescing air bubbles within the inverted U-tube 1306 that acts as a hydraulic bolus or fluid plug and prevents liquids from the down corner 776 and/or up corner 778 from passing between the down corner 776 and up corner 778. This air pocket fluid blocking lends to using larger diameter inverted U-tubes to substantially lessen the possibility of waste solid blockage. Air migrates within the ascending arm 1310, through the entrapped water bolus 1325 when present, through the curved spaced 1314, down through the descending arm 1312, and into the fluid reservoir 1316. Thereafter, the air emergences into the up corner 776 as air bubbles 752 from the bubble release port 1320.

Particular embodiments of the flow-stabilizing, bubble shunting assembly 1302 includes many configurations that the inverted U-tube 1306 may take. For example, a simple hole in the wall of the down corner at the point of air injection in the down corner allowing for ready modification in existing Deep Shaft plants. Pipe piercing technology is commonly used in water and oil well drilling may be sued to place the hole. A small hole in the wall of the down corner would allow passage of the trapped air but a relatively small amount of fluid. For example, a 2″ diameter hole would be adequate to vent the entrapped air from a 36″ down corner tube. The transfer of fluid through this 2″ diameter hole, relative to the flow in a 36″ pipe, is insignificant.

FIG. 40B is a partial perspective, cut-away and cross-sectional view of the structural detail of the cone-shaped and cylinder diffuser of FIG. 38. A cutaway perspective of the impermeable membrane 772 is shown in-between the conical support 764 and diffuser interface 720. The conical support The diffuser surface 720 extends onto the cylinder diffuser 1330. The membrane 772 also extends beneath the diffuser membrane surface 720 and over the cylindrical support extension 764A.

Although the foregoing invention has been described in detail by way of example for purposes of clarity of understanding, it will be apparent to the artisan that certain changes and modifications are comprehended by the disclosure and may be practiced without undue experimentation within the scope of the invention that is described herein by way of illustration not limitation. For example, the aforementioned devices may include at least one fluid submerged, vertically oriented membrane, porous tubing, porous plate, screen, or multiples thereof in the form of a membrane, tubing, plate, or screen assembly that are hydraulically connected to a gas source other than compressed air or oxygen, for example methane, sulfur dioxide, nitrogen, carbon dioxide, hydrogen, and helium. Furthermore, the aforementioned embodiments may also be adapted to nucleate and reduce supersaturated gasses from a liquid, liquid composition, and/or liquid suspension. All publications, patents, and patent applications cited herein are hereby incorporated by reference in their entirety for all purposes.

The embodiments of the invention in which an exclusive property or privilege is claimed are defined as follows:

1. A submerged membrane assembly in a liquid, comprising:
at least one vertically orientated, gas bubble collector having a channel with a first aperture exposed to a first hydraulic pressure and a second aperture exposed to a second hydraulic pressure, the first aperture configured to capture gas bubbles and the second aperture configured to release gas bubbles; and
a gas permeable membrane having a first surface in sealable contact with the second aperture and a second surface in contact with the liquid,
wherein a pressure differential between the first and second apertures urges captured gas bubbles to transit from the first aperture, through the channel, from the second aperture, and through the first and second surfaces of the gas permeable membrane.

2. The membrane assembly of claim 1, wherein the pressure differential between the first and second surfaces is substantially the same throughout the vertical height of the membrane.

3. The membrane assembly of claim 2, wherein the gas emerges from the second surface into the liquid as fine bubbles distributed substantially uniformly throughout the vertical height of the membrane.

4. The membrane assembly of claim 1, wherein the at least one vertically orientated, gas bubble collector is arranged into a staggered array of vertical collectors, each vertical collector in the staggered array having the second aperture in contact with the membrane.

5. The membrane assembly of claim 4, wherein the staggered array includes a distributor plate located beneath the at least one vertically oriented bubble collector, the distributor plate having a perimeter and being in pneumatic contact with a gas supply.

6. The membrane assembly of claim 5, wherein the first aperture of each vertically oriented bubble collection in the staggered array and the distributor plate defines an inner diffuser chamber that receives air bubbles from the distributor plate via the gas supply and conveys the air bubbles to the first aperture.

7. The membrane assembly of claim 6, wherein the staggered array includes a conic array and a tubular array.

8. The membrane assembly of claim 7, wherein the staggered array includes a check valve to release fluids accumulating in the inner diffuser chamber above a preset pressure.

9. The membrane assembly of claim 8, wherein the check valve releases fluids from the inner diffuser chamber through a plenum orifice.

10. The membrane assembly of claim 9, further comprising a plenum located beneath the distributor plate, the plenum further having walls positioned with a gap around the perimeter of the distributor plate, the gap having fluid communication with the inner diffuser chamber.

11. The membrane assembly of claim 10 further comprising a fluid supply in fluid communication with a tank reservoir and the inner diffuser chamber, the tank reservoir holding a fluid deliverable to the inner diffuser chamber.

12. The membrane assembly of claim 11, wherein the perimeter of the distributor plate further comprises a plurality of serrations to form a plurality of bubble streams that emerge from the plate perimeter and into the fluid held in the inner diffuser space and captureable by the first apertures of the array.

13. The membrane assembly of claim 12, wherein the pressure differential between the first and second membrane surfaces is controlled by varying the level of fluid in the tank reservoir, the depth of the submerged assembly, and the fluid release from the inner diffuser space from the plenum orifice.

14. The membrane assembly of claim 13, further comprising a pressure relief valve in fluid communication with the plenum orifice.

15. The membrane assembly of claim 12 wherein the perimeter of the distributor plate includes a bottom having a plurality of serrations to form a plurality of fine bubble streams that are conveyed through the gap to the diffuser inner chamber and captureable by the first orifices.

16. A submerged membrane assembly in a liquid, comprising:
a plurality of vertically orientated and step-wise staggered gas bubble collectors, the collector plurality having in a succession step-wise first orifices to capture gas bubbles, and a succession of beveled second orifices that provide a smooth, continuous surface to release gas bubbles;
a gas permeable membrane having a first surface in sealable contact with the smooth surface of the second orifices and experiencing a first hydraulic pressure, and a second surface in contact with the liquid experiencing a second hydraulic pressure less than the first hydraulic pressure;
a plenum having walls in sealable contact with the outermost bubble collector of the collector plurality, and further having a plenum bottom having a plenum orifice, such that an inner diffuser space is defined by the membrane and plenum walls, the inner diffuser space further containing a fluid;
a gas distributor plate interposed between the plenum bottom and the first orifices, the plate being in fluid communication with a gas supply; and
a fluid reservoir in contact with the inner diffuser space and receiving the fluid from the inner diffuser space,
wherein gas emerges from the second surface as fine bubbles.

17. The membrane assembly of claim 16, wherein the amount of fine bubbles is determined by the pressure differential between the first and second hydraulic pressures.

18. The membrane assembly of claim 17, wherein the magnitude of the pressure differential is controlled by the depth of the submerged apparatus in the liquid, and the height of the fluid in the fluid reservoir relative to the submerged membrane assembly depth, the fluid volume released through the plenum orifice, and the gas volume delivered from the distributor plate to the inner diffuser space.

19. The membrane assembly of claim 18 wherein the perimeter of the distributor plate includes a bottom having a plurality of serrations to form a plurality of fine bubble streams that are captureable by the first orifices.

20. A submerged membrane assembly in a liquid, comprising:
a first inner space and a second inner space, the first and second inner spaces defined by a plenum wall, a plenum bottom, and a plurality of staggered, vertically orientated gas bubble collectors in sealable contact with each other and the plenum walls, the bubble collectors having a first aperture in ascending step-wise configuration to its neighbor collector orifices and a beveled second aperture forming a smooth surface;
a first gas-permeable membrane in sealable contact with all the second apertures of the first inner space;
a second gas-permeable membrane in sealable contact with a majority of second apertures of the first inner space, leaving at least one gas channel of the first inner space in fluid communication with the second inner space of the second diffuser;
a gas distributor plate interposed between the plenum bottom and the first orifices of the first inner space, the plate being in fluid communication with a gas supply; and
a fluid reservoir in contact with the second inner space and receiving the fluid from the first inner space,
wherein under the conditions of a first membrane surface experiencing a first hydraulic pressure that is greater than a second hydraulic pressure experienced by the second surface, gas emerges from the distributor plate, enters the first inner space as a plurality of gas bubbles, a portion thereof delivered to the second inner space by the channel from the first inner space, such that fine gas bubbles emerge from the second membrane surface of the first and second diffusers.

21. The membrane assembly of claim 20, wherein the perimeter of distributor plate further comprises a plurality of serrations to form a plurality of bubble streams that emerge from the plate perimeter and into the fluid held in the inner diffuser space and captureable by the first orifices of the first and second diffusers.

22. The membrane of claim 21, wherein the gas channel of the first diffuser includes a second plurality of serrations to deliver fine bubble streams into the second diffuser space.

23. The assembly of claim 22, wherein first and second diffusers includes conical and cylindrical shapes.

24. The assembly of claim 23, wherein plenum bottom includes a plenum orifice in fluid communication between the first inner chamber and the liquid.

25. The assembly of claim 24, wherein the magnitude of the pressure differential between the first and second hydraulic pressures is controlled by the depth of the submerged assembly in the liquid, the height of the fluid in the fluid reservoir relative to the assembly depth, the fluid volume released through the plenum orifice, and the gas volume delivered from the distributor plate to the first inner space.

26. A submerged membrane assembly in a liquid, comprising:
a gas diffuser having a plurality of vertically orientated and step-wise staggered gas bubble collectors, the plurality arranged in a succession of step-wise first orifices to capture gas bubbles, and a succession of bevel-shaped second orifices that provide a smooth, continuous surface to release gas bubbles;
a gas permeable membrane having a first surface in sealable contact with the smooth surface of the second orifices and experiencing a first hydraulic pressure, and a second surface in contact with the liquid experiencing a second hydraulic pressure less than the first hydraulic pressure;
a non-permeable flexible diaphragm adjacent to the first orifices;
a plenum having walls in sealable contact with the periphery of the diaphragm that defines a gas inner space located between the diaphragm and the first membrane service, and a hydraulic space defined by the space between the diaphragm and the plenum;
a gas line in fluid communication with the gas inner space; and
a fluid reservoir in fluid communication with the hydraulic space,
wherein gas is collected by the first orifices, urged toward the second orifices, and emerges from the second surface as fine bubbles.

27. The apparatus of claim 26, wherein the fine bubbles emerge from the second surface located in a down corner channel.

28. The apparatus of claim 27 further including an annular gas distributor plate in fluid communication with the gas line and an up corner channel.

29. The apparatus of claim 28, wherein the distributor plate further includes a plurality of serrations to form a plurality of bubble streams that emerge from the plate perimeter and into the liquid flowing in the up corner channel.

30. The apparatus of claim 29, wherein the fine bubbles emerge from the second surface located in the down corner channel as a plurality of fine bubbles that emerge from the membrane second surface into the liquid previously aerated in the up corner channel.

31. The apparatus of claim 26, wherein the diaphragm adjustably covers a portion of the gas permeable membrane.

32. The apparatus of claim 31, wherein the diaphragm adjustably covers the portion of the gas permeable membrane in a vertical direction.

33. The apparatus of claim 32, wherein the vertical direction is top to bottom.

34. A gas diffusion assembly comprising:
a first channel configured to receive downward flowing liquids;
a second channel adjacent to the first channel and configured to redirect the downward flowing liquids to upward flowing liquids;
an inverted U-tube located between the first and second channels, the inverted U-tube having a first port located in fluid communication with the first channel and a second port located in fluid communication with the second channel, the first port being lower than the second port;
a gas diffuser located in the first channel, the gas diffuser having a gas permeable membrane, a support, and a gas impermeable diaphragm located between the support and the gas permeable membrane;
a gas source in fluid communication with a first space between the support and the gas permeable membrane; and
a hydraulic fluid in fluid communication with a second space between the support and gas impermeable diaphragm,
wherein manipulation of the hydraulic fluid causes the gas impermeable diaphragm to change the vertical emergence of fine gas bubbles from the gas permeable membrane.

35. The assembly of claim 34, wherein a proportion of the fine gas bubbles coalesce to form larger air bubbles within the first channel, the larger air bubbles are collected by the first port, transit through the U tube, and shunted to the second port for release into the upward flowing fluids in the second channel.

36. The assembly of claim 34, wherein the gas diffuser includes at least one of a cylindrical shape, a conical shape, and a combination of a cylindrical and a conical shape.
